(19) United States
(12) Patent Application Publication
(10) Pub. No.: US 2026/0343024 A1
(43) Pub. Date: Oct. 29, 2026

(54) ENCODING METHOD, DECODING METHOD, BITSTREAM, ENCODER, DECODER, AND STORAGE MEDIUM

(71) Applicant: GUANGDONG OPPO MOBILE TELECOMMUNICATIONS CORP., LTD., Dongguan (CN)

(72) Inventor: Lai ZHANG, Dongguan (CN)

(21) Appl. No.: 19/713,857

(22) Filed: Jun. 19, 2026

Related U.S. Application Data
(63) Continuation of application No. PCT/CN2023/140978, filed on Dec. 22, 2023.

(51) Int. Cl. H04N 19/61; H04N 19/105; H04N 19/12; H04N 19/159; H04N 19/176; H04N 19/70

(52) U.S. Cl. CPC H04N 19/61; H04N 19/105; H04N 19/12; H04N 19/159; H04N 19/176; H04N 19/70

(57) ABSTRACT

Provided are an encoding and decoding method, a bitstream, an encoder, a decoder, and a storage medium. The method includes: decoding a bitstream to determine a value of first syntax flag information; constructing a transformation model candidate list of a current block when the first syntax flag information indicates that the current block uses an inter prediction mode; determining a transformation model of the current block based on the transformation model candidate list, and determining a reference block of the current block; transforming the reference block based on the transformation model to determine a prediction block of the current block. In this way, the diversity of inter prediction may be improved, thereby improving encoding and decoding efficiency.

### CROSS-REFERENCE TO RELATED APPLICATION

This is a continuation application of International Application No. PCT/CN2023/140978, filed on Dec. 22, 2023, which is incorporated by reference herein in its entirety.

### TECHNICAL FIELD

Embodiments of the present disclosure relate to the technical field of video encoding and decoding, and in particular, to an encoding and decoding method, a bitstream, an encoder, a decoder, and a storage medium.

### BACKGROUND

With the increasing demand for high video display quality, high-resolution videos such as high-definition and ultra-high-definition videos have emerged. However, high-resolution videos usually carry more information and therefore require more bandwidth. To reduce bandwidth requirements, video coding standards involving video compression have been introduced.

In video coding standards, Local Illumination Compensation (LIC) is a block-level linear transformation technique. The LIC technique assumes a linear relationship between a coding block and a reference block, so a transformation model may be computed based on adjacent pixels of the coding block and its reference block, and the transformation model may be applied to the reference block to improve prediction accuracy. However, existing technical solutions are incomplete. For example, the transformation model obtained based on adjacent pixels cannot guarantee accuracy, which reduces encoding and decoding efficiency.

### SUMMARY

Embodiments of the present disclosure provide an encoding and decoding method, a bitstream, an encoder, a decoder, and a storage medium, which can improve the diversity of inter prediction, thereby enhancing encoding and decoding efficiency.

Technical solutions of embodiments of the present disclosure may be implemented as follows.

In a first aspect, embodiments of the present disclosure provide a decoding method implemented by a decoder, the method including:
decoding a bitstream to determine a value of first syntax flag information;
constructing a transformation model candidate list of a current block when the first syntax flag information indicates that the current block uses an inter prediction mode;
determining a transformation model of the current block based on the transformation model candidate list, and determining a reference block of the current block; and
transforming the reference block based on the transformation model to determine a prediction block of the current block.

In a second aspect, embodiments of the present disclosure provide an encoding method implemented by an encoder, the method including:
constructing a transformation model candidate list of a current block when the current block uses an inter prediction mode;
determining a transformation model of the current block based on the transformation model candidate list, and determining a reference block of the current block; and
transforming the reference block based on the transformation model to determine a prediction block of the current block.

In a third aspect, embodiments of the present disclosure provide a bitstream which is generated by performing bit encoding on information to be encoded, the information to be encoded including at least one of:
a residual block of a current block, a transformation model index of the current block, a first merge index of the current block, a second merge index of the current block, motion information of the current block, a first transformation model index and a second transformation model index of the current block, prediction direction information of the current block, mode flag information of at least part of candidate motion information in a first sorted merge candidate list, a value of first syntax flag information, a value of second syntax flag information, a value of third syntax flag information, a value of fourth syntax flag information, and a value of fifth syntax flag information.

The first syntax flag information is configured to indicate whether the current block uses an inter prediction mode, the second syntax flag information is configured to indicate whether the current block uses a transformation model candidate list-based manner, the third syntax flag information is configured to indicate whether the current block uses a reference block transformation-based prediction mode, the fourth syntax flag information is configured to indicate whether the current block uses an inter merge prediction mode, and the fifth syntax flag information is configured to indicate whether the current block uses an intra block copy mode.

In a fourth aspect, embodiments of the present disclosure provide an encoder including a first construction unit, a first determination unit, and a first prediction unit, wherein:
the first construction unit is configured to construct a transformation model candidate list of a current block when the current block uses an inter prediction mode;
the first determination unit is configured to determine a transformation model of the current block based on the transformation model candidate list, and determine a reference block of the current block; and
the first prediction unit is configured to transform the reference block based on the transformation model to determine a prediction block of the current block.

In a fifth aspect, embodiments of the present disclosure provide an encoder including a first memory and a first processor, wherein:
the first memory is configured to store a computer program executable on the first processor; and
the first processor is configured to perform the method according to the second aspect when executing the computer program.

In a sixth aspect, embodiments of the present disclosure provide a decoder including a decoding unit, a second construction unit, a second determination unit, and a second prediction unit, wherein:
the decoding unit is configured to decode a bitstream to determine a value of first syntax flag information;
the second construction unit is configured to construct a transformation model candidate list of a current block when the first syntax flag information indicates that the current block uses an inter prediction mode;
the second determination unit is configured to determine a transformation model of the current block based on the transformation model candidate list, and determine a reference block of the current block; and
the second prediction unit is configured to transform the reference block based on the transformation model to determine a prediction block of the current block.

In a seventh aspect, embodiments of the present disclosure provide a decoder including a second memory and a second processor, wherein:
the second memory is configured to store a computer program executable on the second processor; and
the second processor is configured to perform the method according to the first aspect when executing the computer program.

In an eighth aspect, embodiments of the present disclosure provide a computer-readable storage medium storing a computer program that, when executed by at least one processor, implements the method according to the first aspect or the method according to the second aspect.

Embodiments of the present disclosure provide an encoding and decoding method, a bitstream, an encoder, a decoder, and a storage medium. At an encoding end, when a current block uses an inter prediction mode, a transformation model candidate list of the current block is constructed; a transformation model of the current block is determined based on the transformation model candidate list, and a reference block of the current block is determined; the reference block is transformed based on the transformation model to determine a prediction block of the current block. At a decoding end, a bitstream is decoded to determine a value of first syntax flag information; when the first syntax flag information indicates that the current block uses an inter prediction mode, a transformation model candidate list of the current block is constructed; a transformation model of the current block is determined based on the transformation model candidate list, and a reference block of the current block is determined; the reference block is transformed based on the transformation model to determine a prediction block of the current block. In this way, at both the encoding end and the decoding end, when the current block uses the inter prediction mode, a transformation model candidate list of the current block is first constructed, and then the transformation model and the reference block of the current block are determined accordingly. By transforming the reference block using the transformation model, not only the diversity of inter prediction may be improved, but also the prediction accuracy may be enhanced, thereby improving encoding and decoding efficiency.

### BRIEF DESCRIPTION OF THE DRAWINGS

FIG. 1 is a flowchart of a hybrid coding framework;

FIG. 2 is a first template matching diagram of an IntraTMP technique;

FIG. 3 is a diagram of determining a matching block of a current block;

FIG. 4A is a second template matching diagram of an IntraTMP technique;

FIG. 4B is a third template matching diagram of an IntraTMP technique;

FIG. 5 is a weighted fusion diagram of an IntraTMP technique;

FIG. 6 is a structural diagram of a filter;

FIG. 7 is a structural diagram of determining filter coefficients;

FIG. 8A is a structural diagram of vertical quartering;

FIG. 8B is a structural diagram of horizontal quartering;

FIG. 9 is a diagram of current block prediction applied to an LIC technique;

FIG. 10 is a diagram of a linear relationship between a reference block and a prediction block;

FIG. 11 is a position diagram of adjacent candidates and non-adjacent candidates of a current block;

FIG. 12 is a diagram of current block prediction applied to a BVD technique;

FIG. 13 is a diagram of bidirectional matching applied to a DMVR technique;

FIG. 14 is a block diagram of an encoder provided by an embodiment of the present disclosure;

FIG. 15 is a block diagram of a decoder provided by an embodiment of the present disclosure;

FIG. 16 is a network architecture diagram of an encoding and decoding system provided by an embodiment of the present disclosure;

FIG. 17 is a first flowchart of a decoding method provided by an embodiment of the present disclosure;

FIG. 18 is a second flowchart of a decoding method provided by an embodiment of the present disclosure;

FIG. 19 is a third flowchart of a decoding method provided by an embodiment of the present disclosure;

FIG. 20 is a fourth flowchart of a decoding method provided by an embodiment of the present disclosure;

FIG. 21 is a fifth flowchart of a decoding method provided by an embodiment of the present disclosure;

FIG. 22 is a sixth flowchart of a decoding method provided by an embodiment of the present disclosure;

FIG. 23 is a seventh flowchart of a decoding method provided by an embodiment of the present disclosure;

FIG. 24 is an eighth flowchart of a decoding method provided by an embodiment of the present disclosure;

FIG. 25 is a first flowchart of an encoding method provided by an embodiment of the present disclosure;

FIG. 26 is a second flowchart of an encoding method provided by an embodiment of the present disclosure;

FIG. 27 is a third flowchart of an encoding method provided by an embodiment of the present disclosure;

FIG. 28 is a structural diagram of an encoder provided by an embodiment of the present disclosure;

FIG. 29 is a specific hardware structural diagram of an encoder provided by an embodiment of the present disclosure;

FIG. 30 is a structural diagram of a decoder provided by an embodiment of the present disclosure;

FIG. 31 is a specific hardware structural diagram of a decoder provided by an embodiment of the present disclosure; and

FIG. 32 is a structural diagram of an encoding and decoding system provided by an embodiment of the present disclosure.

### DETAILED DESCRIPTION

For a more detailed understanding of the features and technical content of embodiments of the present disclosure, implementation of embodiments of the present disclosure is described in detail below with reference to the accompanying drawings, which are provided for reference and illustration purposes only and are not intended to limit embodiments of the present disclosure.

Unless otherwise defined, all technical and scientific terms used herein have the same meaning as commonly understood by one of ordinary skill in the art to which the present disclosure belongs. The terms used herein are for the purpose of describing embodiments of the present disclosure only and are not intended to limit the present disclosure.

In the following description, “some embodiments” mean a subset of all possible embodiments, but it is understood that “some embodiments” may be the same subset or different subsets of all possible embodiments, and may be combined with each other without conflict.

It should also be noted that the terms “first/second/third” involved in embodiments of the present disclosure are only used to distinguish similar objects and do not represent a specific ordering of the objects. It is understood that “first/second/third” may be interchanged in a specific order or sequence where permitted, so that embodiments of the present disclosure may be implemented in an order other than that illustrated or described herein.

In a video picture, a coding block (CB) is generally represented by a first color component, a second color component, and a third color component. The three color components are a luma component, a blue chroma component, and a red chroma component. Specifically, the luma component is usually denoted by the symbol Y, the blue chroma component is usually denoted by the symbol Cb or U, and the red chroma component is usually denoted by the symbol Cr or V. Thus, a video picture may be represented in a YCbCr format or a YUV format.

Before describing embodiments of the present disclosure in further detail, terms and terminologies involved in embodiments of the present disclosure are explained below:
H.265/High Efficiency Video Coding (HEVC);
H.266/Versatile Video Coding (VVC);
VVC Test Model (VTM);
Enhanced Compression Model (ECM);
Joint Video Experts Team (JVET);
Intra Template Matching Prediction (IntraTMP);
Block Vector (BV);
Motion Vector (MV);
Motion Vector Difference (MVD);
Motion Vector Prediction (MVP);
Most Probable Mode (MPM);
Sum of Absolute Difference (SAD);
Sum of Absolute Transformed Difference (SATD);
Mean Squared Error (MSE);
Root Mean Square Error (RMSE);
Mean Absolute Error (MAE);
Mean Absolute Deviation (MAD);
Coding Unit (CU);
Coding Tree Unit (CTU);
Sequence Parameter Set (SPS);
Palette (PLT);
Merge;
Block Differential Pulse Coded Modulation (BDPCM);
Intra Block Copy (IBC);
Local Illumination Compensation (LIC);
Cross Component Merge (CCMerge); and
Decoder-side Motion Vector Refinement (DMVR).

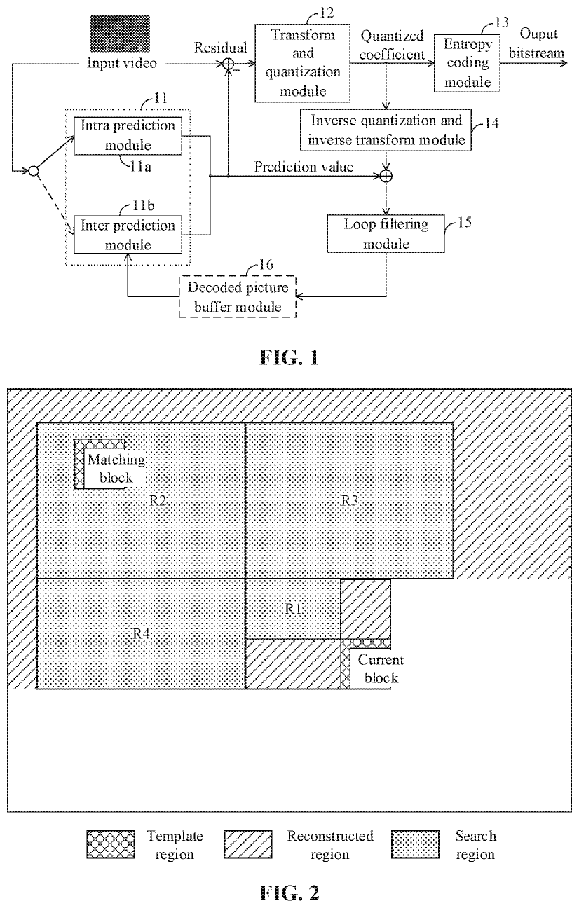

At present, common video coding and decoding standards adopt a block-based hybrid coding framework. Each picture, sub-picture, or frame in a video is split into square largest coding units or coding tree units of the same size (such as 256×256, 128×128, 64×64, etc.). Each largest coding unit or coding tree unit may be partitioned into rectangular coding units according to rules. A coding unit may be further partitioned into prediction units, transform units, and so on. Specifically, as shown in FIG. 1, the hybrid coding framework includes a prediction module 11, a transform and quantization module 12, an entropy coding module 13, an inverse quantization and inverse transform module 14, a loop filtering module 15, and a decoded picture buffer module 16. The prediction module 11 may include an intra prediction module 11a and an inter prediction module 11b, and the inter prediction module 11b may include a motion estimation module and a motion compensation module. Since strong correlation exists between adjacent pixels in a picture of a video, an intra prediction method is used in video coding and decoding techniques to remove spatial redundancy between adjacent pixels. In addition, since strong similarity exists between adjacent pictures in a video, an inter-picture prediction method is used in video coding and decoding techniques to remove temporal redundancy between adjacent pictures, thereby improving coding efficiency.

The basic operation of a video codec is as follows: at an encoding end, a picture is split into blocks, intra prediction or inter prediction is applied to a current block to generate a prediction block of the current block, a residual block is obtained by subtracting the prediction block from an original block of the current block, transform and quantization are performed on the residual block to obtain a quantized coefficient matrix, and entropy coding is performed on the quantized coefficient matrix and the result is output into a bitstream. At a decoding end, intra prediction or inter prediction is applied to the current block to generate a prediction block of the current block; on the other hand, the bitstream is parsed to obtain a quantized coefficient matrix, inverse quantization and inverse transform are performed on the quantized coefficient matrix to obtain a residual block, and the prediction block and the residual block are added together to obtain a reconstructed block. Reconstructed blocks form a reconstructed picture, and loop filtering is performed on the reconstructed picture on a picture basis or a block basis to obtain a decoded picture. The encoding end also performs operations similar to those at the decoding end to obtain a decoded picture. The decoded picture may serve as a reference picture for inter prediction of subsequent pictures. Block partitioning information, mode information or parameter information such as prediction, transform, quantization, entropy coding, and loop filtering determined at the encoding end needs to be output into the bitstream if necessary. The decoding end parses the bitstream and performs analysis based on existing information to determine the same block partitioning information, mode information or parameter information such as prediction, transform, quantization, entropy coding, and loop filtering as those at the encoding end, so as to ensure that the decoded picture obtained at the encoding end is identical to the decoded picture obtained at the decoding end. The decoded picture obtained at the encoding end is also generally referred to as a reconstructed picture. A current block may be partitioned into prediction units during prediction, and into transform units during transform, and the partitioning of prediction units and transform units may be different. The above is the basic operation of a video codec under a block-based hybrid coding framework. With technological development, some modules or operations of the framework or process may be optimized. Embodiments of the present disclosure apply to the basic process of a video codec under the block-based hybrid coding framework, but are not limited to the framework and process.

In addition, in embodiments of the present disclosure, a current block (CB) may be a current coding unit, a current prediction unit, a current transform unit, or the like. For the needs of parallel processing, a picture may be partitioned into slices and the like, and slices in the same picture may be processed in parallel, that is, there is no data dependency between them. A “frame” is a common expression, and generally a frame may be understood as a picture. A frame described in embodiments of the present disclosure may also be replaced with a picture, a slice, or the like.

Several prediction techniques in the related art are described in detail below.

The Intra Template Matching Prediction technique, referred to as the IntraTMP technique for short, is a special intra prediction coding tool mainly applied to screen content coding. IntraTMP is mainly implemented through the following process:

### (1) Intra Template Matching Prediction Technique

An L-shaped portion of reconstructed pixels adjacent to the current block is selected as a template, a most similar template is searched in a given reconstructed region of the current frame, and a reconstructed block corresponding to the most similar template is taken as a matching block to serve as a prediction block of the current block. As shown in FIGS. 2, R1 to R4 therein are available IntraTMP search regions. Matching blocks are searched point by point in these regions in a raster scan order.

In addition, as shown in FIG. 3, a matching block may be represented by a block vector (BV) pointing from the current block to the matching block; the similarity between templates is represented by a template error, and a smaller template error indicates higher similarity. For example, a Sum of Absolute Difference (SAD) is used to calculate a template error, and a smaller SAD indicates more similar templates.

Here, the codec uses a flag intra_tmp_flag to indicate whether the current block is coded using the IntraTMP mode. If so, the same template matching process is performed at the decoding end to obtain the same prediction block at the decoding end, without additional coding of block vector information from the current block to the matching block.

### (2) Technique of IntraTMP Adaption for Camera-Captured Content

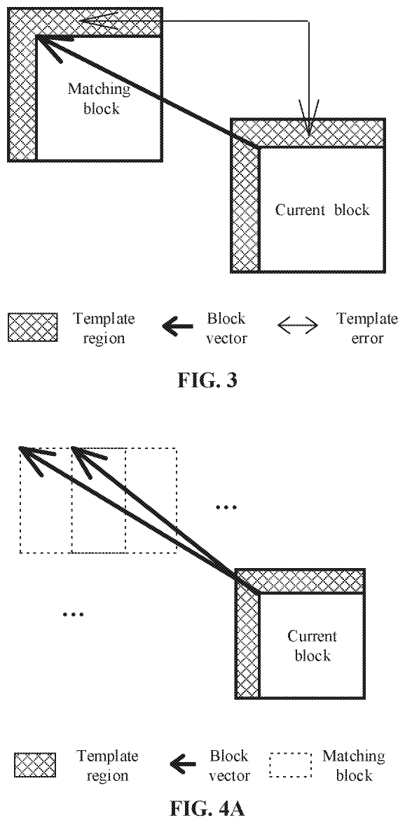

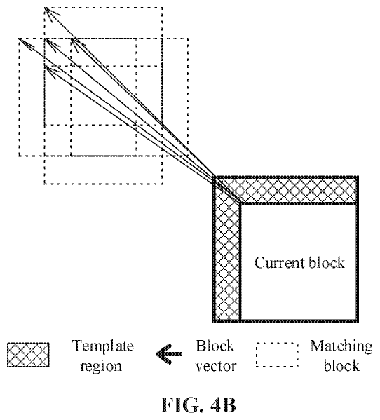

The technique of IntraTMP adaption for camera-captured content proposes performing template matching with a step size S (i.e., every S points in the horizontal and vertical directions, S>1) on the basis of the existing IntraTMP technique, as shown in FIG. 4A. For example, in a search region, matching blocks are not searched point by point in a raster scan order, but searched at intervals in the horizontal and vertical directions of the search region. Illustratively, when a block vector for current template matching is (X0, Y0), a next block vector for template matching shall be (X0+S, Y0), and a vertical coordinate of a block vector for template matching in a next row shall be Y0+S. After template matching is completed, the best matching block may also be refined within a certain range, as shown in FIG. 4B, where template matching is performed with a smaller step size S′, where 1≤S′<S, so that the matching result may be optimized. This technique effectively reduces the complexity of the IntraTMP mode while maintaining good coding efficiency. In FIGS. 4A and 4B, hatched regions represent template regions; arrows represent block vectors, and dashed boxes represent matching blocks.

### (3) IntraTMP Multi-Candidate Technique

The IntraTMP multi-candidate technique proposes obtaining N candidate matching blocks in a reference region through a template matching operation, in other words, constructing a candidate block list with a length of N, and candidate blocks in the list may be sorted according to template errors between the candidate blocks and a current block. A certain candidate block in the list is selected as a final prediction block based on an index. For a coding block using the IntraTMP multi-candidate technique, after decoding that the IntraTMP flag intra_tmp_flag is true, intra_tmp_idx is further decoded, and the syntax element intra_tmp_idx may indicate an index of the selected candidate block.

```
intra_tmp_flag
  if(intra_tmp_flag)
  {
    intra_tmp_idx
  }
```

In a possible implementation, the template matching process for constructing the candidate block list is as follows:

First operation: performing a first search with a certain step size, for example, both a horizontal step size and a vertical step size are 4; and obtaining N optimal matching blocks with a certain spacing (top N blocks with the smallest template errors); and

Second operation: performing a second search in adjacent regions of the N matching blocks obtained in the first operation, wherein these adjacent regions may be set as multiple non-overlapping regions according to the step size in the first operation; and obtaining M optimal matching blocks from these regions (which may include the matching blocks obtained in the first operation).

The same construction process is adopted at the encoding end and the decoding end to obtain a consistent candidate block list.

intra_tmp_idx may be coded using fixed-length coding or variable-length coding, for example, truncated binary coding.

In a possible implementation, the variable-length coding is as follows:

A smaller index (a smaller value of intra_tmp_idx) corresponds to a smaller template error of a candidate block and a statistically higher probability of being selected. Shorter codewords may be set for smaller intra_tmp_idx values, as shown in Table 1.

TABLE 1

| | |
|---|---|
| intra_tmp_idx | Binary symbol |

| | | |
|---|---|---|
| 0 | 1 | |
| 1 | 0 | 1 |
| 2 | 0 | 0 |
| Bin index | 0 | 1 |

When the maximum value N of intra_tmp_idx is relatively large, codewords of the same length may be assigned to larger intra_tmp_idx values. For example, N is 15, as shown in Table 2.

TABLE 2

| Intra_tmp_idx | Binary symbol | | | | |
|---|---|---|---|---|---|
| 0 | 1 | 1 | | | |
| 1 | 1 | 0 | 0 | | |
| 2 | 1 | 0 | 1 | | |
| 3~6 | 0 | x | x | x | |
| 7~14 | 0 | x | x | x | x |

In Table 2 above, x may be obtained using truncated binary coding.

### (4) IntraTMP Fusion Prediction Technique

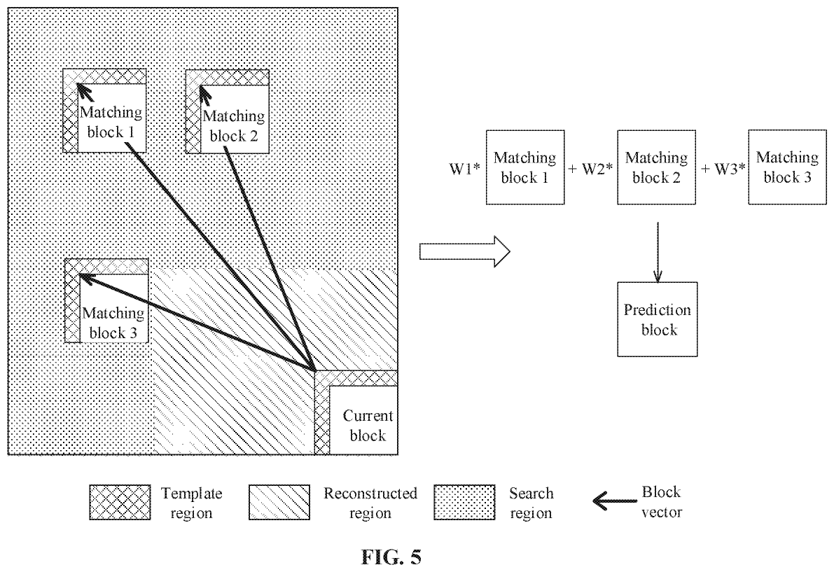

Through intra template matching, template errors between the current block and reconstructed blocks at different positions may be obtained, and these reconstructed blocks may be represented by block vectors pointing from the current block to the reconstructed blocks. A candidate block vector list may be constructed to record block vectors with smaller template errors during template matching. One or more block vectors may be selected from the candidate block vector list according to conditions such as block vector spacing and template errors, and the reconstructed blocks pointed to by the selected block vectors serve as matching blocks of the current block. A weight value may be determined for each matching block. These matching blocks may be weighted and fused according to their weight values to obtain a final prediction block, realizing IntraTMP combined fusion prediction. The specific process is shown in FIG. 5, where a hatched region represents a template region, an obliquely filled region represents a reconstructed region, a dotted region represents a search region, and arrows represent block vectors. For the current block, after determining matching block 1, matching block 2, and matching block 3 based on different block vectors, weighted fusion may be performed on matching block 1, matching block 2, and matching block 3 according to weight value W1, weight value W2, and weight value W3 to obtain a prediction block of the current block.

It should be noted that the number of matching blocks to be fused may be a fixed value, or may be determined according to the magnitude relationship of template errors of the matching blocks. For example, for N available matching blocks, a threshold Threshold=minSAD<<1 is set, where minSAD is the minimum value among the template errors of these matching blocks. Only matching blocks with template errors less than or equal to the threshold are used in the fusion process. Matching blocks for fusion may be determined through this method.

After the matching blocks for fusion are determined, weights of the matching blocks may be determined using preset fixed values, calculation based on template errors, template derivation, and other methods.

### (5) IntraTMP Filtering Technique.

A matching block (also referred to as a reference block) obtained through intra template matching is usually directly used as a prediction block of the current block. Filtering may be performed on the prediction block to improve prediction performance. A block-level flag may be used herein to indicate whether filtering processing is applied to the prediction block of the current block. There may be various forms of filters, and one possible filter form is as follows:

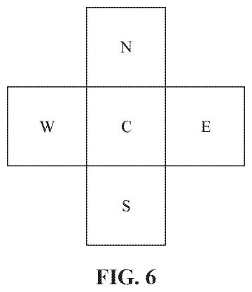

PredC=c0C+c1N+c2S+c3E+c4W+c5B (1)

where C is a pixel to be filtered, N is a pixel above C, S is a pixel below C, Wis a pixel to the left of C, and E is a pixel to the right of C, as shown in FIG. 6. B (Bias) is a fixed value, for example, B is a median value of a pixel range. c0 to c5 are filter coefficients.

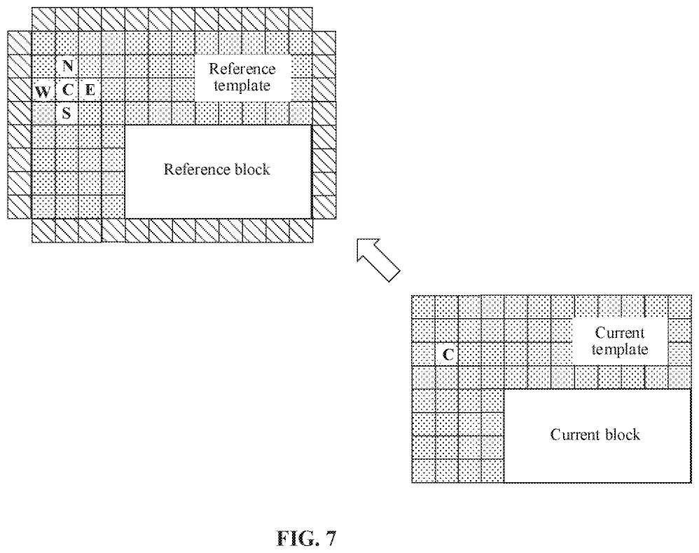

In a possible implementation, a method for determining filter coefficients is to train coefficients of the filter using a reference block template and a current block template. For example, the template region is a reconstructed region of four rows above and four columns to the left of the current block. For the reference block, an additional row of regions above, below, to the left, and to the right of the template region is also required as a reference, as shown in FIG. 7. When part of the additional region has not been coded, it may be copied from the template region. In FIG. 7, the obliquely filled region represents an additional row of regions above, below, to the left, and to the right of the reference template region.

In a possible implementation, a method for training filter coefficients is to calculate a set of coefficients to minimize the Mean Square Error (MSE) between the filtered reference block template and the current block template.

When the current block uses IntraTMP filtering, filtering may be performed on the prediction block directly obtained from the reference block. A possible method is to sequentially filter each pixel in a left-to-right and top-to-bottom order. The filtered value is used as a prediction value.

### (6) Template-Derived IntraTMP Fusion Technique

The IntraTMP fusion prediction technique can obtain multiple reference blocks through an intra template matching process and perform weighted fusion may be performed on these reference blocks. Weight values are usually obtained using predefined fixed values or calculated based on template errors of the reference blocks. For example, template errors of the reference blocks are SAD1 to SADn respectively, and one weight calculation method is:

SADi=(SADi==0)?1:SADi (2)

$$SUM = {\sum }_{i = 1}^{n} {SAD}_{i} \qquad ( 3 )$$

Wi=(SUM−SADi)/((n−1)*SUM) (4)

where n is the total number of reference blocks, and Wi is a weight value corresponding to a reference block with a template error of SADi. The form of the prediction block after weighted fusion may be as follows:

$$Pred = {\sum }_{i = 1}^{n} Wn * Predn \qquad ( 5 )$$

The template-derived IntraTMP fusion method uses a method similar to filter coefficient training to obtain weights for fusion prediction based on each reference block template and the current block template. For example, five reference blocks are used for weighted fusion in the following form:

$$pred = {\sum }_{n = 0}^{4} {w}_{n} * {refBlock}_{n} + {w}_{5} * Bias \qquad ( 6 )$$

Another weight method is to calculate a set of coefficients to minimize the MSE between the fused reference block template and the current block template.

### (7) Template-Based Intra Mode Derivation (TIMD) Technique

The TIMD technique takes an L-shaped portion of reconstructed pixels adjacent to the current block as a template. By traversing an MPM list and calculating predicted pixels of the template region under different intra prediction modes, template errors between predicted pixels and reconstructed pixels under different intra prediction modes may be obtained, represented by Sum of Absolute Transformed Difference (SATD). An optimal intra prediction mode may be selected according to the template errors. At the decoding end, the intra prediction mode may be obtained through the same derivation manner, thereby reducing coding bits of mode information.

### (8) Combined Inter and Intra Prediction (CIIP) Technique.

The CIIP technique combines intra prediction and inter prediction to obtain a prediction block of the current block using a weighted combination of an intra prediction block and an inter prediction block. In ECM, CIIP is combined with template-based prediction technique, and different weight values are assigned to different regions at the same time, further improving prediction accuracy. Specifically, the intra prediction block pred_intra may be obtained from the TIMD mode, and the inter prediction block pred_inter may be obtained from the template-based Merge mode. Weight values wIntra and wInter may be determined according to the derived intra prediction mode and the position of the pixel to be predicted. The final prediction block Pred may be calculated as follows:

Pred=(wIntra*pred_intra+wInter*pred_inter+4)>>3 (7)
where wIntra and wInter are determined based on the intra prediction mode intra_dir derived from TIMD. There are 65 intra angular prediction modes (2≤intra_dir≤66) in ECM. When 2≤intra_dir<34, the current block is vertically divided into four equal parts; and when 34≤intra_dir≤66, the current block is horizontally divided into four equal parts. The weight values wIntra and wInter for each region are shown in Table 3.

TABLE 3

| Region index | (wIntra, wInter) |
|---|---|
| 0 | (6, 2) |
| 1 | (5, 3) |
| 2 | (3, 5) |
| 3 | (2, 6) |

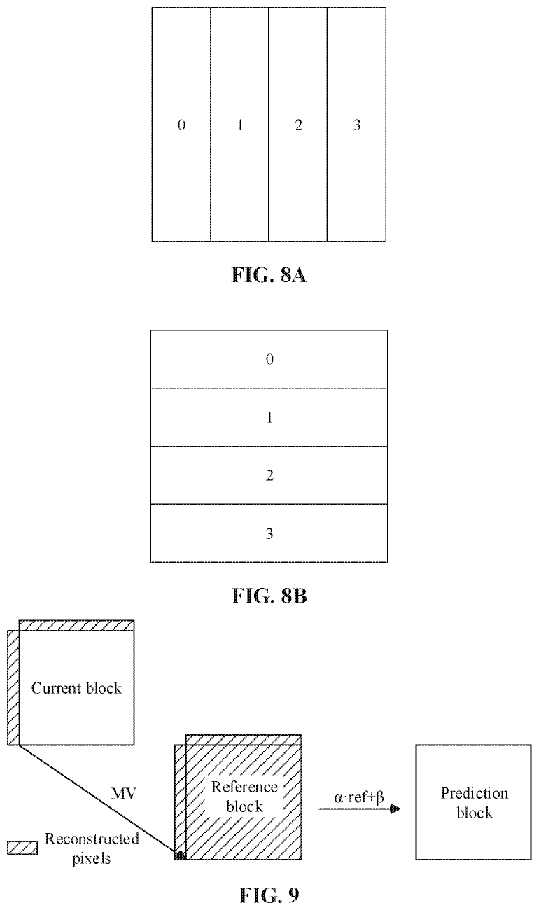

Under vertical quartering, the indices of each region are shown in FIG. 8A; and under horizontal quartering, the indices of each region are shown in FIG. 8B.

In particular, when intra_dir is equal to 0 or 1, no sub-regions are partitioned, and wIntra and wInter may be selected from (3, 1), (2, 2), (1, 3) according to the coding types (intra or inter) of two coding blocks located at the left and above the current block.

(9) Adaptive Reordering of Merge Candidates with Template Matching (ARMC-TM)

ARMC-TM is mainly used in inter prediction. This technique proposes that during construction of a merge list for an inter-coded block, an error, such as SAD, between a template of a merge candidate and a template of the current block may be calculated, and different merge candidates may be reordered according to the error. Merge candidates located earlier in the list correspond to shorter index codewords, thereby improving coding efficiency. When motion information of a merge candidate is bi-prediction, a template of the candidate may also be obtained by bi-prediction.

In addition, this technique further proposes dividing the merge candidate list into multiple sub-lists, and candidates in each sub-list may be reordered separately. To reduce complexity, reordering may not be performed for certain sub-lists. For example, when the current sub-list is not the first sub-list and is the last sub-list, the current sub-list is not reordered.

### (10) Intra Block Copy (IBC) Technique

IBC is an intra prediction technique that obtains prediction pixels based on block matching. Similar to inter prediction, prediction may be realized by a block vector pointing from the current block to a reference block. The difference is that reference blocks for inter prediction come from coded reconstructed frames, while reference blocks for IBC come from the reconstructed part of the current frame. Block vector information needs to be transmitted in a bitstream, so similar to intra prediction, there are IBC-AMVP mode and IBC-Merge mode.

IBC-AMVP mode: a predicted block vector is obtained from a constructed merge candidate list, and a reference block of the current block and a corresponding final block vector are obtained through processes such as hash search and full search. The final block vector is coded based on the predicted block vector to improve coding efficiency; and

IBC-Merge mode: prediction is performed through a constructed merge candidate list, a merge candidate which is the best in the list is selected through coding processes such as SATD and RDO, and a block vector of the merge candidate is inherited to obtain a reference block and complete prediction. The index of the merge candidate in the list is coded instead of the block vector itself, improving coding efficiency.

The merge candidate list may consist of coding information such as coded blocks at adjacent and non-adjacent positions, historical coded blocks, temporal coded blocks, and averages of candidate block vectors. After constructing the merge candidate list, the list may be reordered according to template errors of each candidate in the list. The template error may be obtained from a template error, such as an SAD value, between a template of a reference block of each candidate and a template of the current block.

A merge candidate may include information such as an LIC flag. If the LIC flag of a candidate is true, when the current block selects the candidate, the IBC-LIC technique is used for prediction.

On the basis of the IBC-Merge mode, there is an IBC-MBVD mode. For a BV obtained from a merge candidate, a Block Vector Difference (BVD) may be determined based on an offset and a direction to modify an original BV. For example, when the direction is upward, the offset is k, and the original BV is BV0=(x0, y0), the new BV0′ after applying BVD may be expressed as: BV0′=(x0, y0−k).

### (11) Local Illumination Compensation (LIC) Technique

LIC is a block-level linear transformation technique. As shown in FIG. 9, motion information between the current block and a reference block is MV, and the LIC technique assumes a linear relationship between a prediction block of the current block and the reference block, which may be expressed as:

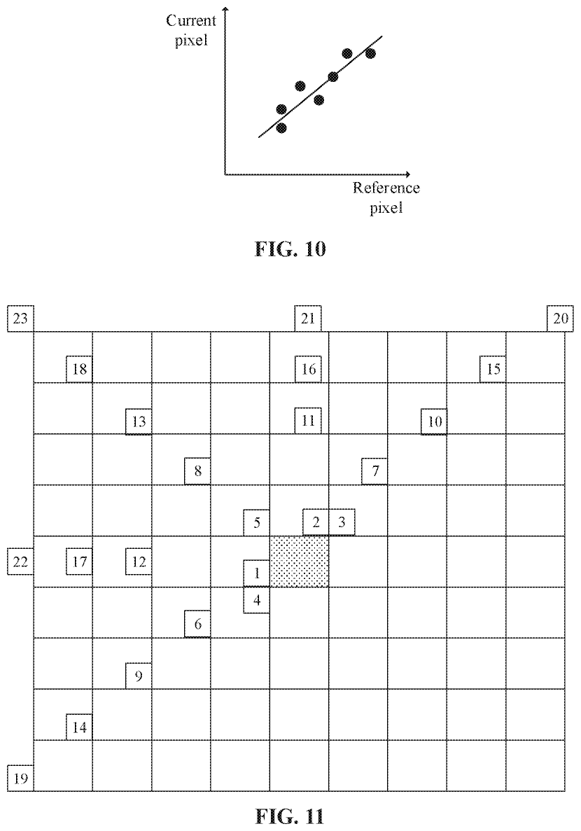

Pred=α·ref+β (8)
where α and β may be derived from pixels in a reconstructed region adjacent to the current block and pixels in a reconstructed region adjacent to the reference block, and obtained by methods such as the least square method. In addition, the linear relationship shown in Equation (8) is illustrated in FIG. 10.

In addition, a threshold may be set, and different linear parameters may be selected according to a magnitude relationship between reference block pixels and the threshold, expressed as:

$$\{ \begin{matrix}Pred = {α}_{1} \cdot ref + {β}_{1} , & ref <= threshold \\ Pred = {α}_{2} \cdot ref + {β}_{2} , & else\end{matrix} \qquad ( 9 )$$

### (12) Non-Adjacent Candidates for Inter-Merge

Non-adjacent candidates may be added when a Merge List is constructed based on inter-coded blocks in Merge mode, and various non-adjacent points may be selected according to the size of the current block to attempt to construct merge candidates. Positions of non-adjacent points relative to the current block are shown in FIG. 11, where dotted small blocks represent the current block. Positions labeled 1 to 5 in FIG. 11 are referred to as adjacent candidates, and the rest are referred to as non-adjacent candidates.

### (13) Multi-Mode IBC-LIC Technique

The multi-mode IBC-LIC technique divides the IBC-LIC method into multiple sub-methods according to template regions used for deriving linear parameters and the number of linear transformation models. In one example, IBC-LIC is divided into the following four methods:
\textcircled{1} Using an L-shaped template region and a single model;
\textcircled{2} Using a left template region and a single model;
\textcircled{3} Using a right template region and a single model; and
\textcircled{4} Using an L-shaped template region and two models (different models are selected for linear transformation according to a threshold).

A specific IBC-LIC sub-method may be selected by coding an index.

### (14) List-Based IBC Transform Prediction Technique

The list-based IBC transform prediction technique may construct an available transformation model candidate list of the current block based on transformation models of coded blocks at adjacent and non-adjacent positions, historical transformation models, temporal transformation models, default transformation models, and the like, and then select a specific transformation model in the list according to an index written into a bitstream to transform a reference block of the current block to obtain a prediction block.

For a current block coded by Inter, IBC, IntraTMP, or other methods, a reference block may be transformed to obtain a prediction block. The transformation on the reference block may be in the following forms:

LIC transformation: a relationship between a prediction block pixel Pred(x,y) and a reference block pixel ref(x,y) is as follows:

Pred(x,y)=α·ref(x,y)+β (10)

Multi-model LIC transformation: a relationship between a prediction block pixel Pred(x,y) and a reference block pixel ref(x,y) is as follows:

$$\{ \begin{matrix}Pred ( x , y ) = {α}_{1} \cdot ref ( x , y ) + {β}_{1} , & ref ( x , y ) <= threshold \\ Pred ( x , y ) = {α}_{2} \cdot ref ( x , y ) + {β}_{2} , & else\end{matrix} \qquad ( 11 )$$

where threshold is a reference pixel threshold, and different parameters are used for linear transformation on reference block pixels above or below the threshold.

Filter transformation: a relationship between a prediction block pixel Pred(x,y) and a reference block pixel is as follows:

Pred(x,y)=c0C+c1N+c2S+c3E+c4W+c5B (12)

where C is a reference block pixel at (x, y), N is a pixel above C, S is a pixel below C, W is a pixel to the left of C, and E is a pixel to the right of C, as shown in FIG. 6. B (Bias) is a fixed value, for example, a median value of a pixel range. c0 to c5 are filter coefficients.

Accordingly, required parameter information (such as αᵢ, βᵢ, cᵢ, threshold, etc.) may be stored as a transformation model corresponding to the position of the current block, for constructing a transformation model candidate list of a current block in subsequent IBC coding.

Before applying a transformation model in the list, an offset value may be calculated according to pixel values of template regions of the current block and the reference block to adjust the prediction value, for example:

Assume the template includes N pixels, template prediction Pred of each pixel is calculated based on the template of the reference block, and then a total difference totalDiff between the template prediction and template pixels Rec of the current block as well as an offset are calculated as follows:

totalDiff=>Σ(Rec−Pred) (13)

offset=totalDiff/N (14)

The final prediction value may be the transformed prediction value plus offset. For example, using LIC transformation:

Pred(x,y)=α·ref(x,y)+β+offset (15)

Here, whether transformation models are the same may be determined as follows:
a. Different transformation types mean different models;
b. For LIC transformation, different a coefficients mean different models;
c. For multi-model LIC transformation, any different di means a different model;
d. For Filter transformation, any different cᵢ means a different model; and
e. Multiple models.

Illustratively, a coded block at an adjacent position of the current block is coded using the IBC-LIC technique, and model parameters α₁ and β₁ are derived based on a template region. The transformation model (α₁, β₁) is stored, and when coding the current block, the transformation model is added as a candidate to the available transformation model candidate list. The transformation model is then selected according to an index, and a prediction block is obtained through the following operations:
Operation 1: calculating an offset value offset of the model according to templates of the current block and the reference block as well as the selected transformation model (α₁, β₁);
Operation 2: adjusting the parameter according to offset: β₁=β₁+offset; and
Operation 3: calculating and obtain a prediction block: Pred=α₁·ref+β₁.

This technique has a block-level flag cu_ibc_model_merge_flag for indicating whether to use the technique and an index cu_ibc_model_merge_idx to indicate an index of the selected transformation model in the list. In an example, the technique explicitly transmits the above syntax elements under both IBC-AMVP and IBC-Merge modes. In addition, when a coded block under the IBC-Merge mode inherits coding information from a coded IBC-Model-Merge block, only type information of the transformation model is inherited, and a new transformation model needs to be re-derived according to the template for prediction.

### (15) Adaptive IBC-MBVD List Construction Technique

This technique proposes an IBC-MBVD list construction technique with adaptive offset sizes. An MBVD list including K candidates may be obtained through the following operations:
Operation 1: setting a maximum offset to N pixels, for example N=256; setting the number D of possible directions, for example D=4 (up, down, left, right); setting an initial search interval to M pixels, for example M=8; and setting a size K of the MBVD list, for example K=8;
Operation 2: determining template errors of reference blocks with various offset sizes at intervals of M along each direction, where offset does not exceed N; and storing K candidates with the smallest template errors in the MBVD list, where a candidate is a combination of an offset value and a direction, which may determine a specific reference block position;
Operation 3: for each candidate in the list, determining template errors at new positions with an offset of ±M/2 along the direction of the candidate position; and storing K candidates with the smallest template errors in the MBVD list; and
Operation 4: repeating Operation 3, and dividing M by 2 each time until M equals 1 pixel.

### (16) BVD Prediction Technique

The BVD prediction technique proposes that partial information of BVD, such as signs of horizontal and vertical components and partial bit values used for coding the magnitude of BVD, may be predicted. Each possible prediction corresponds to one possible BVD. These BVDs may be sorted based on template errors of reference blocks corresponding to respective possible BVDs, so as to confirm the final BVD. In an implementation, a flag written into a bitstream is used to indicate whether the BVD with the smallest template error is taken as the final BVD.

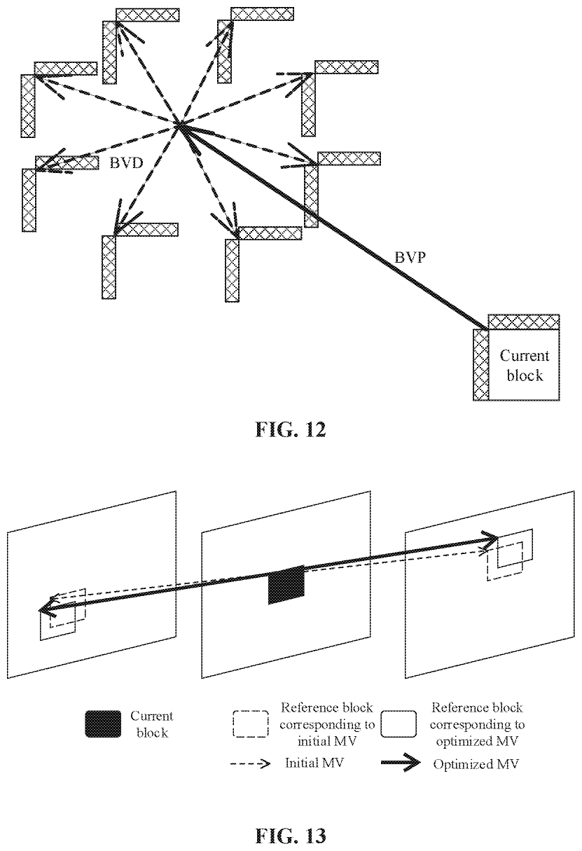

For example, as shown in FIG. 12, for the current block, multiple block vectors may be obtained through search. For these multiple block vectors, after obtaining the Block Vector Prediction (BVP) indicated by the bold solid line, multiple Block Vector Difference (BVD) indicated by dashed lines may be calculated; then the BVD with the smallest template error is selected from these BVDs as the final BVD.

### (17) Bidirectional Local Illumination Compensation Technique

This technique proposes that an inter-coded block using bi-prediction may derive two sets of linear transformation models respectively for its reference blocks in List 0 and List 1. Compared with the LIC technique under uni-prediction, the bidirectional LIC technique may recursively derive transformation models used by the two reference blocks. For example, a transformation model M0 corresponding to L0 is first derived based on a template Tcur of the current block and a template T0 of the reference block in List 0; then Tcur is adjusted to Tcur′ according to T0 and M0, and a transformation model M1 corresponding to L1 is derived from Tcur′ and T1; finally, Tcur is adjusted to Tcur″ according to T1 and M1, and a transformation model M0 corresponding to L0 is re-derived from Tcur″ and T0. After M0 and M1 are obtained, M0 and M1 may be respectively applied to the reference blocks corresponding to L0 and L1 in the motion compensation stage, so as to obtain a final prediction block.

### (18) Decoder-Side Motion Vector Refinement (DMVR) Technique

The DMVR technique proposes that a Motion Vector (MV) may be be optimized according to an error between two reference blocks of a bi-predicted inter-coded block. The MV may be adjusted within a given range and a bidirectional matching error may be calculated, and the MV corresponding to the minimum bidirectional matching error is taken as the optimization result, thereby improving prediction accuracy. As shown in FIG. 13, a black-filled small block represents the current block, a dashed small block represents a reference block corresponding to an initial MV, and a solid small block represents a reference block corresponding to an optimized MV.

In addition, the calculation of the bidirectional matching error can also refer to the magnitude of the motion vector adjustment. For example, the bidirectional matching error may be calculated as bilCost=mvDistanceCost+sadCost or bilCost=satdCost*costFactor, where bilCost represents the bidirectional matching error, sadCost and satdCost represent the SAD or SATD between the two reference blocks, mvDistanceCost represents the cost of adjusting a motion vector, and costFactor represents a different factor corresponding to a different adjustment magnitude.

### (19) Inter Non-Local Illumination Compensation (NL-IC) Technique

The NL-IC technique is mainly used for inter prediction and includes two parts. First, after an inter-coding block is coded, a linear transformation model may be calculated based on a reference block and a reconstructed block of the current block, and the transformation model may be stored as part of the motion information. Second, when the current block uses an inter prediction mode, NL-IC candidates may be added to a merge list, where an NL-IC candidate refers to acquiring motion information from spatially adjacent and non-adjacent positions of the current block, and acquiring a transformation model at the same position. When an NL-IC candidate is selected by the current block, the current block may transform the reference block using the transformation model of the NL-IC candidate. Compared with the LIC technique that derives a transformation model based on a template, the NL-IC technique uses a transformation model calculated from a coded block and its reference block.

In a possible implementation, up to N NL-IC candidates may be added after historical candidates in the merge list. The merge list may be then reordered according to the ARMC-TM technique, and a final candidate may be selected according to a merge index. When performing template error calculation of an NL-IC candidate, the error calculation may be performed after transforming a reference block template according to a transformation model corresponding to the candidate.

In summary, the local illumination compensation technique assumes a linear relationship between a coded block and a reference block, so a transformation model is calculated based on adjacent pixels of the coded block and its reference block, and the transformation model is applied to the reference block to improve prediction accuracy. However, a transformation model obtained based on adjacent pixels cannot guarantee accuracy. Another method of obtaining a transformation model is inheritance from a coded block. Similar to acquiring motion information from a coded block, a transformation model used by a coded block may be taken as a type of motion information and reused. The list-based IBC transform prediction method proposes constructing a transformation model list based on transformation models of multiple coded blocks, and selecting one transformation model through an index from the list for use by the current block. This method is only applicable to the intra block copy prediction mode. In addition, this method does not provide a coding method when a coded block has multiple components (such as Y, U, V), so it cannot be directly applied to inter-coded blocks (which usually contain three components), reducing coding and decoding efficiency.

Based on this, embodiments of the present disclosure provide an encoding method. When a current block uses an inter prediction mode, a transformation model candidate list of the current block is constructed; a transformation model of the current block is determined based on the transformation model candidate list, and a reference block of the current block is determined; the reference block is transformed based on the transformation model to determine a prediction block of the current block. Embodiments of the present disclosure further provide a decoding method. A bitstream is decoded to determine a value of first syntax flag information; when the first syntax flag information indicates that the current block uses an inter prediction mode, a transformation model candidate list of the current block is constructed; a transformation model of the current block is determined based on the transformation model candidate list, and a reference block of the current block is determined; and the reference block is transformed based on the transformation model to determine a prediction block of the current block.

In this way, at both the encoding end and the decoding end, when the current block uses the inter prediction mode, a transformation model candidate list of the current block is first constructed, and then the transformation model and the reference block of the current block are determined accordingly. By transforming the reference block using the transformation model, not only the diversity of inter prediction may be improved, but also the prediction accuracy may be enhanced, thereby improving coding and decoding efficiency.

Various embodiments of the present disclosure will be described in detail below with reference to the accompanying drawings.

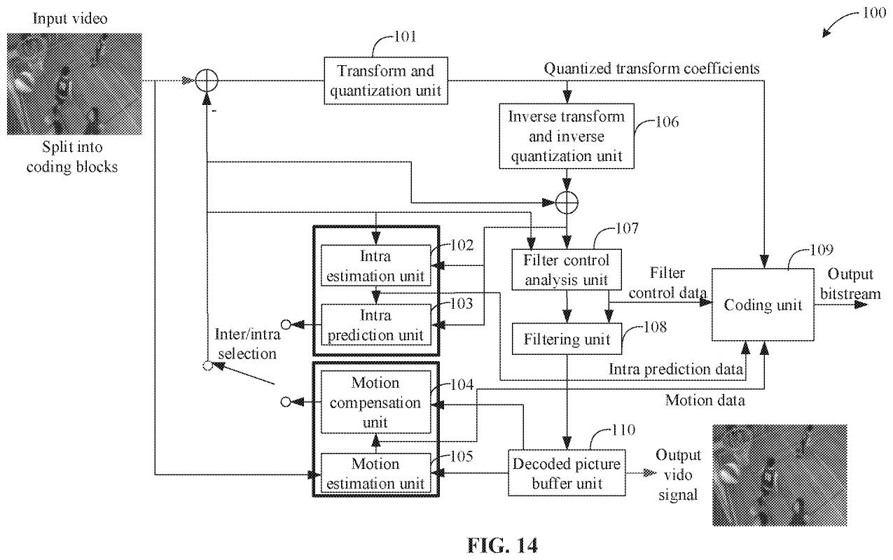

FIG. 14 is a block diagram of an encoder provided by an embodiment of the present disclosure. As shown in FIG. 14, an encoder 100 may include a transform and quantization unit 101, an intra estimation unit 102, an intra prediction unit 103, a motion compensation unit 104, a motion estimation unit 105, an inverse transform and inverse quantization unit 106, a filter control analysis unit 107, a filtering unit 108, a coding unit 109, a decoded picture buffer unit 110, and the like. The filtering unit 108 may implement deblocking filtering and Sample Adaptive Offset (SAO) filtering, and the coding unit 109 may implement header information coding and Context-based Adaptive Binary Arithmetic Coding (CABAC). For an input original video signal, a video coding block may be obtained by dividing a Coding Tree Unit (CTU). Then, residual pixel information obtained after intra or inter prediction may be transformed by the transform and quantization unit 101 on the video coding block, including transforming the residual information from a pixel domain to a transform domain, and the obtained transform coefficients may be quantized to further reduce a bit rate. The intra estimation unit 102 and the intra prediction unit 103 are configured to perform intra prediction on the video coding block. Specifically, the intra estimation unit 102 and the intra prediction unit 103 are configured to determine an intra prediction mode to be used for coding the video coding block. The motion compensation unit 104 and the motion estimation unit 105 are configured to perform inter prediction coding of the received video coding block with respect to one or more blocks in one or more reference frames to provide temporal prediction information. Motion estimation performed by the motion estimation unit 105 is a process of generating a motion vector that can estimate motion of the video coding block, and then motion compensation may be performed by the motion compensation unit 104 based on the motion vector determined by the motion estimation unit 105. After determining the intra prediction mode, the intra prediction unit 103 is further configured to provide the selected intra prediction data to the coding unit 109, and the motion estimation unit 105 may also send the calculated and determined motion vector data to the coding unit 109. In addition, the inverse transform and inverse quantization unit 106 is configured for reconstruction of the video coding block to reconstruct a residual block in the pixel domain. The reconstructed residual block may be processed by the filter control analysis unit 107 and the filtering unit 108 to remove blocking artifacts, and then the reconstructed residual block may be added to a predictive block in a frame of the decoded picture buffer unit 110 to generate a reconstructed video coding block. The coding unit 109 is configured to code various coding parameters and quantized transform coefficients. In a CABAC-based coding algorithm, context content may be based on adjacent coding blocks and may be used to code information indicating the determined intra prediction mode, and output a bitstream of the video signal. The decoded picture buffer unit 110 is configured to store reconstructed video coding blocks for prediction reference. With the progress of video picture coding, new reconstructed video coding blocks may be continuously generated, and these reconstructed video coding blocks may be stored in the decoded picture buffer unit 110.

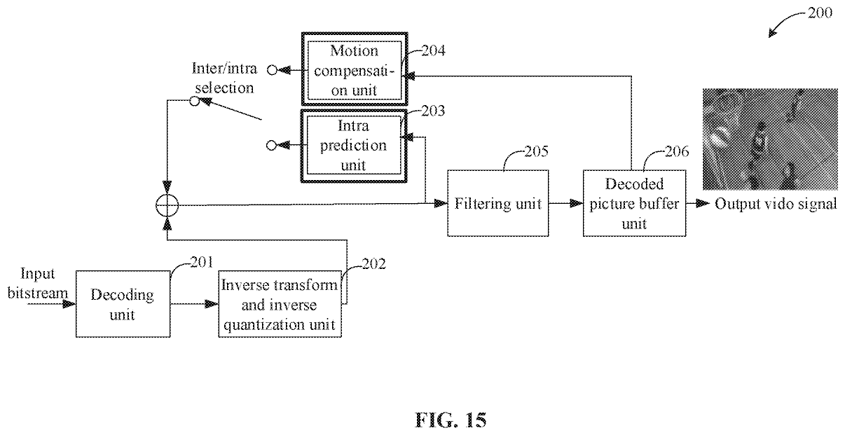

FIG. 15 is a block diagram of a decoder provided by an embodiment of the present disclosure. As shown in FIG. 15, a decoder 200 includes a decoding unit 201, an inverse transform and inverse quantization unit 202, an intra prediction unit 203, a motion compensation unit 204, a filtering unit 205, a decoded picture buffer unit 206, and the like. The decoding unit 201 may implement header information decoding and CABAC decoding, and the filtering unit 205 may implement deblocking filtering and SAO filtering. After the input video signal is encoded as shown in FIG. 14, a bitstream of the video signal may be output. The bitstream may be input into the decoder 200 and first processed by the decoding unit 201 to obtain decoded transform coefficients. The transform coefficients may be processed by the inverse transform and inverse quantization unit 202 to generate a residual block in the pixel domain. The intra prediction unit 203 may be configured to generate prediction data of a current video decoded block based on the determined intra prediction mode and the data from a previously decoded block of the current frame or picture. The motion compensation unit 204 may determine prediction information for the video decoded block by parsing motion vectors and other associated syntax elements, and use the prediction information to generate a predictive block of the video decoded block being decoded. A decoded video block may be formed by summing the residual block from the inverse transform and inverse quantization unit 202 and a corresponding predictive block generated by the intra prediction unit 203 or the motion compensation unit 204. The decoded video signal may be processed by the filtering unit 205 to remove blocking artifacts, which can improve video quality. The decoded video block may be then stored in the decoded picture buffer unit 206, which stores reference pictures for subsequent intra prediction or motion compensation and is also used for output of the video signal, i.e., the restored original video signal is obtained.

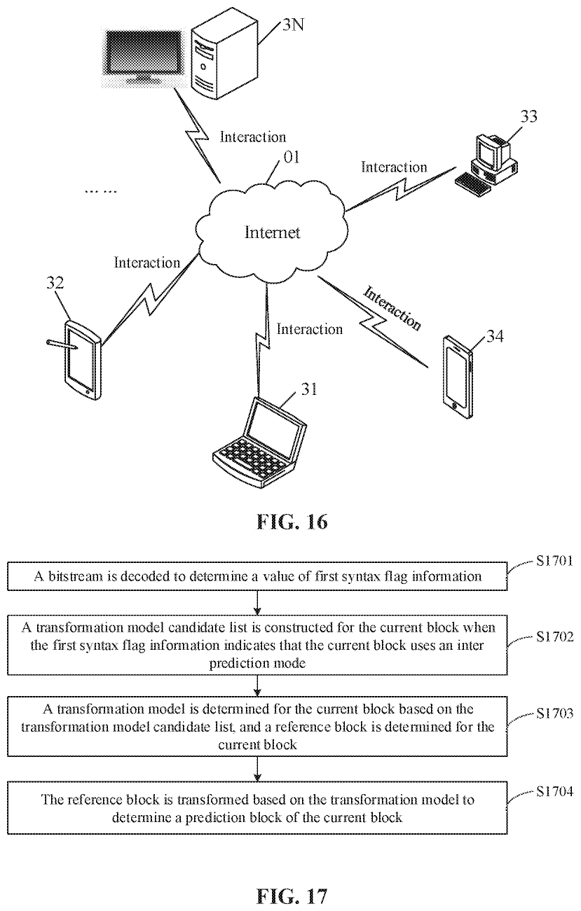

Further, FIG. 16 is a network architecture diagram of an encoding and decoding system provided by an embodiment of the present disclosure. As shown in FIG. 16, the network architecture includes one or more electronic devices 31 to 3N and a communication network 01, where the electronic devices 31 to 3N may perform video interaction through the communication network 01. Electronic devices may be various types of devices with video encoding and decoding functions during implementation. For example, the electronic devices may include smart phones, tablet computers, personal computers, personal digital assistants, navigators, digital phones, video phones, televisions, sensing devices, servers, and the like, which are not specifically limited in embodiments of the present disclosure.

In embodiments of the present disclosure, a network architecture of a video encoding and decoding system including a decoding method and an encoding method is provided. The decoder or encoder in embodiments of the present disclosure may be the above electronic device. That is, the electronic device in embodiments of the present disclosure has a video encoding and decoding function, and generally may include a video encoder (i.e., an encoder) and a video decoder (i.e., a decoder).

It should also be noted that embodiments of the present disclosure are mainly applied to the intra prediction part and/or the inter prediction part (indicated by bold frames) as shown in FIG. 14 and the intra prediction part and/or the inter prediction part (indicated by bold frames) as shown in FIG. 15. That is, embodiments of the present disclosure may be implemented by an encoder, a decoder, or even both an encoder and a decoder.

It should also be noted that when embodiments of the present disclosure are applied to the encoder as shown in FIG. 14, a “current block” specifically refers to a coding block to be currently predicted; and when embodiments of the present disclosure are applied to the decoder as shown in FIG. 15, a “current block” specifically refers to a decoded block to be currently predicted.

In an embodiment of the present disclosure, FIG. 17 is a first flowchart of a decoding method provided by an embodiment of the present disclosure. As shown in FIG. 17, the method may include following operations.

S1701: a bitstream is decoded to determine a value of first syntax flag information.

It should be noted that in embodiments of the present disclosure, the method is implemented by a decoder. Specifically, based on the composition structure of the decoder 200 shown in FIG. 15, the decoding method of embodiments of the present disclosure may be applied to an intra prediction part and/or an inter prediction part, and is mainly applied to an inter prediction method inheriting a transformation model, which can improve the diversity of inter prediction.

It should also be noted that in embodiments of the present disclosure, the first syntax flag information is used to indicate whether a current block uses an inter prediction mode, which may be represented by cu_prediction_mode. In some embodiments, when the value of the first syntax flag information is a first value, it is determined that the first syntax flag information indicates that the current block uses an inter prediction mode; and when the value of the first syntax flag information is a second value, it is determined that the first syntax flag information indicates that the current block does not use an inter prediction mode.

Here, the first value is different from the second value, and both the first value and the second value may be in a parameter form or a numeric form. Specifically, the first syntax flag information may be a parameter written in a profile or a value of a flag, which is not specifically limited herein. For example, the first value may be 1 and the second value may be 0; or the first value may be 0 and the second value may be 1; or the first value may be true and the second value may be false; or the first value may be false and the second value may be true.

In a specific embodiment, taking the first value as 1 and the second value as 0 as an example, when the decoded value of cu_prediction_mode is 1, it may be determined that the first syntax flag information indicates that the current block uses an inter prediction mode; and when the decoded value of cu_prediction_mode is 0, it may be determined that the first syntax flag information indicates that the current block does not use an inter prediction mode.

S1702: a transformation model candidate list is constructed for the current block when the first syntax flag information indicates that the current block uses an inter prediction mode.

It should be noted that in embodiments of the present disclosure, when the current block uses an inter prediction mode, it is further required to determine whether the current block uses a transformation model candidate list-based manner. Here, a syntax element (such as second syntax flag information) may also be used to indicate whether the current block uses a transformation model candidate list-based manner.

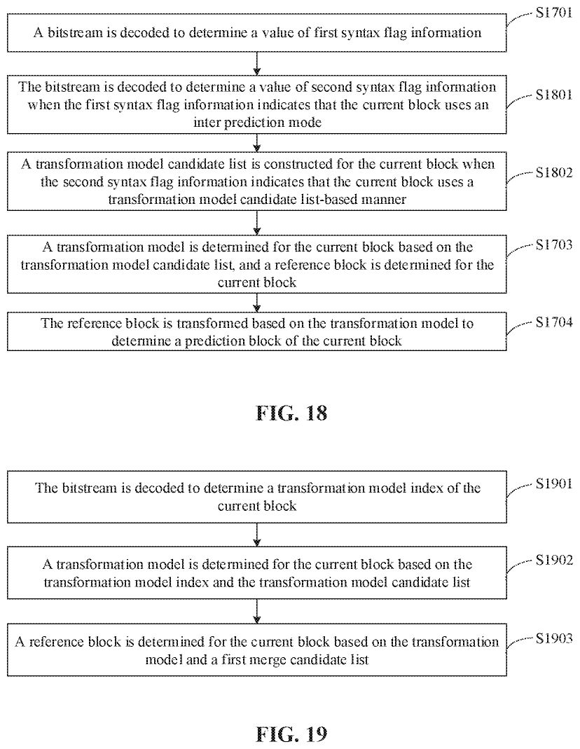

In some embodiments, based on the decoding method shown in FIG. 17, for S1702, referring to FIG. 18, the method may include:

S1801: the bitstream is decoded to determine a value of second syntax flag information when the first syntax flag information indicates that the current block uses an inter prediction mode; and

S1802: a transformation model candidate list is constructed for the current block when the second syntax flag information indicates that the current block uses a transformation model candidate list-based manner.

It should also be noted that in embodiments of the present disclosure, the second syntax flag information is used to indicate whether the current block uses a transformation model candidate list-based manner, which may be represented by cu_model_merge_flag. In some embodiments, when the value of the second syntax flag information is a first value, it is determined that the second syntax flag information indicates that the current block uses a transformation model candidate list-based manner; and when the value of the second syntax flag information is a second value, it is determined that the second syntax flag information indicates that the current block does not use a transformation model candidate list-based manner.

Here, the first value is different from the second value, and both the first value and the second value may be in a parameter form or a numeric form. Specifically, the second syntax flag information may also be a parameter written in a profile or a value of a flag, which is not specifically limited herein. For example, the first value may be 1 and the second value may be 0; or the first value may be 0 and the second value may be 1; or the first value may be true and the second value may be false; or the first value may be false and the second value may be true.

In a specific embodiment, taking the first value as 1 and the second value as 0 as an example, when the decoded value of cu_model_merge_flag is 1, it may be determined that the second syntax flag information indicates that the current block uses a transformation model candidate list-based manner; and when the decoded value of cu_model_merge_flag is 0, it may be determined that the second syntax flag information indicates that the current block does not use a transformation model candidate list-based manner.

It should also be noted that in embodiments of the present disclosure, a context model-based entropy decoding method may be adopted for the second syntax flag information. In some embodiments, the method may further include: decoding the bitstream based on a context model to determine a value of the second syntax flag information.

It should also be noted that in embodiments of the present disclosure, both cu_model_merge_flag and cu_prediction_mode belong to block-level syntax elements of the current block. For example, cu_prediction_mode is first decoded; when the value of cu_prediction_mode is 1, it is determined that the current block uses an inter prediction mode, and cu_model_merge_flag is then decoded; and when the value of cu_model_merge_flag is 1, it is determined that the current block uses a transformation model candidate list-based manner to determine a transformation model, and a transformation model candidate list needs to be constructed for the current block.

In some embodiments, constructing the transformation model candidate list of the current block may include: determining at least one candidate transformation model of the current block; and determining the transformation model candidate list of the current block based on the at least one candidate transformation model.

In a specific embodiment, determining at least one candidate transformation model of the current block may include at least one of:
determining an available transformation model for an adjacent position of the current block;
determining an available temporal transformation model of the current block;
determining an available transformation model for a non-adjacent position of the current block;
determining an available shifted temporal transformation model of the current block;
determining a historical available transformation model; and
determining a preset transformation model.

It should be noted that in embodiments of the present disclosure, when the value of cu_model_merge_flag is 1, it indicates that a transformation model candidate list needs to be constructed for the current block, which may be denoted as modelList, and the maximum length may be set to N, where N is a positive integer.

It should also be noted that in embodiments of the present disclosure, the preset transformation model may include: determining a transformation model corresponding to a local illumination compensation mode of the current block as the preset transformation model; or adjusting an existing candidate transformation model in the transformation model candidate list, and determining the adjusted candidate transformation model as the preset transformation model.

That is to say, in embodiments of the present disclosure, the preset transformation model serving as a default transformation model may be an LIC transformation model with model parameters (α_{Y0}, β_{Y0}, α_{U0}, β_{U0}, α_{V0}, β_{V0}), or a transformation model obtained by adjusting an existing candidate transformation model in the modelList, etc.

In some embodiments, for the transformation model candidate list, transformation models may be added in the following candidate order: \textcircled{1} available transformation models at adjacent positions; \textcircled{2} available temporal transformation models; \textcircled{3} available transformation models at non-adjacent positions; \textcircled{4} available shifted temporal transformation models; \textcircled{5} historical available transformation models; and \textcircled{6} preset transformation models.

In some embodiments, for the transformation model candidate list, the method may further include: after determining a new candidate transformation model of the current block, comparing the new candidate transformation model with existing candidate transformation models in the transformation model candidate list; and adding the new candidate transformation model to the transformation model candidate list when the new candidate transformation model is different from all existing candidate transformation models in the transformation model candidate list. In this way, redundancy is avoided by comparing a newly added transformation model with existing candidates in the modelList.

In some embodiments, for the transformation model candidate list, the method may further include: when constructing the transformation model candidate list of the current block, determining a derived transformation model of the current block; and adding the derived transformation model to the transformation model candidate list.

In embodiments of the present disclosure, a derivation-based transformation model may be taken as one of the candidate transformation models. For example, the transformation model candidate list may be adjusted to {LIC, LIC_LEFT, LIC_TOP, LIC_MM, Filter, Model0, Model1, . . . }. The LIC, LIC_LEFT, . . . , Filter, etc. represent different methods for deriving a derived transformation model based on a template; and Model0, etc. represent transformation models inherited from spatial and temporal domains, so as to construct a transformation model candidate list.

S1703: a transformation model is determined for the current block based on the transformation model candidate list, and a reference block is determined for the current block.

It should be noted that in embodiments of the present disclosure, the transformation model of the current block may be determined first based on the transformation model candidate list, and then the reference block of the current block may be determined based on the transformation model; alternatively, the reference block of the current block may be determined first, and then the transformation model of the current block may be determined based on the reference block and the transformation model candidate list.

In a possible implementation, a transformation model is determined for the current block based on the transformation model candidate list and a reference block is determined for the current block, referring to FIG. 19, the method may include:
S1901: the bitstream is decoded to determine a transformation model index of the current block;
S1902: a transformation model is determined for the current block based on the transformation model index and the transformation model candidate list; and
S1903: a reference block is determined for the current block based on the transformation model and a first merge candidate list.

It should be noted that in embodiments of the present disclosure, when determining the transformation model of the current block based on the transformation model candidate list, the transformation model index of the current block may be determined by decoding the bitstream; then the transformation model of the current block may be determined based on the transformation model index and the transformation model candidate list.

It should also be noted that in embodiments of the present disclosure, the transformation model index may be represented by cu_model_merge_idx, which is used to indicate the number of the transformation model in the transformation model candidate list. The value range of cu_model_merge_idx may be less than or equal to the maximum length of the transformation model candidate list. For decoding cu_model_merge_idx, a variable-length decoding method may be used, and a smaller index corresponds to a shorter codeword. For example, the value range of cu_model_merge_idx is n, and a truncated binary decoding method is used herein.

For example, in implementation, the syntax elements are described as follows: if (cu_prediction_mode==INTER_MODE)

```
{
...
cu_model_merge_flag
if( cu_model_merge_flag) {
  cu_model_merge_idx
}
...
  }
```

In this way, a certain transformation model may be determined according to cu_model_merge_idx. For example, when the value of cu_model_merge_idx is equal to idx, it is determined that modelList[idx] is the transformation model of the current block.

It can be understood that in embodiments of the present disclosure, for the first merge candidate list, the method may further include: determining at least one piece of candidate motion information of the current block; and constructing the first merge candidate list according to the at least one piece of candidate motion information of the current block, wherein the candidate motion information is used to indicate a candidate reference block of the current block and/or a template of the candidate reference block.

In some embodiments, constructing the first merge candidate list according to the at least one piece of candidate motion information of the current block may include one of:
constructing the first merge candidate list based on at least one piece of candidate motion information determined in an inter merge manner;
constructing the first merge candidate list based on at least one piece of candidate motion information determined in a motion vector template matching manner;
constructing the first merge candidate list based on at least one piece of candidate motion information determined in a motion vector bidirectional matching manner;
constructing the first merge candidate list based on at least one piece of candidate motion information determined in a motion vector difference manner; and
constructing the first merge candidate list based on at least one piece of candidate motion information determined in a motion vector difference merge manner.

It should be noted that in embodiments of the present disclosure, the first merge candidate list herein may be a constructed Inter Merge list, or a list constructed based on MV template matching, MV bidirectional matching, MVD prediction, MMVD candidate sorting, etc. That is to say, the transformation model determined according to modelList[idx] may be used for template transformation of a reference block in a Merge list during inter prediction, and may also be used for template transformation of a reference block in processes such as MV template matching, MV bidirectional matching, MVD prediction, and MMVD candidate sorting, to obtain an error calculated from the transformed template so as to replace a template error in the related art.

In a specific embodiment, determining a reference block of the current block based on the transformation model and the first merge candidate list may include: performing template error calculation on at least one candidate reference block indicated in the first merge candidate list based on the transformation model to determine an error of the at least one candidate reference block; determining a minimum error from errors of the at least one candidate reference block, and determining a candidate reference block corresponding to the minimum error as the reference block of the current block.

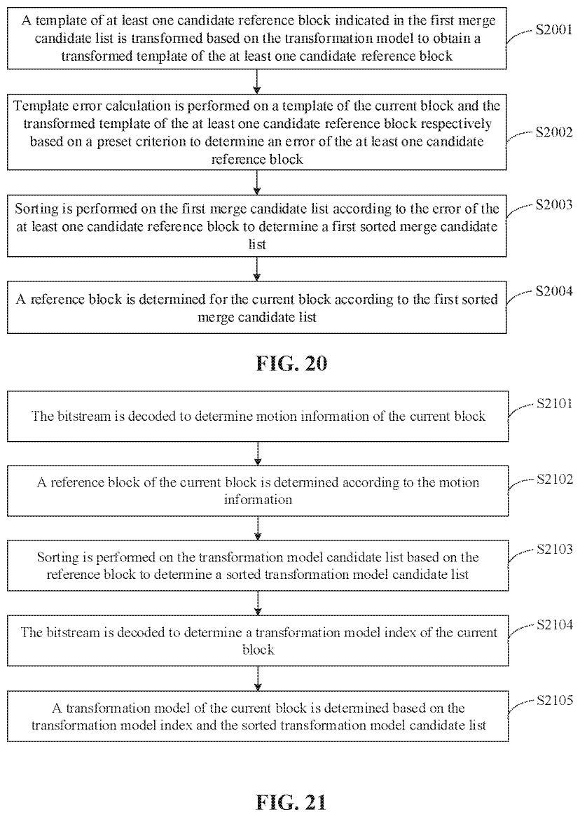

In embodiments of the present disclosure, for the first merge candidate list, referring to FIG. 20, the method may include:
S2001: a template of at least one candidate reference block indicated in the first merge candidate list is transformed based on the transformation model to obtain a transformed template of the at least one candidate reference block;
S2002: template error calculation is performed on a template of the current block and the transformed template of the at least one candidate reference block respectively based on a preset criterion to determine an error of the at least one candidate reference block;
S2003: sorting is performed on the first merge candidate list according to the error of the at least one candidate reference block to determine a first sorted merge candidate list; and
S2004: a reference block is determined for the current block according to the first sorted merge candidate list.

It should be noted that in embodiments of the present disclosure, the candidate motion information in the first merge candidate list may correspondingly indicate one candidate reference block. For determining the error of the at least one candidate reference block, specifically, the template of the at least one candidate reference block indicated in the first merge candidate list may be transformed based on the transformation model to obtain the transformed template of the at least one candidate reference block; and template error calculation may be performed on the template of the current block and the transformed template of the at least one candidate reference block respectively based on the preset criterion to determine the error of the at least one candidate reference block.

It should also be noted that in embodiments of the present disclosure, the preset criterion at least includes one of Sum of Absolute Difference (SAD), Sum of Absolute Transformed Difference (SATD), Mean Squared Error (MSE), Root Mean Square Error (RMSE), Mean Absolute Error (MAE), Mean Absolute Deviation (MAD), and the like.

For example, taking SAD as an example, a reference block template in the first merge candidate list is transformed according to a determined transformation model, and then the first merge candidate list is reordered according to a transformed template error. For example, the transformation model of the current block is modelList[idx], the template corresponding to the nth candidate motion information is Tn, the template of the current block is Tcur, and the template error may be calculated using SAD. First, Tn is transformed according to modelList[idx] to obtain Tn′, and then the SAD between Tn′ and Tcur is calculated to obtain the template error SADn of the candidate motion information. According to this operation, the template error SADi of each candidate motion information in the first merge candidate list is obtained, where 0≤i<N. Then, the N pieces of candidate motion information in the first merge candidate list may be reordered according to SADi, where a smaller SADi corresponds to a smaller sorted index value. In addition, when certain candidate motion information corresponds to bi-prediction, the template of the candidate motion information may be obtained by bi-prediction; and a template error may be calculated for three YUV components or only a single component; it may also be consistent with a reordering process of an Inter Merge list in the related art.

It should also be noted that in embodiments of the present disclosure, for determining a reference block of the current block, the method may further include: decoding a bitstream to determine a first merge index of the current block; and determining the reference block of the current block based on the first merge index and the first sorted merge candidate list.

Here, the first merge candidate list includes N pieces of candidate motion information, and the first merge index is used to indicate the number of target motion information of the current block in the first sorted merge candidate list, and the target motion information may point to the reference block of the current block.

In some embodiments, the method may further include: decoding a bitstream to determine mode flag information of at least part of the candidate motion information in the first sorted merge candidate list; and sorting at least part of the candidate motion information in the first sorted merge candidate list based on the mode flag information of the at least part of the candidate motion information to determine a second sorted merge candidate list.

It should be noted that in embodiments of the present disclosure, after the first merge candidate list is reordered, part of the candidates in the list may be further sorted according to the mode flag information (such as an LIC flag and other mode flags) of the at least part of the candidate motion information to obtain the second sorted merge candidate list. For example, when the LIC flag of certain candidate motion information is true, it is ranked in front of the list; and when the LIC flags of multiple pieces of candidate motion information are true, the relative order among these pieces of candidate motion information can remain unchanged.

In another specific embodiment, the method may further include: decoding a bitstream to determine a first merge index of the current block; and determining the reference block of the current block based on the first merge index and the first sorted merge candidate list or the second sorted merge candidate list.

Here, the first merge index is used to indicate the number of a target merge candidate of the current block in the first sorted merge candidate list or the second sorted merge candidate list, and the target merge candidate may point to the reference block of the current block. In this way, after the first merge index of the current block is obtained by decoding, the reference block of the current block may be determined according to the selected target merge candidate.

In yet another specific embodiment, the method may further include: when the current block uses a DMVR mode, determining at least one group of candidate reference blocks for the current block based on the first merge candidate list, each group of candidate reference blocks including two candidate reference blocks; transforming the two candidate reference blocks in each group of candidate reference blocks based on the transformation model to determine two transformed reference blocks in each group of candidate reference blocks; performing matching error calculation on the two transformed reference blocks in each group of candidate reference blocks to determine an error corresponding to each group of candidate reference blocks; and determining, according to the error corresponding to each group of candidate reference blocks, a group of candidate reference blocks with the minimum error as the reference block of the current block.

It should be noted that in embodiments of the present disclosure, the two reference blocks in the DMVR process of the candidate motion vector (e.g., selected from the first merge candidate list) may also be transformed based on the determined transformation model, and then an error (e.g., SAD between the two reference blocks) may be calculated based on the two transformed reference blocks to determine a final optimization result. For example, a group of candidate reference blocks with the minimum error may be determined as the final reference block.

In another possible implementation, a transformation model of the current block is determined based on the transformation model candidate list and a reference block of the current block is determined, referring to FIG. 21, the method may include:
S2101: the bitstream is decoded to determine motion information of the current block;
S2102: a reference block of the current block is determined according to the motion information;
S2103: sorting is performed on the transformation model candidate list based on the reference block to determine a sorted transformation model candidate list;
S2104: the bitstream is decoded to determine a transformation model index of the current block; and
S2105: a transformation model of the current block is determined based on the transformation model index and the sorted transformation model candidate list.

It should be noted that in embodiments of the present disclosure, decoding a bitstream to determine the reference block of the current block may specifically include: decoding the bitstream to determine motion information of the current block; and then determining the reference block of the current block according to the motion information.

It should also be noted that in embodiments of the present disclosure, determining the transformation model of the current block based on the reference block and the transformation model candidate list may specifically include: performing sorting on the transformation model candidate list based on the reference block to determine a sorted transformation model candidate list; decoding the bitstream to determine a transformation model index of the current block; and determining the transformation model of the current block based on the transformation model index and the sorted transformation model candidate list.

That is to say, in embodiments of the present disclosure, when the current block uses an inter prediction mode, the motion information and the reference block of the current block may be obtained first by decoding a bitstream, then the transformation model candidate list may be reordered based on the reference block, and the transformation model of the current block may be determined in combination with the transformation model index written in the bitstream.

It may also be understood that in embodiments of the present disclosure, to store coding bits, the transformation model index is no longer transmitted in a bitstream. In a specific embodiment, the method may further include: performing template error calculation based on the reference block and at least one candidate transformation model in the transformation model candidate list to determine errors of the at least one candidate transformation model; determining a minimum error from the errors of the at least one candidate transformation model, and determining a candidate transformation model corresponding to the minimum error as the transformation model of the current block.

That is to say, in embodiments of the present disclosure, the transformation model with the minimum error may be used as the finally selected transformation model, and the transformation model index is no longer written into a bitstream, thereby further improving coding efficiency.

In another specific embodiment, the method may further include: determining a candidate transformation model at a preset list position based on the sorted transformation model candidate list; and determining the candidate transformation model at the preset list position as the transformation model of the current block.

It should be noted that in embodiments of the present disclosure, the preset list position may be a specific position in the sorted transformation model candidate list, such as a first element position, a last element position, etc., which is not specifically limited herein.

For example, when the transformation model candidate list is sorted in a manner that a smaller template error corresponds to a smaller index, the first element position may be taken as the preset list position, and the transformation model corresponding to index 0 in the sorted transformation model candidate list is directly determined as the final transformation model. Alternatively, when the transformation model candidate list is sorted in a manner that a smaller template error corresponds to a larger index, the last element position may be taken as the preset list position, and the transformation model corresponding to index N−1 in the sorted transformation model candidate list is directly determined as the final transformation model, where N represents the length of the transformation model candidate list.

In some embodiments, performing sorting on the transformation model candidate list based on the reference block to obtain a sorted transformation model candidate list may include:
performing template error calculation based on the reference block and at least one candidate transformation model in the transformation model candidate list to determine errors of the at least one candidate transformation model; and
performing sorting on the transformation model candidate list based on the errors of the at least one candidate transformation model to determine the sorted transformation model candidate list.

It should be noted that, in embodiments of the present disclosure, performing template error calculation based on the reference block and at least one candidate transformation model in the transformation model candidate list to determine errors of the at least one candidate transformation model may include:
respectively transforming a template of the reference block based on the at least one candidate transformation model to obtain transformed templates of at least one reference block; and
respectively calculating errors between a template of the current block and the transformed templates of the at least one reference block based on a preset criterion to determine the errors of the at least one candidate transformation model.

It should also be noted that, in embodiments of the present disclosure, the preset criterion includes at least one of: Sum of Absolute Difference (SAD), Sum of Absolute Transformed Difference (SATD), Mean Squared Error (MSE), Root Mean Squared Error (RMSE), Mean Absolute Error (MAE), Mean Absolute Deviation (MAD), and the like.

For example, still taking SAD as an example, the transformation model candidate list may be sorted based on the determined reference block. For instance, it is assumed that the template of the current block is Tcur, the template of the reference block is Tref, a candidate transformation model is modelList[i], and a template error is calculated using SAD. First, Tref is transformed according to modelList[i] to obtain Tref_i, and then the SAD between Tref_i and Tcur is calculated to obtain the template error SADi of the candidate transformation model. The template error SADi of each candidate transformation model in the transformation model candidate list is obtained through this operation, where 0≤i<N. The N candidate transformation models in the list are re-sorted according to SADi, where a smaller SADi corresponds to a smaller sorted index.

In addition, when the current block uses bi-prediction, the template of the reference block may be derived from bi-prediction; a template error may be calculated for all three YUV components or for a single component only; the process may also be consistent with the conventional reordering process of an Inter Merge list.

It may also be understood that, in embodiments of the present disclosure, when the current block uses a transformation model candidate list-based manner and the current block uses bi-prediction, the current block has two transformation model indices, such as a first transformation model index and a second transformation model index.

In a specific embodiment, decoding a bitstream to determine a transformation model index of the current block may include:
decoding the bitstream to determine prediction direction information of the current block; and
when the prediction direction information indicates that the current block uses bi-prediction, decoding the bitstream to determine the first transformation model index and the second transformation model index of the current block.

In another specific embodiment, decoding a bitstream to determine a transformation model index of the current block may include:
decoding the bitstream to determine the first transformation model index of the current block; and
when the prediction direction information indicates that the current block uses bi-prediction, decoding the bitstream to determine the second transformation model index of the current block.

It should be noted that, in embodiments of the present disclosure, the first transformation model index may represent an index of a transformation model in the sorted transformation model candidate list and corresponding to the reference block of the current block in a first reference picture list, and the second transformation model index may represent an index of a transformation model in the sorted transformation model candidate list and corresponding to the reference block of the current block in a second reference picture list.

It should also be noted that, in embodiments of the present disclosure, the prediction direction information may be represented by pu_inter_dir. For example, when the value of pu_inter_dir is equal to 3, it indicates that the current block uses bi-prediction. In addition, the first transformation model index may be represented by cu_model_merge_idx0, which may be an index of the transformation model corresponding to the reference block of the current block in the first reference picture list (List0), or in other words, an index of the transformation model corresponding to the reference block of the current block in the forward prediction direction; the second transformation model index may be represented by cu_model_merge_idx1, which may be an index of the transformation model corresponding to the reference block of the current block in the second reference picture list (List1), or in other words, an index of the transformation model corresponding to the reference block of the current block in the backward prediction direction. In other words, cu_model_merge_idx0 and cu_model_merge_idx1 respectively indicate indices of transformation models corresponding to reference blocks or reference block templates in different prediction directions (or in different reference picture lists).

For example, in an implementation, the syntax elements are described as follows:

```
...
pu_inter_dir
...
cu_model_merge_flag
if( cu_model_merge_flag) {
  if( pu_inter_dir == 3) {
    cu_model_merge_idx0
cu_model_merge_idx1
    } else {
      cu_model_merge_idx
    }
}
```

Alternatively, in another implementation, the syntax elements are described as follows:

```
...
pu_inter_dir
...
cu_model_merge_flag
if( cu_model_merge_flag) {
  cu_model_merge_idx0
  if( pu_inter_dir == 3) {
cu_model_merge_idx1
    }
}
...
```

In this way, after constructing the transformation model candidate list of the current block, the transformation model and the reference block of the current block may be determined.

S1704: the reference block is transformed based on the transformation model to determine a prediction block of the current block.

It should be noted that, in embodiments of the present disclosure, the transformation model of the current block may be determined first, and may be combined with the construction process of the first merge candidate list to obtain a final target merge candidate so as to determine the final reference block, and then the reference block may be transformed based on the transformation model of the current block to obtain the prediction block of the current block. Alternatively, motion information and the reference block of the current block may be obtained via decoding first, then the transformation model candidate list may be re-sorted according to the template of the reference block. The transformation model of the current block may be determined based on the transformation model index obtained via decoding, and then the reference block may be transformed based on the transformation model to obtain the prediction block of the current block.

In some embodiments, after determining the prediction block of the current block, the method may further include:
decoding the bitstream to determine a residual block of the current block; and
determining a reconstructed block of the current block based on the prediction block and the residual block of the current block.

It should also be noted that, in embodiments of the present disclosure, determining a reconstructed block of the current block based on the prediction block and the residual block of the current block may include:
performing an addition operation on the prediction block and the residual block of the current block to determine the reconstructed block of the current block.

In this way, after the prediction block of the current block is determined, the decoding process of the current block may be completed in combination with the residual information obtained via decoding.

In some embodiments, the method may further include: storing the transformation model of the current block.

In this way, the stored transformation model of the current block may be used for subsequent decoding processes. For example, it may be used to construct a transformation model candidate list for subsequent decoding blocks.

It should also be noted that, in embodiments of the present disclosure, the transformation model candidate list constructed by the technical solution may be applied to blocks using an inter prediction mode as well as blocks using an IBC mode, which is not specifically limited herein.

Embodiments of the present disclosure provide a decoding method, including: decoding a bitstream to determine a value of first syntax flag information; constructing a transformation model candidate list of a current block when the first syntax flag information indicates that the current block uses an inter prediction mode; determining a transformation model of the current block based on the transformation model candidate list and determining a reference block of the current block; and transforming the reference block based on the transformation model to determine a prediction block of the current block.

In this way, when it is determined through decoding that the current block uses the inter prediction mode, the transformation model candidate list of the current block may be first constructed, then the transformation model and the reference block of the current block may be determined accordingly, and the reference block may be transformed using the transformation model, thereby not only improving the diversity of inter prediction but also enhancing prediction accuracy, and further improving coding and decoding efficiency.

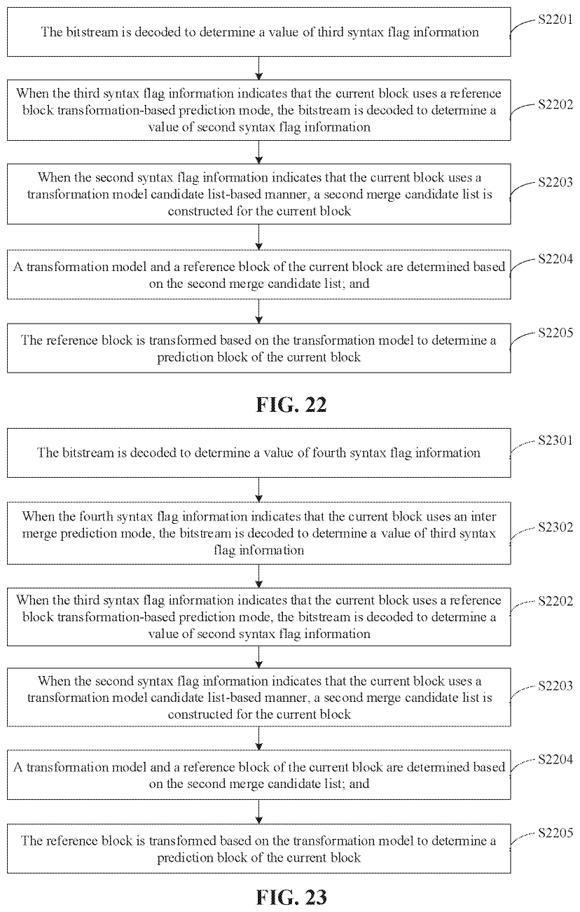

In another embodiment of the present disclosure, based on the decoding method described in the foregoing embodiment, FIG. 22 is a sixth schematic diagram of decoding provided by an embodiment of the present disclosure. As shown in FIG. 22, the method may include:
S2201: the bitstream is decoded to determine a value of third syntax flag information;
S2202: when the third syntax flag information indicates that the current block uses a reference block transformation-based prediction mode, the bitstream is decoded to determine a value of second syntax flag information;
S2203: when the second syntax flag information indicates that the current block uses a transformation model candidate list-based manner, a second merge candidate list is constructed for the current block;
S2204: a transformation model and a reference block of the current block are determined based on the second merge candidate list; and
S2205: the reference block is transformed based on the transformation model to determine a prediction block of the current block.

It should be noted that, in embodiments of the present disclosure, the third syntax flag information is used to indicate whether the current block uses a reference block transformation-based prediction mode, which may be represented by cu_lic_flag. In some embodiments, when the value of the third syntax flag information is a first value, it is determined that the third syntax flag information indicates that the current block uses the reference block transformation-based prediction mode; and when the value of the third syntax flag information is a second value, it is determined that the third syntax flag information indicates that the current block does not use the reference block transformation-based prediction mode.

It should also be noted that, in embodiments of the present disclosure, the second syntax flag information is used to indicate whether the current block uses a transformation model candidate list-based manner, which may be represented by cu_model_merge_flag. In some embodiments, when the value of the second syntax flag information is a first value, it is determined that the second syntax flag information indicates that the current block uses the transformation model candidate list-based manner; and when the value of the second syntax flag information is a second value, it is determined that the second syntax flag information indicates that the current block does not use the transformation model candidate list-based manner.

In some embodiments, based on the decoding method shown in FIG. 22, for S2201, referring to FIG. 23, the method may include:

S2301: the bitstream is decoded to determine a value of fourth syntax flag information; and

S2302: when the fourth syntax flag information indicates that the current block uses an inter merge prediction mode, the bitstream is decoded to determine a value of third syntax flag information.

It should be noted that, in embodiments of the present disclosure, the fourth syntax flag information is used to indicate whether the current block uses an inter merge prediction mode, which may be represented by pu_merge_flag. In some embodiments, when the value of the fourth syntax flag information is a first value, it is determined that the fourth syntax flag information indicates that the current block uses the inter merge prediction mode; and when the value of the fourth syntax flag information is a second value, it is determined that the fourth syntax flag information indicates that the current block does not use the inter merge prediction mode.

Here, the first value is different from the second value, and both the first value and the second value may be in a parameter form or a numeric form. Specifically, the second syntax flag information, the third syntax flag information, and the fourth syntax flag information may all be parameters written in a profile or values of a flag, which is not specifically limited herein. For example, the first value may be 1 and the second value may be 0; or the first value may be 0 and the second value may be 1; or the first value may be true and the second value may be false; or the first value may be false and the second value may be true.

For example, when the bitstream is decoded, if both cu_lic_flag and cu_model_merge_flag are determined to be 1, it indicates that the current block uses a prediction method with inherited transformation models. Specifically, the value of pu_merge_flag is decoded, and when pu_merge_flag is 1, it is determined that the current block uses the inter merge prediction mode; then the value of cu_lic_flag is decoded, and when cu_lic_flag is 1, it is determined that the current block uses a prediction mode that transforms the reference block; the value of cu_model_merge_flag is decoded, and when cu_model_merge_flag is 1, it is determined that the current block uses the transformation model candidate list-based manner, i.e., the transformation model is determined by inheriting transformation models from decoded blocks; when cu_model_merge_flag is 0, it is determined that the current block does not use the transformation model candidate list-based manner, and in this case, the transformation model may be calculated by template derivation.

In some embodiments, when cu_lic_flag is 1 and cu_model_merge_flag is 1, it indicates that the current block uses a present technical solution, and a second merge candidate list for the current block may be constructed. In some embodiments, the method may include:
determining candidate merge information corresponding to predefined positions of the current block, where the candidate merge information includes motion information and a transformation model; and
adding the candidate merge information corresponding to the predefined positions to the second merge candidate list when the candidate merge information corresponding to the predefined positions satisfies a preset candidate condition.

In a specific embodiment, the case that the candidate merge information corresponding to the predefined position satisfies a preset candidate condition may include:
motion information corresponding to the predefined position is available, and a transformation model is stored at the predefined position.

That is to say, in embodiments of the present disclosure, for the construction of the second merge candidate list, each merge candidate may include a corresponding transformation model. For example, spatial adjacent candidates may be added. Predefined spatial positions are checked, and when motion information corresponding to a position is available, it is further checked whether a transformation model is stored at the position. When the above condition is satisfied, the motion information and transformation model corresponding to the position are added to the second merge candidate list as one of available merge candidates. Similarly, merge candidates of spatial type, temporal type, history type, average type, default type, and the like may also be added to the second merge candidate list.

In addition, it should be noted that the first merge candidate list constructed in the foregoing embodiments only includes candidate motion information, whereas the candidate motion information in the second merge candidate list constructed herein is accompanied by transformation models.

In some embodiments, for determining the transformation model and the reference block of the current block based on the second merge candidate list, referring to FIG. 24, the method may include:
S2401: errors of at least one piece of candidate merge information in the second merge candidate list are determined;
S2402: the at least one piece of candidate merge information in the second merge candidate list is sorted based on the errors to determine a third sorted merge candidate list;
S2403: the bitstream is decoded to determine a second merge index of the current block; and
S2404: target merge information of the current block is determined based on the second merge index and the third sorted merge candidate list, and the transformation model and the reference block of the current block are determined according to the target merge information.

It should be noted that, in embodiments of the present disclosure, for determining the errors of the at least one piece of candidate merge information in the second merge candidate list, first candidate merge information is any one of the at least one piece of candidate merge information. The following takes the first candidate merge information as an example for illustrative description.

In a possible implementation, the first candidate merge information may include first motion information and a first transformation model. Correspondingly, the method may include:
determining a template of a first reference block indicated by the first motion information based on the first motion information and the first transformation model included in the first candidate merge information;
transforming the template of the first reference block based on the first transformation model to determine a transformed template of the first reference block; and
performing template error calculation based on the template of the current block and the transformed template of the first reference block based on a preset criterion to determine an error of the first candidate merge information.

It should be noted that, in embodiments of the present disclosure, the preset criterion includes at least one of SAD, SATD, MSE, RMSE, MAE, MAD, and the like.

It should also be noted that, in embodiments of the present disclosure, for the second merge candidate list, the obtained second merge candidate list may be re-sorted according to template errors, and then a selected merge candidate (i.e., target merge information) may be determined based on the second merge index and the re-sorted third sorted merge candidate list. When calculating a template error of a merge candidate, a reference block template obtained thereby may be correspondingly transformed based on a transformation model of the merge candidate, and then the template error may be calculated.

In another possible implementation, when the current block uses a DMVR mode, the first candidate merge information may include two pieces of motion information and two transformation models, such as first motion information and a first transformation model, as well as second motion information and a second transformation model. Correspondingly, the method may include: when the current block uses the DMVR mode, determining the first motion information and the first transformation model, as well as the second motion information and the second transformation model included in the first candidate merge information; transforming a reference block indicated by the first motion information based on the first transformation model to determine a first transformed reference block; and transforming a reference block indicated by the second motion information based on the second transformation model to determine a second transformed reference block; and calculating a matching error between the first transformed reference block and the second transformed reference block to determine an error of the first candidate merge information.

It should be noted that, in embodiments of the present disclosure, two reference blocks in a DMVR process may be transformed based on the transformation model of a merge candidate, and then an error (such as SAD between the two reference blocks) may be calculated based on the two transformed reference blocks to determine a final optimization result. In addition, the transformation model may also transform reference block templates used in processes such as MV template matching, MVD prediction, and MMVD candidate sorting to obtain transformed template errors for replacing template errors in related art.

It should also be noted that, in embodiments of the present disclosure, constructing the second merge candidate list may include one of:
constructing the second merge candidate list based on at least one piece of candidate motion information determined in an inter merge manner and a corresponding transformation model;
constructing the second merge candidate list based on at least one piece of candidate motion information determined in an MV template matching manner and a corresponding transformation model;
constructing the second merge candidate list based on at least one piece of candidate motion information determined in an MV bi-prediction matching manner and a corresponding transformation model;
constructing the second merge candidate list based on at least one piece of candidate motion information determined in an MVD manner and a corresponding transformation model; and
constructing the second merge candidate list based on at least one piece of candidate motion information determined in an MMVD manner and a corresponding transformation model.

It should be noted that, in embodiments of the present disclosure, the second merge candidate list herein may be a constructed Inter Merge list, or a list constructed based on MV template matching, MV bi-prediction matching, MVD prediction, MMVD candidate sorting, and the like, only that merge candidates therein are accompanied by transformation models.

In this way, reference block templates used in processes such as Inter Merge listing, MV template matching, MVD prediction, and MMVD candidate sorting may be transformed based on a transformation model of a merge candidate to obtain transformed template errors; then at least one piece of candidate merge information in the second merge candidate list may be sorted according to the template errors to determine the third sorted merge candidate list; motion information and a transformation model of the current block may be obtained in combination with the second merge index determined via decoding, where a reference block may be determined according to the motion information.

It should also be noted that, in embodiments of the present disclosure, the second merge index may be represented by cu_merge_idx. The second merge index is used to indicate a serial number of target merge information of the current block in the third sorted merge candidate list. According to cu_merge_idx written into a bitstream, the target merge information of the current block may be determined, and then the transformation model and the reference block of the current block may be determined.

For example, in implementation, the syntax elements are described as follows:

if(pu_merge_flag)
{
...
cu_lic_flag
if (cu_lic_flag)
{
cu_model_merge_flag
}
...
cu_merge_idx
...
}

In a specific embodiment, the method may further include: when motion information in the second merge candidate list is adjusted, determining that a transformation model corresponding to the motion information remains unchanged.

In another specific embodiment, the method may further include: when motion information in the second merge candidate list is adjusted, determining an updated reference block of the current block according to the adjusted motion information; and adjusting a model parameter of a transformation model corresponding to the motion information according to a template of the current block and a template of the updated reference block to obtain an adjusted transformation model.

It should be noted that, in embodiments of the present disclosure, motion information (motion vectors) in the second merge candidate list may be adjusted while corresponding transformation models remain unchanged. For example, there are n basic merge candidates in an MMVD manner, and MVD merge candidates are constructed by offsetting motion vectors after a basic merge candidate is selected. Transformation models corresponding to these newly added merge candidates are the same as those of the basic merge candidates. For example, in an MV template matching manner, template matching is performed on a merge candidate in an adjacent region pointed to by its motion vector, and the merge candidate is optimized according to template errors. It should be noted that the transformation model of the optimized merge candidate may remain unchanged. However, in some cases, part of model parameters in the transformation model may also be changed while changing the motion information. For example, the updated reference block of the current block may be determined according to the adjusted motion information; then a model parameter of a transformation model corresponding to the motion information may be adjusted according to the template of the current block and the template of the updated reference block. For example, let the template of the reference block determined according to the adjusted motion information be Tref, the template of the current block be Tcur, and the a model parameter of the transformation model be (α_{Y}, β_{Y}). Then β_{Y}′ may be derived from Tcur, Tref, and α_{Y}, and (α_{Y}, β_{Y}) is replaced with (α_{Y}, β_{Y}′) to obtain the adjusted transformation model.

It should also be noted that, in embodiments of the present disclosure, after transforming the reference block based on the transformation model to determine the prediction block of the current block, the method may further include: decoding the bitstream to determine a residual block of the current block; and determining a reconstructed block of the current block according to the prediction block and the residual block of the current block.

In embodiments of the present disclosure, an addition operation may be performed on the prediction block and the residual block of the current block to determine the reconstructed block of the current block. In this way, after the prediction block of the current block is determined, the decoding process of the current block may be completed in combination with residual information obtained by decoding.

In embodiments of the present disclosure, the transformation model of the current block may also be stored. In this way, the stored transformation model of the current block may be used for subsequent decoding processes, such as constructing a transformation model candidate list or a second merge candidate list with transformation models for subsequent decoding blocks.

It should also be noted that, in embodiments of the present disclosure, the transformation model candidate list constructed by the present technical solution may be applied to blocks using an inter prediction mode as well as blocks using an IBC mode, which is not specifically limited herein.

Embodiments of the present disclosure provide a decoding method including:
when a current block uses a reference block transformation-based prediction mode and the current block uses a transformation model candidate list-based manner, constructing a second merge candidate list for the current block;
determining a transformation model and a reference block of the current block based on the second merge candidate list;
and transforming the reference block based on the transformation model to determine a prediction block of the current block.

In this way, when it is determined through decoding that the current block uses the inter prediction mode, the transformation model candidate list of the current block is first constructed, then the transformation model and the reference block of the current block are determined accordingly, and the reference block is transformed using the transformation model, thereby not only improving the diversity of inter prediction but also enhancing prediction accuracy, and further improving coding and decoding efficiency.

In yet another embodiment of the present disclosure, based on the decoding method described in the foregoing embodiments, the current block may have multiple components (such as a first color component, a second color component, and a third color component), or a single component (such as the first color component); or may use uni-prediction or bi-prediction. For example, the first color component may be a Y component, the second color component may be a U component, and the third color component may be a V component, which is not specifically limited.

In some embodiments, when components to be processed of the current block include at least one of the first color component, the second color component and the third color component, the method may further include:
when the current block has one component to be processed and uses uni-prediction, storing a transformation model used by the component to be processed as one candidate transformation model;
when the current block has one component to be processed and uses bi-prediction, storing a transformation model used by the component to be processed as two candidate transformation models;
when the current block has three components to be processed and uses uni-prediction, storing transformation models used by the first color component, the second color component, and the third color component as one candidate transformation model; and
when the current block has three components to be processed and uses bi-prediction, storing transformation models used by the first color component, the second color component and the third color component as two candidate transformation models.

It should be noted that, in embodiments of the present disclosure, the component to be processed of the current block may be one component (such as the Y component) or multiple components (such as three components including Y, U, and V); and the prediction direction information herein may be uni-prediction or bi-prediction. The following illustrates these cases.

In a possible implementation, the current block has only a Y component and uses uni-prediction, and the transformation model used by this component may be stored as one transformation model candidate. For example, in an inter prediction mode, when the current block uses uni-prediction and is decoded using an LIC mode, a transformation model candidate (α_{Y0}, β_{Y0}) may be stored; for example, in an inter prediction mode, when the current block uses uni-prediction and is decoded using an LIC multi-model mode, a transformation model candidate (α_{Y0}, β_{Y0}, α_{Y1}, β_{Y1}, Threshold) may be stored. Here, (α_{Y0}, β_{Y0}) and (α_{Y1}, β_{Y1}) are two transformation models used by the current block, and Threshold is a threshold used to determine which transformation model should be applied to a certain pixel within the current block.

In another possible implementation, the current block has three components Y, U, and V and uses uni-prediction, and transformation models used by the three components may be stored as one transformation model candidate. For example, in an inter prediction mode, when the current block uses uni-prediction and is decoded using an LIC mode, a transformation model candidate (α_{Y0}, β_{Y0}, α_{U0}, β_{U0}, α_{V0}, β_{V0}) may be stored, where (α_{Y0}, β_{Y0}), (α_{U0}, β_{U0}), and (α_{V0}, β_{V0}) are transformation models used by reference blocks of the current block on the Y, U, and V components respectively. When a subsequent decoding block selects this transformation model, (α_{Y0}, β_{Y0}), (α_{U0}, β_{U0}), and (α_{V0}, β_{V0}) may be applied to the Y, U, and V components of its reference block respectively.

In yet another possible implementation, the current block has only the Y component and uses bi-prediction, and the transformation model used by this component may be stored as two transformation model candidates. For example, in an inter prediction mode, when the current block uses bi-prediction and is decoded using an LIC mode, two transformation model candidates (α_{Y0}, β_{Y0}) and (α_{Y1}, β_{Y1}) may be stored, which respectively come from transformation models used by forward and backward reference blocks of the current block on the Y component.

In yet another possible implementation, the current block has three components Y, U, and V and uses bi-prediction, and transformation models used by the three components may be stored as two transformation model candidates. For example, in an inter prediction mode, when the current block uses bi-prediction and is decoded using an LIC mode, two transformation model candidates (α_{Y0}, β_{Y0}, α_{U0}, β_{U0}, α_{V0}, β_{V0}) and (α_{Y1}, β_{Y1}, α_{U1}, β_{U1}, α_{V1}, β_{V1}) may be stored, which respectively come from transformation models used by forward and backward reference blocks of the current block on the Y, U, and V components.

In some embodiments, the method may further include:
when the current block has three components to be processed, storing a transformation model used by one of the first color component, the second color component, and the third color component.

In this case, the method may further include:
determining a type of the transformation model used by the one color component;
and deriving transformation models used by the remaining two color components of the first color component, the second color component and the third color component based on adjacent reconstructed pixels of the current block and adjacent reconstructed pixels of the reference block, where the types of the transformation models used by the remaining two color components are the same as the type of the transformation model used by the one color component.

In yet another possible implementation, the current block has three components Y, U, and V, and only the transformation model used by one of the components may be stored as one transformation model candidate. For example, in an inter prediction mode, when the current block uses uni-prediction and is decoded using an LIC mode, the transformation model derived from the template is (α_{Y0}, β_{Y0}, α_{U0}, β_{U0}, α_{V0}, β_{V0}), where (α_{Y0}, β_{Y0}), (α_{U0}, β_{U0}), and (α_{V0}, β_{V0}) are transformation models used by reference blocks of the current block on the Y, U, and V components respectively. Here, only (α_{Y0}, β_{Y0}) may be stored for use by subsequent decoding blocks. When a subsequent decoding block selects this transformation model, (aro, Bro) may be applied to the Y component of its reference block, while transformation models for the U and V components are re-derived from the template. It should be noted that the derived transformation models for the U and V components are of the same type as the transformation model stored for the Y component.

In some embodiments, the method may further include:
when the current block uses bi-prediction, if two candidate transformation models to be stored are the same, storing one of the two candidate transformation models.

That is to say, in embodiments of the present disclosure, when the current block uses bi-prediction, two transformation model candidates need to be stored. When the two transformation models are the same, only one transformation model candidate may be stored. However, it should be noted that when a subsequent decoding block constructs a transformation model candidate list, the two transformation models may be added sequentially respectively.

Simply put, in embodiments of the present disclosure, when the current block is decoded using an LIC mode or the present technical solution, after a transformation model of the current block is determined, the transformation model may be stored. Where the current block has three components Y, U, and V, the transformation models used by the three components may be stored as one transformation model candidate (i.e., one transformation model candidate has transformation models respectively for reference blocks of the Y, U, and V components). For example, in an inter prediction mode, when the current block uses uni-prediction and is decoded using an LIC mode, a transformation model candidate (α_{Y0}, β_{Y0}, α_{U0}, β_{U0}, α_{V0}, β_{V0}) may be stored, where (α_{Y0}, β_{Y0}), (α_{U0}, β_{U0}), and (α_{V0}, β_{V0}) are transformation models used by reference blocks of the current block on the Y, U, and V components respectively. For example, in an inter prediction mode, when the current block uses bi-prediction and decoded using an LIC mode, two transformation model candidates (α_{Y0}, β_{Y0}, α_{U0}, β_{U0}, α_{V0}, β_{V0}) and (α_{Y1}, β_{Y1}, α_{U1}, β_{U1}, α_{V1}, β_{V1}) may be stored, respectively corresponding to transformation models used by forward and backward reference blocks of the current block. When the two transformation models are the same, only one transformation model candidate may also be stored.

In some embodiments, the method may further include:
determining first motion information of the current block;
determining a first reference block of the current block according to the first motion information;
adjusting a model parameter of the transformation model based on a template of the current block and a template of the first reference block to obtain an adjusted transformation model;
and transforming the reference block based on the adjusted transformation model to determine a prediction block of the current block.

It should be noted that, in embodiments of the present disclosure, parameter of the transformation model may be updated according to first motion information of the current block (such as motion information corresponding to a certain merge candidate list, motion information finally used by the current block, etc.). For example, let the template of the reference block determined according to the motion information be Tref, the template of the current block be Tcur, and a candidate transformation model in the transformation model candidate list be (α_{Y}, β_{Y}). Then β_{Y} may be derived from Tcur, Tref, and α_{Y}, and (α_{Y}, β_{Y}) is replaced with (α_{Y}, β_{Y}) to obtain an updated transformation model.

In some embodiments, the type of the transformation model may include at least one of: a linear model type, a filtering model type, a multi-model type, and a combination of different types.

It should be noted that, in embodiments of the present disclosure, the type of the transformation model may be a linear model (α, β), a Filter model, an LIC multi-model, or the like, and may also include different types of transformation models, so as to construct a transformation model candidate list.

In some embodiments, the method may further include:
determining a derived model of the current block by performing model derivation based on adjacent reconstructed pixels of the current block and adjacent reconstructed pixels of the reference block, or based on the reference block and a reconstructed block of the current block;
and storing the transformation model of the current block and the derived model of the current block.

It should be noted that, in embodiments of the present disclosure, after the reconstructed block of the current block is determined, a transformation model may also be re-derived based on the reference block and a reconstructed block of the current block. Alternatively, the current block that itself does not use a transformation model may also obtain and store a transformation model through this method; and the current block that itself uses a transformation model may replace the original transformation model with this transformation model for storage, or store both new and old transformation models.

In some embodiments, in the present technical solution and the existing list-based IBC transform prediction technology, when a decoding flag indicates that the current block uses bi-prediction, two transformation model indices may be signaled. For example, as shown below:

```
...
pu_inter_dir
...
cu_model_merge_flag
if( cu_model_merge_flag) {
  if( pu_inter_dir == 3) {
    cu_model_merge_idx0
cu_model_merge_idx1
    } else {
      cu_model_merge_idx
    }
}
...
Or,
...
pu_inter_dir
...
cu_model_merge_flag
if( cu_model_merge_flag) {
  cu_model_merge_idx0
  if( pu_inter_dir == 3) {
cu_model_merge_idx1
    }
}
...
```

Here, pu_inter_dir indicates the prediction direction of the current block. For example, pu_inter_dir==3 indicates that the current block uses bi-prediction. cu_model_merge_idx0 and cu_model_merge_idx1 respectively indicate indices corresponding to transformation models for reference blocks or reference block templates in different prediction directions (or in different reference picture lists).

In some embodiments, for determining a transformation model, in addition to transmitting a transformation model index in a bitstream, a transformation model with a minimum template error may also be used as a finally selected transformation model, in which case no index is transmitted, thereby saving coding bits.

In some embodiments, the method may further include:
determining first information of the current block; and
when the first information satisfies a first condition, performing the operation of determining a derived model of the current block by performing model derivation based on adjacent reconstructed pixels of the current block and adjacent reconstructed pixels of the reference block, or based on the reference block and a reconstructed block of the current block,
where the first information includes at least one of: a position of the current block, a size of the current block, adjacent block information of the current block, and decoded syntax flag information of the current block.

It should be noted that, in embodiments of the present disclosure, a condition may be added to determine whether to derive a transformation model based on the reconstructed block, for example, whether to perform the operation of determining a derived model of the current block is determined according to the size of the current block, block-level flags, frame-level flags, and the like. The derived model of the current block may be derived based on adjacent reconstructed pixels of the current block and adjacent reconstructed pixels of the reference block, or may be derived based on the reference block and a reconstructed block of the current block.

In some embodiments, the method may further include:
determining third information of the current block;
and when the third information satisfies a third condition, performing the operation of storing the transformation model of the current block,
where the third information includes at least one of: a position of the current block, a size of the current block, adjacent block information of the current block, and decoded syntax flag information of the current block.

It should be noted that, in embodiments of the present disclosure, a condition may also be added to determine whether to store the transformation model. For example, when the current block transforms a reference block using a transformation model, whether to store the transformation model or store the transformation model in a historical transformation model list may be determined according to the size of the current block, block-level flags, frame-level flags, and the like.

In some embodiments, the method may further include:
determining second information of the current block;
and when the second information satisfies a second condition, performing the operation of decoding the bitstream to determine a value of second syntax flag information;
where the second information includes at least one of: a position of the current block, a size of the current block, adjacent block information of the current block, and decoded syntax flag information of the current block.

It should be noted that a judgment condition may be added when decoding the cu_model_merge_flag syntax element in various embodiments of the present technical solution. For example, whether to decode cu_model_merge_flag may be determined according to related syntax elements of decoded blocks, and if not decoded, the value of cu_model_merge_flag is 0. The position of a decoded block may be an adjacent block of the current block, for example: let the top-left corner of the current block be (x, y), and the width and height be w, h. Then coding blocks at positions (x−1, y+h−1), (x+w−1, y−1), (x−1, y+h), (x+w, y−1), (x−1, y−1) may be checked. The judgment condition may be that prediction mode-related syntax elements (such as cu_lic_flag, cu_model_merge_flag) of a certain decoded block (or a certain number of decoded blocks) are true. For example, whether to decode cu_model_merge_flag is determined according to other decoded syntax elements of the current block, the position or size of the current block, frame-level flags, or sequence-level flags.

In some embodiments, a judgment condition may be added to the present technical solution to indicate whether to apply a specific process in the present technical solution. For example, when the size of the current block exceeds a certain threshold, the process of transforming the template of the reference block based on the transformation model is not performed.

In some embodiments, when the decoded cu_model_merge_flag is true, it indicates that the current block uses an inter prediction method based on inherited transformation models, the implementation of merge list construction, MMVD list construction, DMVR, and other operations for the current block may differ from those when cu_model_merge_flag is false—for example, differences in list size, candidate information, and other aspects. That is, judgments based on cu_model_merge_flag are introduced in various inter prediction operations.

In some embodiments, the method may further include:
when constructing the transformation model candidate list of the current block, determining a derived transformation model of the current block;
and adding the derived transformation model to the transformation model candidate list.

It should be noted that, in embodiments of the present disclosure, the method may further include:
decoding the bitstream to determine a value of fifth syntax flag information;
and performing the operation of constructing the transformation model candidate list of the current block when the fifth syntax flag information indicates that the current block uses an intra block copy mode.

It should also be noted that, in embodiments of the present disclosure, when the value of the fifth syntax flag information is a first value, it is determined that the fifth syntax flag information indicates the current block uses the intra block copy mode; and when the value of the fifth syntax flag information is a second value, it is determined that the fifth syntax flag information indicates the current block does not use the intra block copy mode. The first value is different from the second value. For example, the first value may be 1 and the second value may be 0, or the first value may be true and the second value false, which is not limited herein.

In other words, in embodiments of the present disclosure, whether in an inter prediction mode or intra block copy mode, a derived transformation model may be taken as one of candidate transformation models when constructing a transformation model candidate list. For example, the transformation model candidate list constructed in the foregoing embodiments may be modified to {LIC, LIC_LEFT, LIC_TOP, LIC_MM, Filter, Model0, Model1, . . . }, where LIC, LIC_LEFT, . . . , Filter represent different methods of deriving transformation models from templates, and Model0, etc., represent transformation models inherited from spatial or temporal adjacent blocks. For example, when the value of cu_model_merge_idx is equal to 0, it indicates that the current block uses the LIC prediction method, and the specific implementation may be the same as the LIC technique in the related art.

Embodiments of the present disclosure provide a decoding method. For multiple components or a single component of a current block, a corresponding transformation model candidate list may be constructed and applied respectively. For example, the transformation model may be combined with processes involving template error or bi-prediction matching error calculation in inter prediction, such as Merge list construction, motion vector optimization and prediction. This not only improves the diversity of inter prediction but also enhances prediction accuracy, thereby improving coding and decoding efficiency.

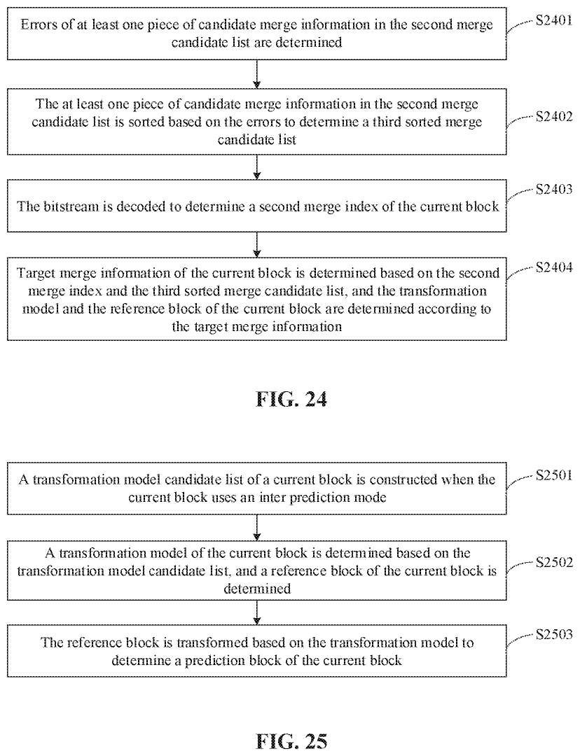

In yet another embodiment of the present disclosure, FIG. 25 is a first schematic flowchart of an encoding method provided by an embodiment of the present disclosure. As shown in FIG. 25, the method may include:

S2501: a transformation model candidate list of a current block is constructed when the current block uses an inter prediction mode.

It should be noted that, in embodiments of the present disclosure, the method is implemented by an encoder. Specifically, based on the structure of the encoder 100 shown in FIG. 14, the decoding method of embodiments of the present disclosure may be applied to an intra prediction part and/or an inter prediction part, mainly to an inter prediction method using inherited transformation models, which can improve the diversity of inter prediction.

It should also be noted that, in embodiments of the present disclosure, constructing the transformation model candidate list of the current block may include:
determining at least one candidate transformation model of the current block;
and determining the transformation model candidate list of the current block based on the at least one candidate transformation model.

In a specific embodiment, determining at least one candidate transformation model of the current block may include at least one of:
determining available transformation models for adjacent positions of the current block;
determining available temporal transformation models of the current block;
determining available transformation models for non-adjacent positions of the current block;
determining available shifted temporal transformation models of the current block;
determining historical available transformation models; and
determining a preset transformation model.

It should also be noted that, in embodiments of the present disclosure, when the current block uses the inter prediction mode and is determined to use a transformation model candidate list-based manner, the transformation model candidate list may be constructed for the current block, denoted as modelList, with a maximum length set to N, where N is a positive integer.

In some embodiments, the preset transformation model may include:
determining a transformation model corresponding to a local illumination compensation mode of the current block as the preset transformation model; or
adjusting an existing candidate transformation model in the transformation model candidate list, and determining the adjusted candidate transformation model as the preset transformation model.

In other words, in embodiments of the present disclosure, the preset transformation model serving as a default transformation model may be an LIC transformation model with model parameters (aro, Bro, α_{U0}, β_{U0}, α_{V0}, β_{V0}), or a transformation model obtained by adjusting an existing candidate transformation model in the modelList, etc.

In some embodiments, for the transformation model candidate list, transformation models may be added in the following candidate order:
\textcircled{1} available transformation models for adjacent positions;
\textcircled{2} available temporal transformation models;
\textcircled{3} available transformation models for non-adjacent positions;
\textcircled{4} available shifted temporal transformation models;
\textcircled{5} historical available transformation models; and
\textcircled{6} preset transformation model.

In some embodiments, for the transformation model candidate list, the method may further include:
after determining a new candidate transformation model of the current block, comparing the new candidate transformation model with existing candidate transformation models in the transformation model candidate list;
and adding the new candidate transformation model to the transformation model candidate list when the new candidate transformation model is different from all existing candidate transformation models in the transformation model candidate list.

In this way, redundancy is avoided by comparing a newly added transformation model with existing candidates in the modelList.

In some embodiments, for the transformation model candidate list, the method may further include:
when constructing the transformation model candidate list of the current block, determining a derived transformation model of the current block; and
adding the derived transformation model to the transformation model candidate list.

In embodiments of the present disclosure, a derived transformation model may also be included as one candidate transformation model. For example, the transformation model candidate list may be adjusted to {LIC, LIC_LEFT, LIC_TOP, LIC_MM, Filter, Model0, Model1, . . . }, where LIC, LIC_LEFT, . . . , Filter represent different methods of deriving transformation models from templates, and Model0, etc., represent transformation models inherited from spatial or temporal adjacent blocks, so as to construct the transformation model candidate list.

S2502: a transformation model of the current block is determined based on the transformation model candidate list, and a reference block of the current block is determined.

It should be noted that, in embodiments of the present disclosure, the transformation model of the current block may be determined first based on the transformation model candidate list, and then the reference block of the current block may be determined based on the transformation model; or, the reference block of the current block may be determined first, and then the transformation model of the current block may be determined based on the reference block and the transformation model candidate list.

In a possible implementation, determining the transformation model of the current block based on the transformation model candidate list and determining the reference block of the current block may include:
determining the transformation model of the current block based on the transformation model candidate list; and
determining the reference block of the current block based on the transformation model and a first merge candidate list.

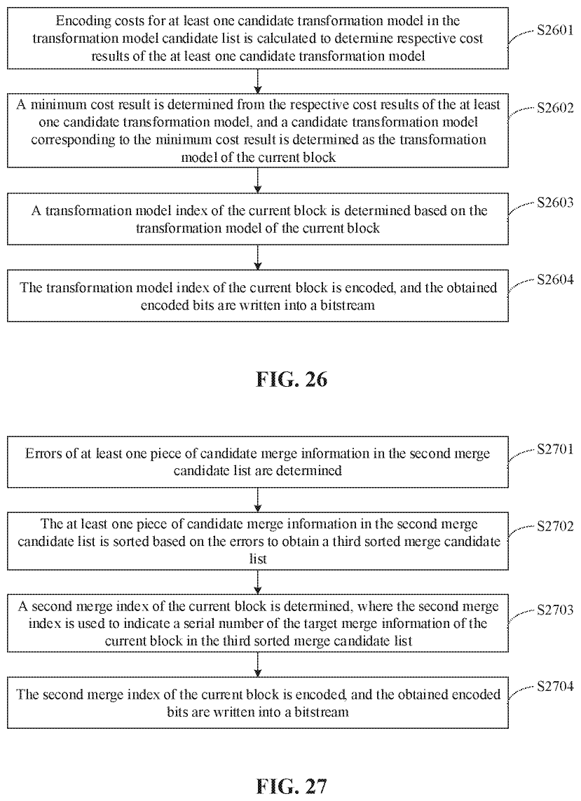

In some embodiments, for determining the transformation model of the current block, referring to FIG. 26, the method may further include:
S2601: encoding costs for at least one candidate transformation model in the transformation model candidate list is calculated to determine respective cost results of the at least one candidate transformation model;
S2602: a minimum cost result is determined from the respective cost results of the at least one candidate transformation model, and a candidate transformation model corresponding to the minimum cost result is determined as the transformation model of the current block;
S2603: a transformation model index of the current block is determined based on the transformation model of the current block; and
S2604: the transformation model index of the current block is encoded, and the obtained encoded bits are written into a bitstream.

It should be noted that, in embodiments of the present disclosure, the cost result may be determined based on a rate-distortion optimization (RDO) cost, a sum of absolute difference (SAD) cost, or even a sum of absolute transformed difference (SATD) cost, which is not limited herein.

It should also be noted that, in embodiments of the present disclosure, after determining the transformation model of the current block, an index of the transformation model in the transformation model candidate list, i.e., the transformation model index, may be further determined. The transformation model index indicates the index of the transformation model of the current block in the transformation model candidate list. The encoding end may encode the transformation model index of the current block and write the transformation model index into the bitstream.

It should also be noted that, in embodiments of the present disclosure, the transformation model index may be represented by cu_model_merge_idx, which indicates the index of the transformation model in the transformation model candidate list. The value range of cu_model_merge_idx may be less than or equal to the maximum length of the transformation model candidate list. Variable-length coding may be used for encoding cu_model_merge_idx, where a smaller index corresponds to a shorter codeword. For example, when the value range of cu_model_merge_idx is n, truncated binary coding is used.

It may be understood that, in embodiments of the present disclosure, for the first merge candidate list, the method may further include:
determining at least one piece of candidate motion information of the current block;
and constructing the first merge candidate list according to the at least one piece of candidate motion information of the current block,
where the candidate motion information is used to indicate a candidate reference block of the current block and/or a template of the candidate reference block.

In some embodiments, constructing the first merge candidate list according to the at least one piece of candidate motion information of the current block may include one of:
constructing the first merge candidate list based on at least one piece of candidate motion information determined in an inter merge manner;
constructing the first merge candidate list based on at least one piece of candidate motion information determined in a motion vector (MV) template matching manner;
constructing the first merge candidate list based on at least one piece of candidate motion information determined in an MV bi-prediction matching manner;
constructing the first merge candidate list based on at least one piece of candidate motion information determined in a motion vector difference (MVD) manner; and
constructing the first merge candidate list based on at least one piece of candidate motion information determined in a merge motion vector difference (MMVD) manner.

It should be noted that, in embodiments of the present disclosure, the first merge candidate list herein may be a constructed Inter Merge list, or a list constructed based on MV template matching, MV bi-prediction matching, MVD prediction, MMVD candidate sorting, etc. That is, the determined transformation model may be used to transform templates of reference blocks in the Merge list during inter prediction, or to transform reference block templates in processes such as MV template matching, MV bi-prediction matching, MVD prediction, and MMVD candidate sorting, so as to obtain transformed errors to replace template errors in the related art.

In a specific embodiment, determining the reference block of the current block based on the transformation model and the first merge candidate list may include:
calculating template errors for at least one candidate reference block indicated in the first merge candidate list based on the transformation model to determine errors of the at least one candidate reference block; and
determining a minimum error from the errors of the at least one candidate reference block, and determining a candidate reference block corresponding to the minimum error as the reference block of the current block.

In embodiments of the present disclosure, the candidate motion information in the first merge candidate list may correspondingly indicate one candidate reference block. For determining errors of the at least one candidate reference block, the method may include:
transforming templates of the at least one candidate reference block indicated in the first merge candidate list based on the transformation model to obtain transformed templates of the at least one candidate reference block;
and performing template error calculation based on a template of the current block and the transformed templates of the at least one candidate reference block respectively based on a preset criterion to determine the errors of the at least one candidate reference block.

It should also be noted that, in embodiments of the present disclosure, after constructing the first merge candidate list, it may be reordered. The method may further include:
performing sorting on the first merge candidate list based on the errors of the at least one candidate reference block to determine a first sorted merge candidate list.

It should also be noted that, in embodiments of the present disclosure, the preset criterion includes at least one of: SAD, SATD, mean squared error (MSE), root mean squared error (RMSE), mean absolute error (MAE), mean absolute deviation (MAD), and the like.

For example, taking SAD as an example, reference block templates in the first merge candidate list are transformed according to a determined transformation model, and the first merge candidate list is reordered based on transformed template errors. For instance, let the transformation model of the current block be modelList[idx], the template corresponding to the nth candidate motion information be Tn, and the template of the current block be Tcur, where the template error is calculated using SAD. First, Tn is transformed according to modelList[idx] to obtain Tn′, and then the SAD between Tn′ and Tcur is calculated to obtain the template error SADn of the candidate motion information. The template error SADi of each candidate motion information in the first merge candidate list is obtained through this operation, where 0≤i<N. The N pieces of candidate motion information in the first merge candidate list are then reordered according to SADi, where a smaller SADi corresponds to a smaller sorted index. In addition, when candidate motion information corresponds to bi-prediction, its template may be derived from bi-prediction; the template error may be calculated for all three YUV components or for a single component only; the process may also be consistent with the reordering process of the Inter Merge list in the related art.

In some embodiments, the method may further include:
determining a first merge index of the current block based on the reference block of the current block, where the first merge index indicates an index of the motion information corresponding to the reference block in the first sorted merge candidate list;
and encoding the first merge index, and writing the obtained encoded bits into the bitstream.

Here, the first merge candidate list may include N merge candidates, and the first merge index specifically indicates an index of a target merge candidate of the current block in the first sorted merge candidate list, where the target merge candidate may point to the reference block of the current block.

In some embodiments, the method may further include:
determining mode flag information of at least part of the candidate motion information in the first sorted merge candidate list;
and sorting the at least part of the candidate motion information in the first sorted merge candidate list based on the mode flag information of the at least part of the candidate motion information to determine a second sorted merge candidate list.

It should be noted that, in embodiments of the present disclosure, after reordering the first merge candidate list, part of the candidates in the list may be further sorted according to mode flag information (such as an LIC flag) of at least part of the candidate motion information to obtain the second sorted merge candidate list. For example, when the LIC flag of candidate motion information is true, it is placed ahead in the list; when multiple pieces of candidate motion information have a true LIC flag, their relative order may remain unchanged.

It should also be noted that, in embodiments of the present disclosure, the method may further include:
encoding the mode flag information of the at least part of the candidate motion information in the first sorted merge candidate list, and writing the obtained encoded bits into a bitstream.

In this way, at the decoding end, the mode flag information of the at least part of the candidate motion information may be determined by decoding the bitstream, so as to decide whether to further sort part of the candidates in the list.

In another specific embodiment, the method may further include:
determining a first merge index of the current block based on the reference block of the current block,
where the first merge index indicates an index of the motion information corresponding to the reference block in the first sorted merge candidate list or the second sorted merge candidate list;
encoding the first merge index, and writing the obtained encoded bits into the bitstream.

Here, the first merge index specifically indicates an index of a target merge candidate of the current block in the first sorted merge candidate list or the second sorted merge candidate list, where the target merge candidate may point to the reference block of the current block. In this way, at the decoding end, after obtaining the first merge index of the current block by decoding the bitstream, the reference block of the current block may be determined according to the selected target merge candidate.

In yet another specific embodiment, determining the reference block of the current block based on the transformation model and the first merge candidate list may further include:
when the current block uses a DMVR mode, determining at least one group of candidate reference blocks of the current block based on the first merge candidate list, where each group of candidate reference blocks includes two candidate reference blocks;
transforming the two candidate reference blocks in each group based on the transformation model to determine two transformed reference blocks in each group of candidate reference blocks;
calculating a matching error between the two transformed reference blocks in each group to determine an error corresponding to each group of candidate reference blocks;
and determining a group of candidate reference blocks with a minimum error, as the reference block of the current block according to the error corresponding to each group of candidate reference blocks.

It should be noted that, in embodiments of the present disclosure, the two reference blocks of a candidate motion vector (e.g., selected from the first merge candidate list) in the DMVR process may also be transformed based on the determined transformation model, and an error (e.g., SAD between the two reference blocks) may be calculated based on the two transformed reference blocks to determine a final optimization result. For example, a group of candidate reference blocks with a minimum error may be determined as the final reference block.

In another possible implementation, determining the transformation model of the current block based on the transformation model candidate list and determining the reference block of the current block may include:
determining the reference block of the current block;
and determining the transformation model of the current block based on the reference block and the transformation model candidate list.

For determining the reference block of the current block, matching search may be performed in a reference picture of the current block to determine an optimal MV, and the reference block of the current block may be determined according to the optimal MV; alternatively, MV-based template search or the like may be used to determine the reference block of the current block.

In some embodiments, the method may further include:
determining motion information of the current block based on the reference block;
encoding the motion information of the current block, and writing the obtained encoded bits into a bitstream.

In this way, at the decoding end, the motion information of the current block may be obtained by decoding the bitstream, and the reference block of the current block may be determined according to the motion information without performing a search process.

It should be noted that, in embodiments of the present disclosure, the transformation model candidate list may be sorted based on the reference block to obtain a sorted transformation model candidate list. In some embodiments, the sorting process may specifically include:
performing template error calculation based on the reference block and at least one candidate transformation model in the transformation model candidate list to determine errors of the at least one candidate transformation model;
and performing sorting on the transformation model candidate list according to the errors of the at least one candidate transformation model to determine the sorted transformation model candidate list.

In a specific embodiment, the method may further include:
determining a transformation model index of the current block, where the transformation model index indicates an index of the transformation model of the current block in the sorted transformation model candidate list; and
encoding the transformation model index of the current block, and writing the obtained encoded bits into a bitstream.

In this way, when the current block uses the inter prediction mode, the decoding end may first perform decoding to obtain the motion information and the reference block of the current block, then reorder the transformation model candidate list based on the reference block, and determine the transformation model of the current block in combination with the transformation model index written into the bitstream.

It may also be understood that, in embodiments of the present disclosure, no transformation model index is transmitted in a bitstream to store coding bits. In another specific embodiment, the method may further include:
performing template error calculation based on the reference block and at least one candidate transformation model in the transformation model candidate list to determine errors of the at least one candidate transformation model; and
determining a minimum error from the errors of the at least one candidate transformation model, and determining a candidate transformation model corresponding to the minimum error as the transformation model of the current block.

In other words, in embodiments of the present disclosure, the transformation model with the minimum error may be used as the finally selected transformation model, and the transformation model index is no longer written into a bitstream, thereby further improving coding efficiency.

In yet another specific embodiment, determining the transformation model of the current block based on the reference block and the transformation model candidate list may include:
performing sorting on the transformation model candidate list based on the reference block to determine a sorted transformation model candidate list;
determining a candidate transformation model at a preset position based on the sorted transformation model candidate list;
and determining the candidate transformation model at the preset position as the transformation model of the current block.

It should be noted that, in embodiments of the present disclosure, the preset list position may be a specific position in the sorted transformation model candidate list, such as a first element position or a last element position in the list, which is not specifically limited herein.

For example, when the transformation model candidate list is sorted such that a smaller template error corresponds to a smaller index, the first element position may be set as the preset list position, and the transformation model corresponding to index 0 in the sorted transformation model candidate list is directly determined as the final transformation model. Alternatively, when the transformation model candidate list is sorted such that a smaller template error corresponds to a larger index, the last element position may be set as the preset list position, and the transformation model corresponding to index N−1 in the sorted transformation model candidate list is directly determined as the final transformation model, where N represents the length of the transformation model candidate list.

It should also be noted that, in embodiments of the present disclosure, performing template error calculation based on the reference block and at least one candidate transformation model in the transformation model candidate list to determine errors of the at least one candidate transformation model may include:
respectively transforming a template of the reference block based on the at least one candidate transformation model to obtain transformed templates of at least one reference block;
and respectively calculating errors between a template of the current block and the transformed templates of the at least one reference block based on a preset criterion to determine the errors of the at least one candidate transformation model.

It should also be noted that, in embodiments of the present disclosure, the preset criterion includes at least one of SAD, SATD, MSE, RMSE, MAE, MAD, and the like.

For example, still taking SAD as an example, the transformation model candidate list is sorted based on the determined reference block. For instance, it is assumed that a template of the current block is Tcur, a template of the reference block is Tref, a candidate transformation model is modelList[i], and a template error is calculated using SAD. First, Tref is transformed according to modelList[i] to obtain Tref_i, and then the SAD between Tref_i and Tcur is calculated to obtain the template error SADi of a candidate transformation model. The template error SADi of each candidate transformation model in the transformation model candidate list is obtained through this operation, where 0≤i<N. The N candidate transformation models in the list are re-sorted according to SADi, where a smaller SADi corresponds to a smaller sorted index. In addition, when the current block uses bi-prediction, the template of the reference block may be derived from bi-prediction; the template error may be calculated for all three YUV components or for a single component only; and the process may also be consistent with the conventional reordering process of an Inter Merge list.

It may also be understood that, in embodiments of the present disclosure, when the current block uses a transformation model candidate list-based manner and the current block uses bi-prediction, the current block has two transformation model indices, such as a first transformation model index and a second transformation model index.

In some embodiments, the method may further include:
when the current block uses bi-prediction, determining the first transformation model index and the second transformation model index of the current block; and
encoding the first transformation model index and the second transformation model index, and writing the obtained encoded bits into a bitstream.

It should be noted that, in embodiments of the present disclosure, the first transformation model index may represent an index of the transformation model in the sorted transformation model candidate list and corresponding to the reference block of the current block in a first reference picture list, and the second transformation model index may represent an index of the transformation model in the sorted transformation model candidate list and corresponding to the reference block of the current block in a second reference picture list.

It should also be noted that, in embodiments of the present disclosure, when the current block uses bi-prediction, the first transformation model index and the second transformation model index of the current block may be encoded together, and the obtained encoded bits may be written into a bitstream; alternatively, the first transformation model index of the current block may be encoded first, with the obtained encoded bits written into a bitstream, and then, when the current block uses bi-prediction, the second transformation model index of the current block may be encoded, with the obtained encoded bits written into a bitstream.

It should also be noted that, in embodiments of the present disclosure, the method may further include:
determining prediction direction information of the current block; and
encoding the prediction direction information of the current block, and writing the obtained encoded bits into a bitstream.

It should also be noted that, in embodiments of the present disclosure, the prediction direction information may be represented by pu_inter_dir. For example, when the value of pu_inter_dir is equal to 3, it indicates that the current block uses bi-prediction. In addition, the first transformation model index may be represented by cu_model_merge_idx0, which may be an index of the transformation model corresponding to the reference block of the current block in the first reference picture list (List0), or in other words, an index of the transformation model corresponding to the reference block of the current block in the forward prediction direction; the second transformation model index may be represented by cu_model_merge_idx1, which may be an index of the transformation model corresponding to the reference block of the current block in the second reference picture list (List1), or in other words, an index of the transformation model corresponding to the reference block of the current block in the backward prediction direction. In other words, cu_model_merge_idx0 and cu_model_merge_idx1 respectively indicate indices of transformation models corresponding to reference blocks or reference block templates in different prediction directions (or in different reference picture lists).

In this way, after constructing the transformation model candidate list of the current block, the transformation model and the reference block of the current block may be determined.

S2503: the reference block is transformed based on the transformation model to determine a prediction block of the current block.

It should be noted that, in embodiments of the present disclosure, the transformation model of the current block may be determined first, and combined with the construction process of the first merge candidate list to obtain a final target merge candidate so as to determine the final reference block, and then the reference block may be transformed based on the transformation model of the current block to obtain the prediction block of the current block. Alternatively, motion information and the reference block of the current block may be obtained via decoding first, and then the transformation model candidate list may be re-sorted according to the template of the reference block. The transformation model of the current block may be determined according to the transformation model index obtained by decoding, and then the reference block may be transformed based on the transformation model to obtain the prediction block of the current block.

In some embodiments, after determining the prediction block of the current block, the method may further include:
determining an original block of the current block;
and determining a residual block of the current block based on the original block and the prediction block of the current block.

It should also be noted that, in embodiments of the present disclosure, determining the residual block of the current block based on the original block and the prediction block of the current block may include:
performing a subtraction operation on the original block and the prediction block of the current block to determine the residual block of the current block.

In some embodiments, the method may further include:
encoding the residual block of the current block, and writing the obtained encoded bits into a bitstream.

In this way, the encoding process of the current block may be completed.

In some embodiments, the method may further include: storing the transformation model of the current block.

In this way, the stored transformation model of the current block may be used for subsequent encoding processes. For example, it may be used to construct a transformation model candidate list for subsequent coding blocks.

It may also be understood that, in embodiments of the present disclosure, whether the current block uses the inter prediction mode may be indicated by first syntax flag information. In some embodiments, the method may further include:
determining a value of the first syntax flag information; and
encoding the value of the first syntax flag information, and writing the obtained encoded bits into a bitstream.

In embodiments of the present disclosure, the first syntax flag information may be represented by cu_prediction_mode, and is used to indicate whether the current block uses the inter prediction mode. When the current block uses the inter prediction mode, the value of the first syntax flag information is determined to be a first value; and when the current block does not use the inter prediction mode, the value of the first syntax flag information is determined to be a second value.

It may also be understood that, in embodiments of the present disclosure, whether the current block uses a transformation model candidate list-based manner may be indicated by second syntax flag information. In some embodiments, the method may further include:
determining a value of the second syntax flag information; and
encoding the value of the second syntax flag information, and writing the obtained encoded bits into a bitstream.

In embodiments of the present disclosure, the second syntax flag information may be represented by cu_model_merge_flag, and is used to indicate whether the current block uses the transformation model candidate list-based manner. When the current block uses the transformation model candidate list-based manner, the value of the second syntax flag information is determined to be a first value; and when the current block does not use the transformation model candidate list-based manner, the value of the second syntax flag information is determined to be a second value.

Here, the first value is different from the second value, and both the first value and the second value may be in a parameter form or a numeric form. Specifically, both the first syntax flag information and the second syntax flag information may be parameters written in a profile or values of a flag, which is not specifically limited herein. For example, the first value may be 1 and the second value may be 0; or the first value may be 0 and the second value may be 1; or the first value may be true and the second value may be false; or the first value may be false and the second value may be true.

It should also be noted that, in embodiments of the present disclosure, the second syntax flag information may be encoded using a context-based entropy coding method. In some embodiments, the method may further include:
encoding the value of the second syntax flag information based on a context model, and writing the obtained encoded bits into a bitstream.

In yet another possible implementation, the method may further include:
when the current block uses a reference block transformation-based prediction mode and the current block uses a transformation model candidate list-based manner, constructing a second merge candidate list for the current block;
determining the transformation model and the reference block of the current block based on the second merge candidate list;
and transforming the reference block based on the transformation model to determine the prediction block of the current block.

It should be noted that, in embodiments of the present disclosure, third syntax flag information may be used to indicate whether the current block uses the reference block transformation-based prediction mode, and fourth syntax flag information may be used to indicate whether the current block uses an inter merge prediction mode.

In some embodiments, the method may further include:
determining a value of the third syntax flag information; and
encoding the value of the third syntax flag information, and writing the obtained encoded bits into a bitstream.

In embodiments of the present disclosure, the third syntax flag information may be represented by cu_lic flag. When the current block uses the reference block transformation-based prediction mode, the value of the third syntax flag information is determined to be a first value; and when the current block does not use the reference block transformation-based prediction mode, the value of the third syntax flag information is determined to be a second value.

In some embodiments, the method may further include:
determining a value of the fourth syntax flag information; and
encoding the value of the fourth syntax flag information, and writing the obtained encoded bits into a bitstream.

In embodiments of the present disclosure, the fourth syntax flag information may be represented by pu_merge_flag. When the current block uses the inter merge prediction mode, the value of the fourth syntax flag information is determined to be a first value; and when the current block does not use the inter merge prediction mode, the value of the fourth syntax flag information is determined to be a second value.

Here, the first value is different from the second value, and both the first value and the second value may be in a parameter form or a numeric form. Specifically, both the third syntax flag information and the fourth syntax flag information may be parameters written in a profile or values of a flag, which is not specifically limited herein. For example, the first value may be 1 and the second value may be 0; or the first value may be 0 and the second value may be 1; or the first value may be true and the second value may be false; or the first value may be false and the second value may be true.

It should also be noted that, in embodiments of the present disclosure, it is first determined whether the current block uses the inter prediction mode; if the current block uses the inter prediction mode, it is further determined whether the current block uses the inter merge prediction mode; if the current block uses the inter merge prediction mode, it is further determined whether the current block uses the prediction mode that transforms the reference block; if the current block uses the prediction mode that transforms the reference block, it is further determined whether the current block uses the transformation model candidate list-based manner; if the current block uses the transformation model candidate list-based manner, the second merge candidate list for the current block may be constructed.

In some embodiments, constructing the second merge candidate list for the current block may include:
determining candidate merge information corresponding to a predefined position of the current block, where the candidate merge information includes motion information and a transformation model;
and adding the candidate merge information corresponding to the predefined position to the second merge candidate list when the candidate merge information corresponding to the predefined position satisfies a preset candidate condition.

In a specific embodiment, the case that the candidate merge information corresponding to the predefined position satisfies a preset candidate condition may include:
motion information corresponding to the predefined position is available, and a transformation model is stored at the predefined position.

In other words, in embodiments of the present disclosure, for the construction of the second merge candidate list, each merge candidate may include a corresponding transformation model. For example, taking adding spatial adjacent candidates as an example, predefined spatial positions are checked, and when motion information corresponding to a position is available, it is further checked whether a transformation model is stored at the position. When the above condition is satisfied, the motion information and transformation model corresponding to the position are added to the second merge candidate list as one of available merge candidates. Similarly, merge candidates of spatial, temporal, historical, average, default, and other types may also be added to the second merge candidate list.

In addition, it should be noted that the first merge candidate list constructed in the foregoing embodiments only includes candidate motion information, whereas the candidate motion information in the second merge candidate list constructed herein is accompanied by transformation models.

In some embodiments, determining the transformation model and the reference block of the current block based on the second merge candidate list may include:
calculating encoding costs for at least one piece of candidate merge information in the second merge candidate list to obtain respective cost results of the at least one piece of candidate merge information;
determining a minimum cost result from the respective cost results of the at least one piece of candidate merge information, and determining candidate merge information corresponding to the minimum cost result as target merge information of the current block;
and determining the transformation model and the reference block of the current block according to the target merge information.

It should be noted that, in embodiments of the present disclosure, determining the transformation model and the reference block of the current block according to the target merge information may be specifically implemented as follows: the target merge information includes motion information and a corresponding transformation model, and the motion information is capable of indicating the reference block of the current block.

In some embodiments, after determining the target merge information of the current block, referring to FIG. 27, the method may further include:
S2701: errors of at least one piece of candidate merge information in the second merge candidate list are determined;
S2702: the at least one piece of candidate merge information in the second merge candidate list is sorted based on the errors to obtain a third sorted merge candidate list;
S2703: a second merge index of the current block is determined, where the second merge index is used to indicate a serial number of the target merge information of the current block in the third sorted merge candidate list; and
S2704: the second merge index of the current block is encoded, and the obtained encoded bits are written into a bitstream.

It should be noted that, in embodiments of the present disclosure, the transformation model and the reference block of the current block are determined according to the target merge information. In this way, for a decoding end, after decoding to obtain the second merge index of the current block, the transformation model and the reference block of the current block may be directly determined in combination with the third sorted merge candidate list.

It should also be noted that, in embodiments of the present disclosure, for determining the error of at least one piece of candidate merge information in the second merge candidate list, first candidate merge information refers to any one of the at least one piece of candidate merge information. A schematic illustration is provided below by taking the first candidate merge information as an example.

In a possible implementation, the first candidate merge information may include first motion information and a first transformation model. Correspondingly, the method includes:
determining a template of a first reference block indicated by the first motion information based on the first motion information and the first transformation model included in the first candidate merge information;
transforming the template of the first reference block based on the first transformation model to obtain a transformed template of the first reference block;
and performing template error calculation based on a template of the current block and the transformed template of the first reference block based on a preset criterion to obtain an error of the first candidate merge information.

It should be noted that, in embodiments of the present disclosure, the preset criterion includes at least one of SAD, SATD, MSE, RMSE, MAE, MAD, and the like.

It should also be noted that, in embodiments of the present disclosure, the second merge candidate list may be reordered according to template errors, and a selected merge candidate (namely the target merge information) may be determined based on the second merge index and the reordered third sorted merge candidate list. When calculating a template error of a certain merge candidate, a reference block template obtained by the merge candidate may be transformed correspondingly based on the transformation model of the merge candidate, and then the template error may be calculated.

In another possible implementation, when the current block adopts a DMVR mode, the first candidate merge information may include two pieces of motion information and two transformation models, for example, first motion information and a first transformation model, as well as second motion information and a second transformation model. Correspondingly, the method may include:
when the current block adopts the DMVR mode, determining the first motion information and the first transformation model, as well as the second motion information and the second transformation model included in the first candidate merge information;
transforming a reference block indicated by the first motion information based on the first transformation model to determine a first transformed reference block;
transforming a reference block indicated by the second motion information based on the second transformation model to determine a second transformed reference block;
and calculating a matching error between the first transformed reference block and the second transformed reference block to determine an error of the first candidate merge information.

It should be noted that, in embodiments of the present disclosure, two reference blocks in a DMVR process may be transformed based on a transformation model of a merge candidate, and an error (such as SAD between the two reference blocks) may be calculated based on the two transformed reference blocks to determine a final optimization result. In addition, the transformation model may also transform reference block templates used in processes such as motion vector (MV) template matching, motion vector difference (MVD) prediction, and merge mode with motion vector difference (MMVD) candidate sorting to obtain transformed template errors for replacing template errors in the related art.

It should also be noted that, in embodiments of the present disclosure, constructing the second merge candidate list may include one of:
constructing the second merge candidate list based on at least one piece of candidate motion information determined in an inter prediction merge manner and a corresponding transformation model;
constructing the second merge candidate list based on at least one piece of candidate motion information determined in an MV template matching manner and a corresponding transformation model;
constructing the second merge candidate list based on at least one piece of candidate motion information determined in an MV bi-directional matching manner and a corresponding transformation model;
constructing the second merge candidate list based on at least one piece of candidate motion information determined in an MVD manner and a corresponding transformation model; and
constructing the second merge candidate list based on at least one piece of candidate motion information determined in an MMVD manner and a corresponding transformation model.

It should be noted that, in embodiments of the present disclosure, the second merge candidate list herein may be a constructed inter merge list, or a list constructed based on MV template matching, MV bi-directional matching, MVD prediction, MMVD candidate sorting, etc., only that merge candidates therein are attached with transformation models.

In this way, reference block templates used in processes such as the inter merge listing, MV template matching, MVD prediction, and MMVD candidate sorting may be transformed based on the transformation model of the merge candidate to obtain transformed template errors; then the at least one piece of candidate merge information in the second merge candidate list may be sorted according to the template errors to obtain a third sorted merge candidate list.

It should also be noted that, in embodiments of the present disclosure, the second merge index may be represented by cu_merge_idx. The second merge index is used to indicate a serial number of the target merge information of the current block in the third sorted merge candidate list. The target merge information of the current block may be determined according to cu_merge_idx written into a bitstream, and then the transformation model and the reference block of the current block may be determined.

In a specific embodiment, the method may further include: in response to adjusting motion information in the second merge candidate list, determining to keep a transformation model corresponding to the motion information unchanged.

In another specific embodiment, the method may further include:
in response to adjusting motion information in the second merge candidate list, determining an updated reference block of the current block according to the adjusted motion information;
and adjusting a model parameter of a transformation model corresponding to the motion information based on a template of the current block and a template of the updated reference block to obtain an adjusted transformation model.

It should be noted that, in embodiments of the present disclosure, the motion information (motion vector) in the second merge candidate list may be adjusted while the corresponding transformation model remains unchanged. For example, in an MMVD manner, there are n basic merge candidates, and after a basic merge candidate is selected, a motion vector is offset to construct an MVD merge candidate. Transformation models corresponding to these newly added merge candidates are the same as the transformation model of the basic merge candidate. For example, template matching is performed in an MV template matching manner on a merge candidate in an adjacent region pointed by the motion vector of the merge candidate, and the merge candidate is optimized according to a template error. It should be noted that the transformation model of the optimized merge candidate may remain unchanged. However, in some cases, part of model parameters in the transformation model may be changed while changing the motion information. For example, the updated reference block of the current block may be determined according to the adjusted motion information; then a model parameter of a transformation model corresponding to the motion information may be adjusted based on the template of the current block and the template of the updated reference block. For example, the template of the reference block determined according to the adjusted motion information is set as Tref, the template of the current block is set as Tcur, and the a model parameter of the transformation model are (α_{Y}, β_{Y}). Then β_{Y} may be derived according to Tcur, Tref and α_{Y}, and (α_{Y}, β_{Y}) may be used to replace (α_{Y}, β_{Y}) to obtain the updated transformation model.

It should also be noted that, in embodiments of the present disclosure, the transformation model of the current block may also be stored. In this way, the stored transformation model of the current block may be used for subsequent encoding processes, such as constructing a transformation model candidate list or a second merge candidate list with transformation models for subsequent coding blocks.

It should also be noted that, in embodiments of the present disclosure, the transformation model candidate list constructed by the present technical solution may be applied to both blocks adopting an inter prediction mode and blocks adopting an IBC mode, which is not specifically limited herein.

It may also be understood that, in embodiments of the present disclosure, the current block may have multiple components (such as a first color component, a second color component and a third color component), or a single component (such as the first color component); or may adopt uni-prediction or bi-prediction. For example, the first color component may be a Y component, the second color component may be a U component, and the third color component may be a V component, which is not specifically limited.

In some embodiments, when components to be processed of the current block include at least one of the first color component, the second color component and the third color component, the method may further include:
when the current block has one component to be processed and uses uni-prediction, storing a transformation model used by the component to be processed as one candidate transformation model;
when the current block has one component to be processed and uses bi-prediction, storing a transformation model used by the component to be processed as two candidate transformation models;
when the current block has three components to be processed and uses uni-prediction, storing transformation models used by the first color component, the second color component and the third color component as one candidate transformation model; and
when the current block has three components to be processed and uses bi-prediction, storing transformation models used by the first color component, the second color component and the third color component as two candidate transformation models.

It should be noted that, in embodiments of the present disclosure, the components to be processed of the current block may be one (such as a Y component) or multiple (such as three components including Y, U and V); and the prediction direction information herein may be uni-prediction or bi-prediction. These cases are illustrated below.

In a possible implementation, the current block only includes a Y component and adopts uni-prediction, and the transformation model used by the component may be stored as one transformation model candidate. For example, in an inter prediction mode, the current block adopts uni-prediction and is coded in an LIC mode, and a transformation model candidate (α_{Y0}, β_{Y0}) may be stored. For example, in an inter prediction mode, the current block adopts uni-prediction and is coded in an LIC multi-model mode, and a transformation model candidate (aro, Bro, α_{Y1}, β_{Y1}, Threshold) may be stored, where (aro, Bro) and (α_{Y1}, β_{Y1}) are two transformation models used by the current block, and Threshold is a threshold for determining which transformation model to apply to a certain pixel in the current block.

In another possible implementation, the current block includes three components Y, U and V and adopts uni-prediction, and transformation models used by the three components may be stored as one transformation model candidate. For example, in an inter prediction mode, the current block adopts uni-prediction and is coded in an LIC mode, and a transformation model candidate (α_{Y0}, β_{Y0}, α_{U0}, β_{U0}, α_{V0}, β_{V0}) may be stored, where (α_{Y0}, β_{Y0}), (α_{U0}, β_{U0}) and (α_{V0}, β_{V0}) are transformation models used by reference blocks of the current block on the Y, U and V components respectively. When a subsequent coding block selects the transformation model, (aro, Bro), (α_{U0}, β_{U0}) and (α_{V0}, β_{V0}) may be applied to Y, U and V components of its reference block respectively.

In yet another possible implementation, the current block only includes a Y component and adopts bi-prediction, and the transformation model used by the component may be stored as two transformation model candidates. For example, in an inter prediction mode, the current block adopts bi-prediction and is coded in an LIC mode, and two transformation model candidates (α_{Y0}, β_{Y0}) and (α_{Y1}, β_{Y1}) may be stored, which respectively correspond to transformation models used by a forward reference block and a backward reference block of the current block on the Y component.

In yet another possible implementation, the current block includes three components Y, U and V and adopts bi-prediction, and transformation models used by the three components may be stored as two transformation model candidates. For example, in an inter prediction mode, the current block adopts bi-prediction and is coded in an LIC mode, and two transformation model candidates (α_{Y0}, β_{Y0}, α_{U0}, β_{U0}, α_{V0}, β_{V0}) and (α_{Y1}, β_{Y1}, α_{U1}, β_{U1}, α_{V1}, β_{V1}) may be stored, which respectively correspond to transformation models used by a forward reference block and a backward reference block of the current block on the Y, U and V components.

In some embodiments, the method may further include: storing, when the current block includes three components to be processed, a transformation model used by one of the first color component, the second color component and the third color component. In this case, the method may further include: determining a type of the transformation model used by the one color component; and deriving transformation models used by the remaining two color components among the first color component, the second color component and the third color component based on adjacent reconstructed pixels of the current block and adjacent reconstructed pixels of the reference block, where types of the transformation models used by the remaining two color components are the same as a type of the transformation model used by the one color component.

In yet another possible implementation, the current block includes Y, U and V components, and only a transformation model used by one of the components may be stored as one transformation model candidate. For example, in an inter prediction mode, the current block adopts uni-prediction and is coded in an LIC mode, and a transformation model derived from a template is (aro, Bro, α_{U0}, β_{U0}, α_{V0}, β_{V0}), where (aro, Bro), (α_{U0}, β_{U0}) and (α_{V0}, β_{V0}) are transformation models used by reference blocks of the current block on the Y, U and V components respectively. Only (aro, Bro) may be stored for use by subsequent coding blocks. When a subsequent coding block selects a transformation model, (aro, Bro) may be applied to the Y component of its reference block, while transformation models for U and V components may be re-derived according to the template. It should be noted that the derived transformation models for the U and V components are of the same type as the stored transformation model for the Y component.

In some embodiments, the method may further include: when the current block adopts bi-prediction and two candidate transformation models to be stored are identical, storing one of the two candidate transformation models.

That is to say, in embodiments of the present disclosure, when the current block adopts bi-prediction, two transformation model candidates need to be stored, and two transformation models are identical, only one transformation model candidate may be stored. However, it should be noted that when a subsequent coding block constructs a transformation model candidate list, the two transformation models may be added sequentially respectively.

Briefly speaking, in embodiments of the present disclosure, when the current block is coded in an LIC mode or by using the present technical solution, the transformation model of the current block may be stored after being determined. When the current block includes Y, U and V components, transformation models used by the three components may be stored as one transformation model candidate (namely one transformation model candidate has transformation models respectively for reference blocks of the Y, U and V components). For example, in an inter prediction mode, the current block adopts uni-prediction and is coded in an LIC mode, and a transformation model candidate (aro, Bro, α_{U0}, β_{U0}, α_{V0}, β_{V0}) may be stored, where (α_{Y0}, β_{Y0}), (α_{U0}, β_{U0}) and (α_{V0}, β_{V0}) are transformation models used by reference blocks of the current block on the Y, U and V components respectively. For example, in an inter prediction mode, the current block adopts bi-prediction and is coded in an LIC mode, and two transformation model candidates (α_{Y0}, β_{Y0}, α_{U0}, β_{U0}, α_{V0}, β_{V0}) and (α_{Y1}, β_{Y1}, α_{U1}, β_{U1}, α_{V1}, β_{V1}) may be stored, which respectively correspond to transformation models used by a forward reference block and a backward reference block of the current block. When the two transformation models are identical, only one transformation model candidate may also be stored.

In some embodiments, the method may further include: determining first motion information of the current block; determining a first reference block of the current block according to the first motion information; adjusting a model parameter of the transformation model based on a template of the current block and a template of the first reference block to obtain an adjusted transformation model; and transforming the reference block based on the adjusted transformation model to obtain a prediction block of the current block.

It should be noted that, in embodiments of the present disclosure, the parameter of the transformation model may be updated according to the first motion information of the current block (such as motion information corresponding to a certain merge candidate list, motion information finally used by the current block, etc.). For example, the template of the reference block determined according to the motion information is set as Tref, the template of the current block is set as Tcur, and a candidate transformation model in the transformation model candidate list is (α_{Y}, β_{Y}). Then β_Y′ may be derived according to Tcur, Tref and α_{Y}, and (α_{Y}, β_{Y}) may be used to replace (α_{Y}, β_{Y}) to obtain the updated transformation model.

In some embodiments, the type of the transformation model may include at least one of: a linear model type, a filtering model type, a multi-model type, and a combination of different types.

It should be noted that, in embodiments of the present disclosure, the type of the transformation model may be a linear model (α, β), a Filter model, an LIC multi-model, etc., and may also include different types of transformation models, so as to construct the transformation model candidate list.

In some embodiments, the method may further include: determining a derived model of the current block by performing model derivation based on adjacent reconstructed pixels of the current block and adjacent reconstructed pixels of the reference block, or based on the reference block and a reconstructed block of the current block;
and storing the transformation model of the current block and the derived model of the current block.

It should be noted that, in embodiments of the present disclosure, after the reconstructed block of the current block is determined, a transformation model may be re-derived based on the reference block and a reconstructed block of the current block. Or, a transformation model may be obtained and stored through this method for a current block that does not originally use a transformation model; for a current block that originally uses a transformation model, the transformation model may replace an original transformation model for storage, or both new and old transformation models may be stored.

In some embodiments, for determining the transformation model, in addition to transmitting a transformation model index in a bitstream, a transformation model with a minimum template error may also be used as a finally selected transformation model, in which case no index is transmitted, thereby saving coding bits.

In some embodiments, the method may further include: determining first information of the current block;
and performing, in response to that the first information satisfies a first condition, the operation of determining a derived model of the current block by performing model derivation based on adjacent reconstructed pixels of the current block and adjacent reconstructed pixels of the reference block, or based on the reference block and a reconstructed block of the current block.

The first information includes at least one of: a position of the current block, a size of the current block, adjacent block information of the current block, and encoded syntax flag information of the current block.

It should be noted that, in embodiments of the present disclosure, a condition may be added to determine whether to derive a transformation model based on a reconstructed block, for example, whether to perform the operation of determining the derived model of the current block may be determined according to the size of the current block, a block-level flag, a frame-level flag, etc. The derived model of the current block may be derived based on adjacent reconstructed pixels of the current block and adjacent reconstructed pixels of the reference block, or based on the reference block and a reconstructed block of the current block.

In some embodiments, the method may further include: determining second information of the current block;
and performing, in response to that the second information satisfies a second condition, the operation of encoding a value of second syntax flag information and writing the obtained encoded bits into a bitstream.

The second information includes at least one of: a position of the current block, a size of the current block, adjacent block information of the current block, and encoded syntax flag information of the current block.

It should be noted that a judgment condition may be added when encoding a cu_model_merge_flag syntax element in various embodiments of the present technical solution. For example, whether to encode cu_model_merge_flag into a bitstream may be determined according to related syntax elements of encoded blocks. The position of the coded block may be an adjacent block of the current block, for example: a top-left coordinate of the current block is (x, y), and a width and a height are w and h respectively. Then encoded blocks located at (x−1, y+h−1), (x+w−1, y−1), (x−1, y+h), (x+w, y−1), (x−1, y−1) may be checked. The judgment condition may be that prediction mode-related syntax elements (such as cu_lic_flag, cu_model_merge_flag) of a certain encoded block (or a certain number of encoded blocks) are true. For example, whether to encode cu_model_merge_flag into a bitstream may be determined according to other encoded syntax elements of the current block, the position or size of the current block, a frame-level flag, a sequence-level flag, etc.

In some embodiments, a judgment condition may be added in the present technical solution to indicate whether to apply a specific process in the present technical solution. For example, in response to that the size of the current block exceeds a certain threshold, the process of transforming a template of a reference block based on a transformation model is not performed.

In some embodiments, when the current block adopts an inter prediction method based on an inherited transformation model, implementation processes of methods such as merge list construction, MMVD list construction, and DMVR for the current block may be different from those when the current block does not adopt the inter prediction method based on an inherited transformation model, for example, there are differences in a constructed list size, candidate information, etc. That is, judgment based on cu_model_merge_flag is introduced in various processes of inter prediction.

In some embodiments, the method may further include: determining third information of the current block;
and performing, in response to that the third information satisfies a third condition, the operation of storing the transformation model of the current block.

The third information includes at least one of: a position of the current block, a size of the current block, adjacent block information of the current block, and encoded syntax flag information of the current block.

It should be noted that, in embodiments of the present disclosure, a condition may also be added to determine whether to store a transformation model. For example, when the current block transforms a reference block using a transformation model, whether to store the transformation model or store the transformation model in a historical transformation model list may be determined according to the size of the current block, a block-level flag, a frame-level flag, etc.

In some embodiments, the method may further include: determining a derived transformation model of the current block when constructing a transformation model candidate list of the current block;
and adding the derived transformation model to the transformation model candidate list.

In some embodiments, the method may further include: performing the operation of constructing a transformation model candidate list of the current block when the current block adopts an intra block copy (IBC) mode.

It should be noted that, in embodiments of the present disclosure, fifth syntax flag information may be used to indicate whether the current block adopts an IBC mode. In some embodiments, the method may further include: determining a value of the fifth syntax flag information; and encoding the value of the fifth syntax flag information, and writing the obtained encoded bits into a bitstream.

It should also be noted that, in embodiments of the present disclosure, for the value of the fifth syntax flag information, the value of the fifth syntax flag information is set to a first value in response to that the current block adopts an IBC mode; and the value of the fifth syntax flag information is set to a second value in response to that the current block does not adopt an IBC mode. The first value is different from the second value. For example, the first value may be 1 and the second value may be 0; or the first value may be true and the second value may be false, which is not limited herein.

That is to say, in embodiments of the present disclosure, regardless whether in an inter prediction mode or an IBC mode, a derived transformation model may be used as one of candidate transformation models when a transformation model candidate list is constructed. For example, the transformation model candidate list constructed in the foregoing embodiments may be modified into {LIC, LIC_LEFT, LIC_TOP, LIC_MM, Filter, Model0, Model1, . . . }, where LIC, LIC_LEFT, . . . , Filter represent different template-based transformation model derivation methods, and Model0 and the like represent transformation models inherited from spatial and temporal domains. For example, when a value of cu_model_merge_idx is equal to 0, it indicates that the current block adopts an LIC prediction method, and a specific implementation process may be the same as that of an LIC technology in the related art.

In yet another embodiment of the present disclosure, a bitstream is further provided in embodiments of the present disclosure. The bitstream is generated by performing bit coding on information to be coded. The information to be coded includes at least one of:
a residual block of a current block, a transformation model index of the current block, a first merge index of the current block, a second merge index of the current block, motion information of the current block, a first transformation model index and a second transformation model index of the current block, prediction direction information of the current block, mode flag information of at least part of candidate motion information in a first sorted merge candidate list, a value of first syntax flag information, a value of second syntax flag information, a value of third syntax flag information, a value of fourth syntax flag information, and a value of fifth syntax flag information.

In embodiments of the present disclosure, the first syntax flag information is used to indicate whether the current block adopts an inter prediction mode, the second syntax flag information is used to indicate whether the current block adopts a transformation model candidate list-based manner, the third syntax flag information is used to indicate whether the current block adopts a reference block transformation-based prediction mode, the fourth syntax flag information is used to indicate whether the current block adopts an inter prediction merge mode, and the fifth syntax flag information is used to indicate whether the current block adopts an IBC mode.

Embodiments of the present disclosure provide an encoding method. When a current block adopts an inter prediction mode, a transformation model candidate list of the current block is constructed; a transformation model of the current block is determined based on the transformation model candidate list, and a reference block of the current block is determined; and the reference block is transformed based on the transformation model to obtain a prediction block of the current block. That is to say, when the current block adopts an inter prediction mode, a transformation model candidate list of the current block is first constructed, then a transformation model and a reference block of the current block are determined accordingly, and the reference block is transformed by the transformation model, thereby not only improving diversity of inter prediction, but also improving prediction accuracy, and further improving coding and decoding efficiency.

In yet another embodiment of the present disclosure, based on the encoding method and decoding method described in the foregoing embodiments, the method mainly includes: obtaining a transformation model of a current block by constructing a list; and the transformation model may be used for processes such as reference block transformation and template error calculation.

In a specific embodiment, in an inter prediction mode, a transformation model candidate list may be constructed for a current block, and a transformation model of the current block may be determined according to a candidate index written into a bitstream. The selected transformation model may be applied to processes such as merge list construction, MMVD list construction, MV template matching, MV bi-directional matching, and MVD prediction during inter prediction, so as to complete decoding of the current block.

For example, syntax elements are described as follows:
if (cu_prediction_mode==INTER_MODE)

{
...
cu_model_merge_flag
if( cu_model_merge_flag) {
cu_model_merge_idx
}
...
}

A specific implementation process is as follows.
Operation 1: When a coding block is coded using an LIC technology or the present technical solution, a transformation model used by the reference block may be stored after coding is completed. When the coding block includes Y, U and V components, transformation models used by the three components may be stored as one transformation model candidate (namely one transformation model candidate has transformation models respectively for reference blocks of the Y, U and V components). For example, an inter-coded block adopts uni-prediction and is coded in an LIC mode, and a transformation model candidate (α_{Y0}, β_{Y0}, α_{U0}, β_{U0}, α_{V0}, β_{V0}) may be stored, where (aro, Bro), (α_{U0}, β_{U0}) and (α_{V0}, β_{V0}) are transformation models used by reference blocks of the coded block on the Y, U and V components respectively. For example, an inter-coded block adopts bi-prediction and is coded in an LIC mode, and two transformation model candidates (α_{Y0}, β_{Y0}, α_{U0}, β_{U0}, α_{V0}, β_{V0}) and (α_{Y1}, β_{Y1}, QUI, β_{U1}, α_{V1}, β_{V1}) may be stored, which respectively correspond to transformation models used by a forward reference block and a backward reference block of the coded block. When the two transformation models are identical, only one transformation model candidate may be stored.
Operation 2: The current block is decoded. cu_prediction_mode is decoded to determine that the current block adopts an inter prediction mode; cu_model_merge_flag os decoded, and when cu_model_merge_flag is true, it indicates that a transformation model is determined by constructing g a transformation model candidate list. Further cu_model_merge_idx is decoded to determine which transformation model in the list is used, and when cu_model_merge_flag is false, it indicates that the prediction method of the present technical solution is not used.
Operation 3: A context-based entropy coding method may be adopted for cu_model_merge_flag. A value range of cu_model_merge_idx may be less than or equal to a maximum length of the transformation model candidate list, and variable-length coding may be used, where a smaller index corresponds to a shorter codeword. For example, the value range of cu_model_merge_idx is n, and truncated binary coding is used.
Operation 4: When cu_model_merge_flag is true, a transformation model candidate list is constructed for the current block, denoted as modelList, with a maximum length of N. The list may be sequentially composed of the following candidates:
a) available transformation models for adjacent positions;
b) available transformation models for a temporal domain;
c) available transformation models for non-adjacent positions;
d) available shifted temporal transformation models;
e) available historical transformation models; and
f) a default transformation model.

The default transformation model may include: an LIC transformation model with a parameter (α_{Y0}, β_{Y0}, α_{U0}, β_{U0}, α_{V0}, β_{V0}), and a transformation model adjusted from an existing transformation model in the list. When a certain transformation model is added, it may be compared with existing models in the list to prevent redundancy.
Operation 5: A certain transformation model is determined according to cu_model_merge_idx. For example, when a value of cu_model_merge_idx is equal to idx, modelList[idx] is determined as the transformation model of the current block.
Operation 6: A reference block template in an inter merge candidate list process may be transformed according to modelList[idx], and the inter merge candidate list is reordered according to a transformed template error. For example, the transformation model of the current block is modelList[idx], a template of an n-th merge candidate is Tn, a template of the current block is Tcur, and the template error is calculated using SAD. First, Tn is transformed according to modelList[idx] to obtain Tn′, then SAD between Tn′ and Tcur is calculated to obtain a template error SADn of the merge candidate. The template error SADi of each merge candidate is obtained through this process, where 0≤i<N. N merge candidates in the list are reordered according to SADi, where a smaller SADi corresponds to a smaller sorted index. When a certain candidate corresponds to bi-prediction, a template of the merge candidate may be obtained through bi-prediction. A template error may be calculated for three YUV components or a single component, which may be consistent with a conventional inter merge list reordering process.
Operation 7: After the inter merge candidate list is reordered in Operation 6, part of candidates in the inter merge candidate list may be further sorted according to mode flags such as an LIC flag in the merge candidates. For example, when an LIC flag of a merge candidate is true, the merge candidate is ranked ahead in the list. When LIC flags of multiple merge candidates are true, the relative order among these candidates may remain unchanged.
Operation 8: Two reference blocks in a DMVR process of a candidate motion vector (determined from merge candidates) may be transformed according to modelList[idx], and an error (such as SAD between two blocks) is calculated according to the two transformed reference blocks to determine a final optimization result.
Operation 9: With reference to Operation 6, reference block templates used in processes such as MV template matching, MVD prediction, and MMVD candidate sorting may be transformed according to modelList[idx] to obtain transformed template errors for replacing original template errors.
Operation 10: The transformation model of the current block is determined according to Operations 1 to 9, and the transformation model is combined with inter decoding processes such as merge list construction to obtain final motion information so as to determine a final reference block. The reference block is transformed based on the transformation model of the current block to obtain a prediction block of the current block. Decoding of the current block is completed in combination with decoded residual information and the like.
Operation 11: The transformation model used by the current block is stored for subsequent coding processes, such as constructing a transformation model candidate list for subsequent coding blocks.

In another specific embodiment, in an inter prediction mode, a transformation model candidate list is constructed for a current block. Motion information and a reference block of the current block are first determined according to decoding information, and then the transformation model candidate list is reordered based on a template of the reference block. A transformation model of the current block is determined according to a candidate index written into a bitstream. The reference block is transformed based on the transformation model to obtain a prediction block, and decoding of the current block is completed.

For example, syntax elements are described as follows:
if (cu_prediction_mode==INTER_MODE)

{
...
cu_model_merge_flag
if( cu_model_merge_flag) {
cu_model_merge_idx
}
...
}

A specific implementation process is as follows:
Operation 12: Same as Operations 1 to 4, syntax elements cu_model_merge_flag and cu_model_merge_idx are decoded to complete construction of a transformation model candidate list of the current block.
Operation 13: Motion information and a reference block of the current block are determined according to decoding information.
Operation 14: The transformation model candidate list may be sorted based on the reference block. For example, a template of the current block is Tcur, a template of the reference block is Tref, a certain transformation model candidate is modelList[i], and a template error is calculated using SAD. First, Tref is transformed according to modelList[i] to obtain Tref_i, then SAD between Tref_i and Tcur is calculated to obtain a template error SADi of the transformation model candidate. The template error SADi of each transformation model candidate is obtained through this process, where 0≤i<N. N transformation model candidates in the list are reordered according to SADi, where a smaller SADi corresponds to a smaller sorted index. When the current block adopts bi-prediction, a reference block template may be obtained through bi-prediction. The template error may be calculated for three YUV components or a single component, which may be consistent with a conventional inter merge list reordering process.
Operation 15: A selected transformation model of the current block is determined according to cu_model_merge_idx; the reference block is transformed based on the transformation model of the current block to obtain a prediction block of the current block. Decoding of the current block is completed in combination with decoded residual information and the like.
Operation 16: The transformation model used by the current block is stored for subsequent coding processes, such as constructing a transformation model candidate list for subsequent coding blocks.

In yet another specific embodiment, in an inter prediction mode, a merge candidate list with transformation models is constructed for a current block, and motion information and a transformation model of the current block are determined according to a candidate index written into a bitstream, so as to complete decoding of the current block.

For example, syntax elements are described as follows:

if(pu_merge_flag)
{
...
cu_lic_flag
if (cu_lic_flag)
{
cu_model_merge_flag
}
...
cu_merge_idx
...
}

Operation 17: Similar to Operation 1, when a coding block is coded using the LIC technology or the present technical solution, the transformation model used by the reference block of the coding block may be stored for subsequent coding blocks after the coding is completed.

The specific implementation process is as follows:
Operation 18: Both cu_lic_flag and cu_model_merge_flag are decoded as true, indicating that the current block uses a prediction method with an inherited transformation model; the current block is decoded. pu_merge_flag is decoded to determine that the current block uses an inter merge prediction mode; cu_lic_flag is decoded, and when cu_lic_flag is true, it indicates that a prediction mode with reference block transformation is used; cu_model_merge_flag is decoded: when cu_model_merge_flag is true, it indicates that a transformation model is determined by inheritance from a coded block; and when cu_model_merge_flag is false, it indicates that a transformation model is computed by template derivation.
Operation 19: When cu_lic_flag is true and cu_model_merge_flag is true, it indicates that the prediction method of the present solution is used. a merge candidate list is constructed, where each merge candidate may include a corresponding transformation model. For example, spatial adjacent candidates may be added. Predefined spatial positions are checked, and when motion information corresponding to a position is available, whether a transformation model is stored at the position is further checked. When the above condition is satisfied, the motion information and transformation model corresponding to the position are added as one available merge candidate to the merge candidate list. Similarly, merge candidates of spatial type, temporal type, history type, average type, default type, and the like may be included.
Operation 20: With reference to Operation 6, the merge candidate list obtained in Operation 19 may be reordered according to template errors, and a selected merge candidate is determined according to a merge index and the reordered merge list. When calculating the template error of a merge candidate, the obtained reference block template of the merge candidate is transformed correspondingly based on the transformation model of the merge candidate.
Operation 21: With reference to Operations 8 and 9, two reference blocks in a DMVR process may be transformed based on the transformation model of the merge candidate, and an error (e.g., SAD between the two blocks) is calculated according to the two transformed reference blocks to determine a final optimization result. Reference block templates used in processes such as MV template matching, MVD prediction, and MMVD candidate sorting are transformed to obtain transformed template errors for replacing original template errors.
Operation 22: In Operations 20 and 21, the motion information (motion vector) may be adjusted while the corresponding transformation model remains unchanged. For example, in an MMVD method, there are n basic merge candidates, and after a basic merge candidate is selected, a motion vector is offset to construct MVD merge candidates. Transformation models corresponding to these newly added merge candidates are the same as the transformation model of the basic merge candidate. For example, template matching is performed in an MV template matching manner on a merge candidate in an adjacent region pointed by the motion vector of the merge candidate, and the merge candidate is optimized according to a template error. The transformation model of the optimized merge candidate remains unchanged. Or, part of the model parameter of the transformation model may also be modified while adjusting the motion information (motion vector).
Operation 23: Final motion information and a transformation model are obtained according to Operations 17-21. The reference block is transformed based on the transformation model of the current block to obtain a prediction block of the current block. Decoding of the current block is completed in combination with decoded residual information and the like.
Operation 24: The transformation model used by the current block is stored for subsequent coding processes, such as constructing a transformation model candidate list for subsequent coding blocks.

It should be noted that, compared with the previous two specific embodiments, this specific embodiment does not require transmission of a transformation model index. Instead, transformation models correspond one-to-one to merge candidates in the merge mode, and only a merge index needs to be transmitted. This specific embodiment may be indicated by cu_lic_flag and cu_model_merge_flag to construct a new merge candidate list, and the transformation model corresponding to the merge candidate may be applied to processes involving reference block templates such as MVD prediction.

In another specific embodiment, a current block in the IBC prediction mode, Inter prediction mode or the like may have multiple color components (e.g., Y component, U component, and V component) or a single color component (e.g., Y component), and may use uni-prediction or bi-prediction. Storing transformation models, constructing a transformation model list, and applying transformation models may be implemented according to the following methods:
(a) When the current block has only a Y component and uses uni-prediction, the transformation model used by the component may be stored as one transformation model candidate. For example, when an inter-coded block uses uni-prediction and is coded in an LIC mode, a transformation model candidate (α_{Y0}, β_{Y0}) may be stored. For example, when an inter-coded block uses uni-prediction and is coded in an LIC multi-model mode, a transformation model candidate (α_{Y0}, β_{Y0}, α_{Y1}, β_{Y1}, Threshold) may be stored, where (α_{Y0}, β_{Y0}) and (α_{Y1}, β_{Y1}) are two transformation models used by the current block, and Threshold is a threshold for determining which transformation model to apply to a pixel in the block;
(b) When the current block has Y, U, and V components and uses uni-prediction, transformation models used by the three components may be stored as one transformation model candidate. For example, when an inter-coded block uses uni-prediction and is coded in an LIC mode, a transformation model candidate (α_{Y0}, β_{Y0}, α_{U0}, β_{U0}, α_{V0}, β_{V0}) may be stored, where (α_{Y0}, β_{Y0}), (α_{U0}, β_{U0}) and (α_{V0}, β_{V0}) are transformation models used by reference blocks of the current block on the Y, U, and V components respectively. When a subsequent coding block selects the transformation model, (α_{Y0}, β_{Y0}), (α_{U0}, β_{U0}) and (α_{V0}, β_{V0}) may be applied to the three components of its reference block respectively;
(c) When the current block has Y, U, and V components and uses bi-prediction, transformation models used by the three components may be stored as two transformation model candidates. For example, when an inter-coded block uses bi-prediction and is coded in an LIC mode, two transformation model candidates (α_{Y0}, β_{Y0}, α_{U0}, β_{U0}, α_{V0}, β_{V0}) and (α_{Y1}, β_{Y1}, α_{U1}, β_{U1}, α_{V1}, β_{V1}) may be stored, corresponding to transformation models used by forward and backward reference blocks of the current block respectively. When the two transformation models are identical, only one transformation model candidate may be stored. When a subsequent coding block constructs a transformation model candidate list, the two transformation models may be added sequentially respectively; and
(d) When the current block has Y, U, and V components, only the transformation model used by one component may be stored as one transformation model candidate. For example, when an inter-coded block uses uni-prediction and is coded in an LIC mode, the transformation model derived from a template is (aro, Bro, α_{U0}, β_{U0}, α_{V0}, β_{V0}), where (aro, Bro), (α_{U0}, β_{U0}) and (α_{V0}, β_{V0}) are transformation models used by reference blocks of the current block on the Y, U, and V components respectively. Only (aro, Bro) may be stored for use by subsequent coding blocks. When a subsequent coding block selects the transformation model, (α_{Y0}, β_{Y0}) may be applied to the Y component of its reference block, and transformation models for the U and V components may be re-derived according to the template.

In embodiments of the present disclosure, the specific implementations of the foregoing embodiments are described in detail through the above embodiments. According to the technical solutions of the foregoing embodiments, it may be seen that a transformation model candidate list is constructed for a current block, and a transformation model of the current block is determined by a transformation model index. In addition, the transformation model is combined with processes involving template error and bi-directional matching error calculation in inter prediction such as merge list construction, motion vector optimization and prediction, and transformed template errors are used to replace template errors in the related art. In this way, by using transformation model information of coded blocks, a method for using transformation models by constructing a candidate list and coding an index is proposed, thereby improving the diversity of inter prediction and further improving coding efficiency.

In yet another embodiment of the present disclosure, based on the same inventive concept as the foregoing embodiments, FIG. 28 is a schematic diagram of a composition structure of an encoder provided by an embodiment of the present disclosure. As shown in FIG. 28, the encoder 280 may include a first construction unit 2801, a first determination unit 2802, and a first prediction unit 2803.

The first construction unit 2801 is configured to construct a transformation model candidate list of a current block when the current block uses an inter prediction mode.

The first determination unit 2802 is configured to determine a transformation model of the current block based on the transformation model candidate list, and determine a reference block of the current block.

The first prediction unit 2803 is configured to transform the reference block based on the transformation model to determine a prediction block of the current block.

In some embodiments, the first determination unit 2802 is further configured to determine the transformation model of the current block based on the transformation model candidate list, and determine the reference block of the current block based on the transformation model and a first merge candidate list.

In some embodiments, the first determination unit 2802 is further configured to: calculate encoding costs for at least one candidate transformation model in the transformation model candidate list to determine respective cost results of the at least one candidate transformation model; and determine a minimum cost result from the respective cost results of the at least one candidate transformation model, and determine a candidate transformation model corresponding to the minimum cost result as the transformation model of the current block.

In some embodiments, referring to FIG. 28, the encoder 280 may further include a coding unit 2804.

The first determination unit 2802 is further configured to determine a transformation model index of the current block, where the transformation model index is used to indicate a serial number of the transformation model of the current block in the transformation model candidate list.

The coding unit 2804 is configured to encode the transformation model index of the current block, and write the obtained encoded bits into a bitstream.

In some embodiments, the first determination unit 2802 is further configured to determine at least one piece of candidate motion information of the current block.

The first construction unit 2801 is further configured to construct the first merge candidate list according to the at least one piece of candidate motion information of the current block, where the candidate motion information is configured to indicate a candidate reference block of the current block and/or a template of the candidate reference block.

In some embodiments, the first construction unit 2801 is further configured to:
construct the first merge candidate list based on at least one piece of candidate motion information determined in an inter merge manner;
construct the first merge candidate list based on at least one piece of candidate motion information determined in an MV template matching manner;
construct the first merge candidate list based on at least one piece of candidate motion information determined in an MV bi-directional matching manner;
construct the first merge candidate list based on at least one piece of candidate motion information determined in an MVD manner; and
and construct the first merge candidate list based on at least one piece of candidate motion information determined in an MMVD manner.

In some embodiments, the first determination unit 2802 is further configured to calculate template errors for at least one candidate reference block indicated in the first merge candidate list based on the transformation model to obtain errors of the at least one candidate reference block, and determine a minimum error from the errors of the at least one candidate reference block, and determine a candidate reference block corresponding to the minimum error as the reference block of the current block.

In some embodiments, the first determination unit 2802 is further configured to transform templates of at least one candidate reference block indicated in the first merge candidate list based on the transformation model to obtain transformed templates of the at least one candidate reference block; and perform template error calculation based on a template of the current block and the transformed templates of the at least one candidate reference block respectively based on a preset criterion to determine the errors of the at least one candidate reference block.

In some embodiments, the first determination unit 2802 is further configured to perform sorting on the first merge candidate list based on the errors of the at least one candidate reference block to obtain a first sorted merge candidate list.

In some embodiments, the first determination unit 2802 is further configured to determine mode flag information of at least part of candidate motion information in the first sorted merge candidate list; and sort the at least part of candidate motion information in the first sorted merge candidate list based on the mode flag information of the at least part of candidate motion information to obtain a second sorted merge candidate list.

In some embodiments, the coding unit 2804 is further configured to encode the mode flag information of the at least part of candidate motion information in the first sorted merge candidate list, and write the obtained encoded bits into a bitstream.

In some embodiments, the first determination unit 2802 is further configured to determine a first merge index of the current block based on the reference block of the current block, where the first merge index is used to indicate a serial number of motion information corresponding to the reference block in the first sorted merge candidate list or the second sorted merge candidate list.

The coding unit 2804 is further configured to encode the first merge index, and write the obtained encoded bits into a bitstream.

In some embodiments, the first determination unit 2802 is further configured to:
determine at least one group of candidate reference blocks of the current block based on the first merge candidate list when the current block uses a DMVR mode, each group of candidate reference blocks including two candidate reference blocks;
transform the two candidate reference blocks in each group of candidate reference blocks based on the transformation model to obtain two transformed reference blocks in each group of candidate reference blocks;
calculate a matching error between the two transformed reference blocks in each group of candidate reference blocks to obtain an error corresponding to each group of candidate reference blocks; and
determine a group of candidate reference blocks with a minimum error as the reference block of the current block according to the error corresponding to each group of candidate reference blocks.

In some embodiments, the first determination unit 2802 is further configured to determine the reference block of the current block, and determine the transformation model of the current block based on the reference block and the transformation model candidate list.

In some embodiments, the first determination unit 2802 is further configured to determine motion information of the current block based on the reference block.

The coding unit 2804 is further configured to encode the motion information of the current block, and write the obtained encoded bits into a bitstream.

In some embodiments, the first determination unit 2802 is further configured to: perform template error calculation based on the reference block and at least one candidate transformation model in the transformation model candidate list to determine errors of the at least one candidate transformation model; and determine a minimum error from the errors of the at least one candidate transformation model, and determine a candidate transformation model corresponding to the minimum error as the transformation model of the current block.

In some embodiments, the first determination unit 2802 is further configured to: perform sorting on the transformation model candidate list based on the reference block to determine a sorted transformation model candidate list; determine a candidate transformation model at a preset position based on the sorted transformation model candidate list; and determine the candidate transformation model at the preset position as the transformation model of the current block.

In some embodiments, the first determination unit 2802 is further configured to determine a transformation model index of the current block, where the transformation model index is used to indicate a serial number of the transformation model of the current block in the sorted transformation model candidate list.

The coding unit 2804 is further configured to encode the transformation model index of the current block, and write the obtained encoded bits into a bitstream.

In some embodiments, the first determination unit 2802 is further configured to performing template error calculation based on the reference block and at least one candidate transformation model in the transformation model candidate list to obtain errors of the at least one candidate transformation model; and perform sorting on the transformation model candidate list based on the errors of the at least one candidate transformation model to obtain a sorted transformation model candidate list.

In some embodiments, the first determination unit 2802 is further configured to transform a template of the reference block based on the at least one candidate transformation model respectively to obtain transformed templates of at least one reference block; and calculate errors between a template of the current block and the transformed templates of the at least one reference block respectively based on a preset criterion to determine the errors of the at least one candidate transformation model.

In some embodiments, the first determination unit 2802 is further configured to determine a first transformation model index and a second transformation model index of the current block when the current block uses bi-prediction.

The coding unit 2804 is further configured to encode the first transformation model index and the second transformation model index, and write the obtained encoded bits into a bitstream.

The first transformation model index represents a serial number of a transformation model in the sorted transformation model candidate list and corresponding to a reference block of the current block in a first reference picture list, and the second transformation model index represents a serial number of a transformation model in the sorted transformation model candidate list and corresponding to a reference block of the current block in a second reference picture list.

In some embodiments, the first prediction unit 2803 is further configured to determine prediction direction information of the current block.

The coding unit 2804 is further configured to encode the prediction direction information of the current block, and write the obtained encoded bits into a bitstream.

In some embodiments, the first determination unit 2802 is further configured to determine at least one candidate transformation model of the current block, and determine the transformation model candidate list of the current block based on the at least one candidate transformation model.

In some embodiments, the first determination unit 2802 is further configured to:
determine available transformation models for adjacent positions of the current block;
determine available transformation models for a temporal domain of the current block;
determine available transformation models for non-adjacent positions of the current block;
determine available shifted temporal transformation models of the current block;
determine available historical transformation models; and/or
determine a preset transformation model.

In some embodiments, the first determination unit 2802 is further configured to determine a transformation model corresponding to a local illumination compensation mode of the current block as the preset transformation model; or adjust an existing candidate transformation model in the transformation model candidate list, and determine the adjusted candidate transformation model as the preset transformation model.

In some embodiments, the first determination unit 2802 is further configured to: after determining a new candidate transformation model of the current block, compare the new candidate transformation model with existing candidate transformation models in the transformation model candidate list; and add the new candidate transformation model to the transformation model candidate list when the new candidate transformation model is different from all existing candidate transformation models in the transformation model candidate list.

In some embodiments, the first determination unit 2802 is further configured to determine a value of first syntax flag information, where the first syntax flag information is configured to indicate whether the current block uses an inter prediction mode.

The coding unit 2804 is further configured to encode the value of the first syntax flag information, and write the obtained encoded bits into a bitstream.

In some embodiments, the first determination unit 2802 is further configured to determine a value of second syntax flag information, where the second syntax flag information is configured to indicate whether the current block uses a transformation model candidate list-based manner.

The coding unit 2804 is further configured to encode the value of the second syntax flag information, and write the obtained encoded bits into a bitstream.

In some embodiments, the coding unit 2804 is further configured to encode the value of the second syntax flag information based on a context model, and write the obtained encoded bits into a bitstream.

In some embodiments, the first construction unit 2801 is further configured to construct a second merge candidate list of the current block when the current block uses a reference block transformation-based prediction mode and the current block uses a transformation model candidate list-based manner.

The first determination unit 2802 is further configured to determine the transformation model and the reference block of the current block based on the second merge candidate list.

The first prediction unit 2803 is further configured to transform the reference block based on the transformation model to determine the prediction block of the current block.

In some embodiments, the first determination unit 2802 is further configured to determine a value of third syntax flag information, where the third syntax flag information is configured to indicate whether the current block uses the reference block transformation-based prediction mode.

The coding unit 2804 is further configured to encode the value of the third syntax flag information, and write the obtained encoded bits into a bitstream.

In some embodiments, the first determination unit 2802 is further configured to determine a value of fourth syntax flag information, where the fourth syntax flag information is configured to indicate whether the current block uses an inter merge prediction mode.

The coding unit 2804 is further configured to encode the value of the fourth syntax flag information, and write the obtained encoded bits into a bitstream.

In some embodiments, the first determination unit 2802 is further configured to determine candidate merge information corresponding to a predefined position of the current block, where the candidate merge information includes motion information and a transformation model; and add the candidate merge information corresponding to the predefined position to the second merge candidate list when the candidate merge information corresponding to the predefined position satisfies a preset candidate condition.

In some embodiments, the case that the candidate merge information corresponding to the predefined position satisfies a preset candidate condition includes:
motion information corresponding to the predefined position is available, and a transformation model is stored at the predefined position.

In some embodiments, the first determination unit 2802 is further configured to:
calculate encoding costs for at least one piece of candidate merge information in
the second merge candidate list to obtain respective cost results of the at least one piece of candidate merge information;
determine a minimum cost result from the respective cost results of the at least one piece of candidate merge information, and determine candidate merge information corresponding to the minimum cost result as a target merge information of the current block;
and determine the transformation model and the reference block of the current block according to the target merge information.

In some embodiments, the first determination unit 2802 is further configured to determine errors of at least one piece of candidate merge information in the second merge candidate list; and sort the at least one piece of candidate merge information in the second merge candidate list based on the errors to obtain a third sorted merge candidate list.

In some embodiments, the first determination unit 2802 is further configured to determine a second merge index of the current block, where the second merge index is used to indicate a serial number of the target merge information of the current block in the third sorted merge candidate list.

The coding unit 2804 is further configured to encode the second merge index of the current block, and write the obtained encoded bits into a bitstream.

In some embodiments, the first determination unit 2802 is further configured to:
determine a template of a first reference block indicated by first motion information based on first motion information and a first transformation model included in first candidate merge information;
transform the template of the first reference block based on the first transformation model to obtain a transformed template of the first reference block;
and performing template error calculation based on a template of the current block and the transformed template of the first reference block based on a preset criterion to determine an error of the first candidate merge information.

The first candidate merge information is any one of the at least one piece of candidate merge information.

In some embodiments, the first determination unit 2802 is further configured to:
determine first motion information and a first transformation model, as well as second motion information and a second transformation model included in first candidate merge information when the current block uses a DMVR mode;
transform a reference block indicated by the first motion information based on the first transformation model to obtain a first transformed reference block;
transform a reference block indicated by the second motion information based on the second transformation model to obtain a second transformed reference block;
and calculate a matching error between the first transformed reference block and the second transformed reference block to obtain an error of the first candidate merge information.

The first candidate merge information is any one of the at least one piece of candidate merge information.

In some embodiments, the first construction unit 2801 is further configured to:
construct the second merge candidate list based on at least one piece of candidate motion information determined in an inter merge manner and a corresponding transformation model;
construct the second merge candidate list based on at least one piece of candidate motion information determined in an MV template matching manner and a corresponding transformation model;
construct the second merge candidate list based on at least one piece of candidate motion information determined in an MV bi-directional matching manner and a corresponding transformation model;
construct the second merge candidate list based on at least one piece of candidate motion information determined in an MVD manner and a corresponding transformation model;
and construct the second merge candidate list based on at least one piece of candidate motion information determined in an MMVD manner and a corresponding transformation model.

In some embodiments, the first determination unit 2802 is further configured to determine to keep a transformation model corresponding to motion information unchanged when motion information in the second merge candidate list is adjusted.

In some embodiments, the first determination unit 2802 is further configured to:
when motion information in the second merge candidate list is adjusted, determine an updated reference block of the current block according to the adjusted motion information;
and adjust a model parameter of a transformation model corresponding to the motion information based on a template of the current block and a template of the updated reference block to obtain an adjusted transformation model.

In some embodiments, the preset criterion includes at least one of SAD, SATD, MSE, RMSE, MAE, and MAD.

In some embodiments, the first determination unit 2802 is further configured to store the transformation model of the current block.

In some embodiments, the first determination unit 2802 is further configured to:
store a transformation model used by a component to be processed as one candidate transformation model when there is one component to be processed of the current block and the current block uses uni-prediction;
store a transformation model used by a component to be processed as two candidate transformation models when there is one component to be processed of the current block and the current block uses bi-prediction;
store transformation models used by a first color component, a second color component, and a third color component as one candidate transformation model when there are three components to be processed of the current block and the current block uses uni-prediction;
and store transformation models used by a first color component, a second color component, and a third color component as two candidate transformation models when there are three components to be processed of the current block and the current block uses bi-prediction.

In some embodiments, the first determination unit 2802 is further configured to store a transformation model used by one of the first color component, the second color component, and the third color component when there are three components to be processed of the current block.

In some embodiments, the first determination unit 2802 is further configured to:
determine a type of the transformation model used by the one color component;
and perform model derivation based on adjacent reconstructed pixels of the current block and adjacent reconstructed pixels of the reference block to determine transformation models used by remaining two color components among the first color component, the second color component, and the third color component, wherein types of the transformation models used by the remaining two color components are the same as a type of the transformation model used by the one color component.

In some embodiments, the first determination unit 2802 is further configured to: when the current block uses bi-prediction and two candidate transformation models to be stored are identical, store one of the two candidate transformation models.

In some embodiments, the first determination unit 2802 is further configured to:
determine first motion information of the current block;
determine a first reference block of the current block according to the first motion information of the current block;
and adjust a model parameter of the transformation model based on a template of the current block and a template of the first reference block to obtain an adjusted transformation model.

The first prediction unit 2803 is further configured to transform the reference block based on the adjusted transformation model to determine the prediction block of the current block.

In some embodiments, the type of the transformation model includes at least one of: a linear model type, a filtering model type, a multi-model type, and a combination of different types.

In some embodiments, the first determination unit 2802 is further configured to:
determine a derived model of the current block by performing model derivation based on adjacent reconstructed pixels of the current block and adjacent reconstructed pixels of the reference block, or based on the reference block and a reconstructed block of the current block;
and store the transformation model of the current block and the derived model of the current block.

In some embodiments, the first determination unit 2802 is further configured to:
determine first information of the current block; and
perform the operation of determining a derived model of the current block by performing model derivation based on adjacent reconstructed pixels of the current block and adjacent reconstructed pixels of the reference block or based on the reference block and a reconstructed block of the current block when the first information satisfies a first condition.

The first information includes at least one of: a position of the current block, a size of the current block, adjacent block information of the current block, and encoded syntax flag information of the current block.

In some embodiments, the first determination unit 2802 is further configured to determine second information of the current block.

The coding unit 2804 is further configured to perform the operation of encoding a value of second syntax flag information and writing the obtained encoded bits into a bitstream when the second information satisfies a second condition.

The second information includes at least one of: a position of the current block, a size of the current block, adjacent block information of the current block, and encoded syntax flag information of the current block.

In some embodiments, the first determination unit 2802 is further configured to:
determine third information of the current block;
and perform the operation of storing the transformation model of the current block when the third information satisfies a third condition.

The third information includes at least one of: a position of the current block, a size of the current block, adjacent block information of the current block, and encoded syntax flag information of the current block.

In some embodiments, the first determination unit 2802 is further configured to:
determine a derived transformation model of the current block when constructing the transformation model candidate list of the current block; and
add the derived transformation model to the transformation model candidate list.

In some embodiments, the first construction unit 2801 is further configured to perform the operation of constructing the transformation model candidate list of the current block when the current block uses an intra block copy (IBC) mode.

In some embodiments, the first determination unit 2802 is further configured to determine a value of fifth syntax flag information, where the fifth syntax flag information is configured to indicate whether the current block uses an IBC mode.

The coding unit 2804 is further configured to encode the value of the fifth syntax flag information, and write the obtained encoded bits into a bitstream.

In some embodiments, the first determination unit 2802 is further configured to determine an initial block of the current block; and determine a residual block of the current block based on the initial block of the current block and the prediction block of the current block.

In some embodiments, the coding unit 2804 is further configured to encode the residual block of the current block, and write the obtained encoded bits into a bitstream.

It may be understood that, in embodiments of the present disclosure, a “unit” may be a part of a circuit, a part of a processor, a part of a program or software, or the like, and may certainly be a module, or non-modular. Moreover, each component in the present embodiments may be integrated into one processing unit, or each unit may exist alone physically, or two or more units may be integrated into one unit. The above integrated unit may be implemented in the form of hardware or a software function module.

When the integrated unit is implemented as a software function module and is not sold or used as an independent product, it may be stored in a computer-readable storage medium. Based on such understanding, the technical solutions of the present embodiment essentially, or the part contributing to the related art, or all or part of the technical solutions may be embodied in the form of a software product. The computer software product is stored in a storage medium and includes a plurality of instructions for causing a computer device (which may be a personal computer, a server, or a network device) or a processor to perform all or part of the operations of the method described in the present embodiment. The foregoing storage medium includes: a U disk, a mobile hard disk, a Read Only Memory (ROM), a Random Access Memory (RAM), a magnetic disk, an optical disk, or other various media that can store program codes.

Therefore, an embodiment of the present disclosure provides a computer-readable storage medium applied to the encoder 280. The computer-readable storage medium has stored a computer program thereon, and the computer program, when executed by a first processor, implements the method according to any one of the foregoing embodiments.

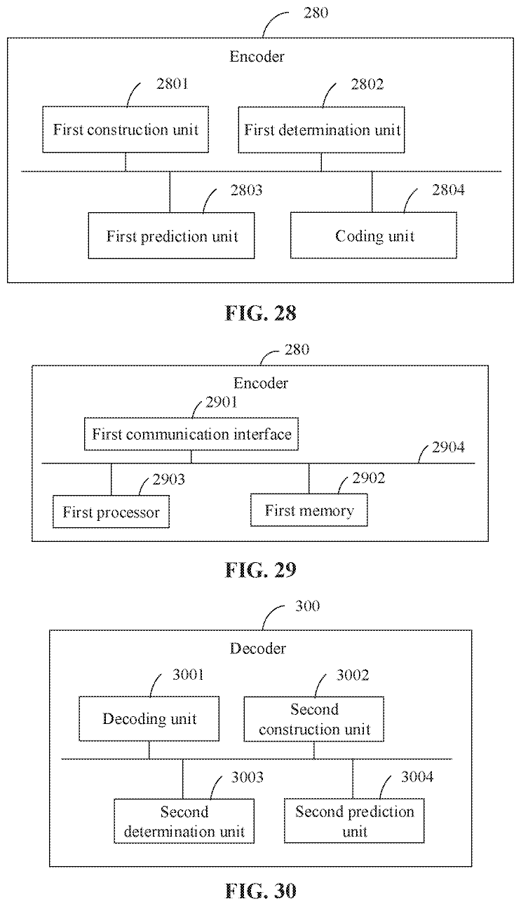

Based on the composition of the encoder 280 and the computer-readable storage medium, FIG. 29 is a schematic diagram of a specific hardware structure of an encoder provided by an embodiment of the present disclosure. As shown in FIG. 29, the encoder 280 may include: a first communication interface 2901, a first memory 2902, and a first processor 2903. The components are coupled together through a first bus system 2904. It may be understood that the first bus system 2904 is configured to implement connection and communication among these components. The first bus system 2904 includes a power bus, a control bus, and a status signal bus in addition to a data bus. However, for clarity of description, various buses are marked as the first bus system 2904 in FIG. 29.

The first communication interface 2901 is configured to receive and transmit signals during transceiving of information with other external network elements.

The first memory 2902 is configured to store a computer program capable of running on the first processor 2903.

The first processor 2903 is configured to, when running the computer program, perform:
when a current block uses an inter prediction mode, constructing a transformation model candidate list of the current block;
determining a transformation model of the current block based on the transformation model candidate list, and determining a reference block of the current block;
and transforming the reference block based on the transformation model to determine a prediction block of the current block.

It may be understood that the first memory 2902 in embodiments of the present disclosure may be a volatile memory or a non-volatile memory, or may include both volatile and non-volatile memories. The non-volatile memory may be a Read-Only Memory (ROM), a Programmable ROM (PROM), an Erasable PROM (EPROM), an Electrically Erasable PROM (EEPROM), or a flash memory. The volatile memory may be a Random Access Memory (RAM), used as an external cache. By way of example and not limitation, many forms of RAM are available, such as Static RAM (SRAM), Dynamic RAM (DRAM), Synchronous DRAM (SDRAM), Double Data Rate SDRAM (DDRSDRAM), Enhanced SDRAM (ESDRAM), Synchlink DRAM (SLDRAM), and Direct Rambus RAM (DRRAM). The first memory 2902 of the systems and methods described in the present disclosure is intended to include, but is not limited to, these and any other suitable types of memories.

The first processor 2903 may be an integrated circuit chip having a signal processing capability. In an implementation process, each operation of the above method may be completed by an integrated logic circuit of hardware in the first processor 2903 or an instruction in a form of software. The first processor 2903 may be a general-purpose processor, a Digital Signal Processor (DSP), an Application Specific Integrated Circuit (ASIC), a Field Programmable Gate Array (FPGA) or other programmable logic devices, discrete gate or transistor logic devices, or discrete hardware components, which may implement or execute the methods, operations, and logic block diagrams disclosed in embodiments of the present disclosure. The general-purpose processor may be a microprocessor, or the processor may be any conventional processor or the like. The operations of the method disclosed in embodiments of the present disclosure may be directly embodied as being completed and executed by a hardware decoding processor, or executed and completed by a combination of hardware and software modules in the decoding processor. The software module may be located in a mature storage medium in the art such as a random access memory, a flash memory, a read-only memory, a programmable read-only memory, an electrically erasable programmable memory, or a register. The storage medium is located in the first memory 2902, and the first processor 2903 reads information in the first memory 2902 and completes the operations of the above method in combination with hardware thereof.

It may be understood that the embodiments described in the present disclosure may be implemented by hardware, software, firmware, middleware, microcode, or a combination thereof. For a hardware implementation, a processing unit may be implemented in one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), general-purpose processors, controllers, microcontrollers, microprocessors, other electronic units configured to perform the functions described in the present disclosure, or a combination thereof. For a software implementation, the technology described in the present disclosure may be implemented by modules (e.g., processes, functions, and the like) configured to perform the functions described in the present disclosure. Software codes may be stored in a memory and executed by a processor. The memory may be implemented in the processor or external to the processor.

Optionally, as another embodiment, the first processor 2903 is further configured to, when running the computer program, perform the method according to any one of the foregoing embodiments.

An embodiment of the present disclosure provides an encoder. When a current block uses an inter prediction mode, a transformation model candidate list of the current block is first constructed, then a transformation model and a reference block of the current block are determined accordingly, and the reference block is transformed by the transformation model, thereby not only improving diversity of inter prediction, but also improving prediction accuracy, and further improving coding and decoding efficiency.

In yet another embodiment of the present disclosure, based on the same inventive concept as the foregoing embodiments, FIG. 30 is a schematic diagram of a composition structure of a decoder provided by an embodiment of the present disclosure. As shown in FIG. 30, the decoder 300 may include a decoding unit 3001, a second construction unit 3002, a second determination unit 3003, and a second prediction unit 3004.

The decoding unit 3001 is configured to decode a bitstream to determine a value of first syntax flag information.

The second construction unit 3002 is configured to construct a transformation model candidate list of a current block when the first syntax flag information indicates that the current block uses an inter prediction mode.

The second determination unit 3003 is configured to determine a transformation model of the current block based on the transformation model candidate list, and determine a reference block of the current block.

The second prediction unit 3004 is configured to transform the reference block based on the transformation model to determine a prediction block of the current block.

In some embodiments, the second determination unit 3003 is further configured to determine the transformation model of the current block based on the transformation model candidate list; and determine the reference block of the current block based on the transformation model and a first merge candidate list.

In some embodiments, the decoding unit 3001 is further configured to decode the bitstream to determine a transformation model index of the current block.

The second determination unit 3003 is further configured to determine the transformation model of the current block based on the transformation model index and the transformation model candidate list.

In some embodiments, the second determining unit 3003 is further configured to determine at least one piece of candidate motion information of the current block; the second constructing unit 3002 is further configured to construct a first merge candidate list according to the at least one piece of candidate motion information of the current block, wherein the candidate motion information is used to indicate a candidate reference block of the current block and/or a template of the candidate reference block.

In some embodiments, the second constructing unit 3002 is further configured to construct the first merge candidate list based on at least one piece of candidate motion information determined in an inter merge manner; construct the first merge candidate list based on at least one piece of candidate motion information determined in a motion vector template matching manner; construct the first merge candidate list based on at least one piece of candidate motion information determined in a motion vector bi-directional matching manner; construct the first merge candidate list based on at least one piece of candidate motion information determined in a motion vector difference manner; and construct the first merge candidate list based on at least one piece of candidate motion information determined in a motion vector difference merge manner.

In some embodiments, the second determining unit 3003 is further configured to calculate template errors for at least one candidate reference block indicated in the first merge candidate list based on the transformation model to determine errors of the at least one candidate reference block; and determine a minimum error from the errors of the at least one candidate reference block, and determine a candidate reference block corresponding to the minimum error as the reference block of the current block.

In some embodiments, the second determining unit 3003 is further configured to transform templates of at least one candidate reference block indicated in the first merge candidate list based on the transformation model to obtain transformed templates of the at least one candidate reference block; and performing template error calculation based on a template of the current block and the transformed templates of the at least one candidate reference block respectively based on a preset criterion to determine the errors of the at least one candidate reference block.

In some embodiments, the second determining unit 3003 is further configured to perform sorting on the first merge candidate list based on the errors of the at least one candidate reference block, so as to determine a first sorted merge candidate list.

In some embodiments, the decoding unit 3001 is further configured to decode the bitstream to determine mode flag information of at least part of candidate motion information in the first sorted merge candidate list; the second determining unit 3003 is further configured to sort the at least part of candidate motion information in the first sorted merge candidate list based on the mode flag information of the at least part of candidate motion information, so as to determine a second sorted merge candidate list.

In some embodiments, the decoding unit 3001 is further configured to decode the bitstream to determine a first merge index of the current block; the second determining unit 3003 is further configured to determine the reference block of the current block based on the first merge index and the first sorted merge candidate list or the second sorted merge candidate list.

In some embodiments, the second determining unit 3003 is further configured to, when the current block uses a DMVR mode, determine at least one group of candidate reference blocks of the current block based on the first merge candidate list, each group of candidate reference blocks including two candidate reference blocks; transform the two candidate reference blocks in each group of candidate reference blocks based on the transformation model to determine two transformed reference blocks in each group of candidate reference blocks; calculate a matching error between the two transformed reference blocks in each group of candidate reference blocks to determine an error corresponding to each group of candidate reference blocks; and determine, according to the error corresponding to each group of candidate reference blocks, a group of candidate reference blocks with a minimum error as the reference block of the current block.

In some embodiments, the decoding unit 3001 is further configured to decode the bitstream to determine the reference block of the current block; the second determining unit 3003 is further configured to determine the transformation model of the current block based on the reference block and the transformation model candidate list.

In some embodiments, the decoding unit 3001 is further configured to decode the bitstream to determine motion information of the current block; the second determining unit 3003 is further configured to determine the reference block of the current block according to the motion information.

In some embodiments, the second determining unit 3003 is further configured to perform sorting on the transformation model candidate list based on the reference block to determine a sorted transformation model candidate list; the decoding unit 3001 is further configured to decode the bitstream to determine a transformation model index of the current block; and the second determining unit 3003 is further configured to determine the transformation model of the current block based on the transformation model index and the sorted transformation model candidate list.

In some embodiments, the second determining unit 3003 is further configured to performing template error calculation based on the reference block and at least one candidate transformation model in the transformation model candidate list, so as to determine errors of the at least one candidate transformation model; and determine a minimum error from the errors of the at least one candidate transformation model, and determine a candidate transformation model corresponding to the minimum error as the transformation model of the current block.

In some embodiments, the second determining unit 3003 is further configured to determine, based on the sorted transformation model candidate list, a candidate transformation model at a preset list position; and determine the candidate transformation model at the preset list position as the transformation model of the current block.

In some embodiments, the second determining unit 3003 is further configured to performing template error calculation based on the reference block and at least one candidate transformation model in the transformation model candidate list to determine errors of the at least one candidate transformation model; and perform sorting on the transformation model candidate list based on the errors of the at least one candidate transformation model, so as to determine a sorted transformation model candidate list.

In some embodiments, the second determining unit 3003 is further configured to transform a template of the reference block based on the at least one candidate transformation model respectively to obtain transformed templates of at least one reference block; and calculate errors between a template of the current block and the transformed templates of the at least one reference block respectively based on a preset criterion to determine the errors of the at least one candidate transformation model.

In some embodiments, the decoding unit 3001 is further configured to decode the bitstream to determine prediction direction information of the current block; and decode the bitstream to determine a first transformation model index and a second transformation model index of the current block when the prediction direction information indicates that the current block uses bi-prediction, wherein the first transformation model index is used to represent a serial number of a transformation model in the sorted transformation model candidate list and corresponding to a reference block of the current block in a first reference picture list, and the second transformation model index is used to represent a serial number of a transformation model in the sorted transformation model candidate list and corresponding to a reference block of the current block in a second reference picture list.

In some embodiments, the decoding unit 3001 is further configured to decode the bitstream to determine a first transformation model index of the current block; and decode the bitstream to determine a second transformation model index of the current block when the prediction direction information indicates that the current block uses bi-prediction.

In some embodiments, the second determining unit 3003 is further configured to determine at least one candidate transformation model of the current block; and determine the transformation model candidate list of the current block based on the at least one candidate transformation model.

In some embodiments, the second determining unit 3003 is further configured to determine available transformation models for adjacent positions of the current block; determine available transformation models for a temporal domain of the current block; determine available transformation models for non-adjacent positions of the current block; determine available shifted temporal transformation models of the current block; determine available historical transformation models; and/or determine a preset transformation model.

In some embodiments, the second determining unit 3003 is further configured to determine a transformation model corresponding to a local illumination compensation mode of the current block as the preset transformation model; or adjust an existing candidate transformation model in the transformation model candidate list, and determine the adjusted candidate transformation model as the preset transformation model.

In some embodiments, the second determining unit 3003 is further configured to, after determining a new candidate transformation model of the current block, compare the new candidate transformation model with existing candidate transformation models in the transformation model candidate list; and add the new candidate transformation model to the transformation model candidate list when the new candidate transformation model is different from all existing candidate transformation models in the transformation model candidate list.

In some embodiments, the decoding unit 3001 is further configured to decode the bitstream to determine a value of second syntax flag information; the second constructing unit 3002 is further configured to perform the operation of constructing the transformation model candidate list of the current block when the second syntax flag information indicates that the current block uses a transformation model candidate list-based manner.

In some embodiments, the decoding unit 3001 is further configured to decode the bitstream based on a context model to determine a value of second syntax flag information.

In some embodiments, the decoding unit 3001 is further configured to decode the bitstream to determine a value of third syntax flag information; and decode the bitstream to determine a value of second syntax flag information when the third syntax flag information indicates that the current block uses a reference block transformation-based prediction mode; the second constructing unit 3002 is further configured to construct a second merge candidate list of the current block when the second syntax flag information indicates that the current block uses a transformation model candidate list-based manner; the second determining unit 3003 is further configured to determine the transformation model and the reference block of the current block based on the second merge candidate list; and the second predicting unit 3004 is further configured to transform the reference block based on the transformation model to determine the prediction block of the current block.

In some embodiments, the decoding unit 3001 is further configured to decode the bitstream to determine a value of fourth syntax flag information; and perform the operation of decoding the bitstream to determine a value of third syntax flag information when the fourth syntax flag information indicates that the current block uses an inter merge prediction mode.

In some embodiments, the second determining unit 3003 is further configured to determine candidate merge information corresponding to a predefined position of the current block, wherein the candidate merge information includes motion information and a transformation model; and add the candidate merge information corresponding to the predefined position to the second merge candidate list when the candidate merge information corresponding to the predefined position satisfies a preset candidate condition.

In some embodiments, the case that the candidate merge information corresponding to the predefined position satisfies a preset candidate condition includes: motion information corresponding to the predefined position is available, and a transformation model is stored at the predefined position.

In some embodiments, the second determining unit 3003 is further configured to determine errors of the at least one piece of candidate merge information in the second merge candidate list; and sort the at least one piece of candidate merge information in the second merge candidate list based on the errors to determine a third sorted merge candidate list; the decoding unit 3001 is further configured to decode the bitstream to determine a second merge index of the current block; and the second determining unit 3003 is further configured to determine target merge information of the current block based on the second merge index and the third sorted merge candidate list, and determine the transformation model and the reference block of the current block according to the target merge information.

In some embodiments, the second determining unit 3003 is further configured to determine, based on a first transformation model and first motion information included in first candidate merge information, a template of a first reference block indicated by the first motion information; transform the template of the first reference block based on the first transformation model to determine a transformed template of the first reference block; and performing template error calculation based on a template of the current block and the transformed template of the first reference block based on a preset criterion to determine an error of the first candidate merge information, wherein the first candidate merge information is any one of the at least one piece of candidate merge information.

In some embodiments, the second determining unit 3003 is further configured to, when the current block uses a DMVR mode, determine first motion information and a first transformation model as well as second motion information and a second transformation model included in first candidate merge information; transform a reference block indicated by the first motion information based on the first transformation model to determine a first transformed reference block; and transform a reference block indicated by the second motion information based on the second transformation model to determine a second transformed reference block; and calculate a matching error between the first transformed reference block and the second transformed reference block to determine an error of the first candidate merge information, wherein the first candidate merge information is any one of the at least one piece of candidate merge information.

In some embodiments, the second constructing unit 3002 is further configured to construct the second merge candidate list based on at least one piece of candidate motion information determined in an inter merge manner and a corresponding transformation model; construct the second merge candidate list based on at least one piece of candidate motion information determined in a motion vector template matching manner and a corresponding transformation model; construct the second merge candidate list based on at least one piece of candidate motion information determined in a motion vector bi-directional matching manner and a corresponding transformation model; construct the second merge candidate list based on at least one piece of candidate motion information determined in a motion vector difference manner and a corresponding transformation model; and construct the second merge candidate list based on at least one piece of candidate motion information determined in a motion vector difference merge manner and a corresponding transformation model.

In some embodiments, the second determining unit 3003 is further configured to determine to keep the transformation model corresponding to motion information unchanged when motion information in the second merge candidate list is adjusted.

In some embodiments, the second determining unit 3003 is further configured to, when motion information in the second merge candidate list is adjusted, determine an updated reference block of the current block according to the adjusted motion information; and adjust a model parameter of a transformation model corresponding to the motion information based on a template of the current block and a template of the updated reference block, so as to obtain an adjusted transformation model.

In some embodiments, the preset criterion includes at least one of: SAD, SATD, MSE, RMSE, MAE, and MAD.

In some embodiments, the second determining unit 3003 is further configured to store the transformation model of the current block.

In some embodiments, the second determining unit 3003 is further configured to store a transformation model used by a component to be processed as one candidate transformation model when there is one component to be processed of the current block and the current block uses uni-prediction; store the transformation model used by a component to be processed as two candidate transformation models when there is one component to be processed of the current block and the current block uses bi-prediction; store transformation models used by a first color component, a second color component and a third color component as one candidate transformation model when there are three components to be processed of the current block and the current block uses uni-prediction; and store transformation models used by a first color component, a second color component and a third color component as two candidate transformation models when there are three components to be processed of the current block and the current block uses bi-prediction.

In some embodiments, the second determining unit 3003 is further configured to store a transformation model used by one of the first color component, the second color component and the third color component when there are three components to be processed of the current block.

In some embodiments, the second determining unit 3003 is further configured to determine a type of the transformation model used by the one color component; and derive transformation models used by the remaining two color components among the first color component, the second color component and the third color component based on adjacent reconstructed pixels of the current block and adjacent reconstructed pixels of the reference block, wherein types of the transformation models used by the remaining two color components are the same as a type of the transformation model used by the one color component.

In some embodiments, the second determining unit 3003 is further configured to, when the current block uses bi-prediction and two candidate transformation models to be stored are identical, store one of the two candidate transformation models.

In some embodiments, the second determining unit 3003 is further configured to determine first motion information of the current block; determine a first reference block of the current block according to the first motion information; and adjust a model parameter of the transformation model based on a template of the current block and a template of the first reference block to obtain an adjusted transformation model; and the second predicting unit 3004 is further configured to transform the reference block based on the adjusted transformation model to determine the prediction block of the current block.

In some embodiments, the type of the transformation model includes at least one of: a linear model type, a filtering model type, a multi-model type, and a combination of different types.

In some embodiments, the second determining unit 3003 is further configured to determine a derived model of the current block by performing model derivation based on adjacent reconstructed pixels of the current block and adjacent reconstructed pixels of the reference block or based on the reference block and a reconstructed block of the current block; and store the transformation model of the current block and the derived model of the current block.

In some embodiments, the second determining unit 3003 is further configured to determine first information of the current block; and perform the operation of determining a derived model of the current block by performing model derivation based on adjacent reconstructed pixels of the current block and adjacent reconstructed pixels of the reference block or based on the reference block and a reconstructed block of the current block when the first information satisfies a first condition, wherein the first information includes at least one of: a position of the current block, a size of the current block, adjacent block information of the current block, and decoded syntax flag information of the current block.

In some embodiments, the second determining unit 3003 is further configured to determine second information of the current block; the decoding unit 3001 is further configured to perform the operation of decoding the bitstream to determine a value of second syntax flag information when the second information satisfies a second condition, wherein the second information includes at least one of: a position of the current block, a size of the current block, adjacent block information of the current block, and decoded syntax flag information of the current block.

In some embodiments, the second determining unit 3003 is further configured to determine third information of the current block; and perform the operation of storing the transformation model of the current block when the third information satisfies a third condition, wherein the third information includes at least one of: a position of the current block, a size of the current block, adjacent block information of the current block, and decoded syntax flag information of the current block.

In some embodiments, the second constructing unit 3002 is further configured to, when constructing the transformation model candidate list of the current block, determine a derived transformation model of the current block; and add the derived transformation model to the transformation model candidate list.

In some embodiments, the decoding unit 3001 is further configured to decode the bitstream to determine a value of fifth syntax flag information; the second constructing unit 3002 is further configured to perform the operation of constructing the transformation model candidate list of the current block when the fifth syntax flag information indicates that the current block uses an intra block copy mode.

It may be understood that, in the present embodiment, a “unit” may be a part of a circuit, a part of a processor, a part of a program or software, etc., and may of course be a module, or non-modular. Moreover, each component in the present embodiment may be integrated into one processing unit, or each unit may exist alone physically, or two or more units may be integrated into one unit. The above integrated unit may be implemented in the form of hardware or a software function module.

When the integrated unit is implemented as a software function module and is not sold or used as an independent product, it may be stored in a computer-readable storage medium. Based on such understanding, the present embodiment provides a computer-readable storage medium applied to the decoder 300, the computer-readable storage medium storing a computer program, the computer program, when executed by a second processor, implementing the method according to any one of the preceding embodiments.

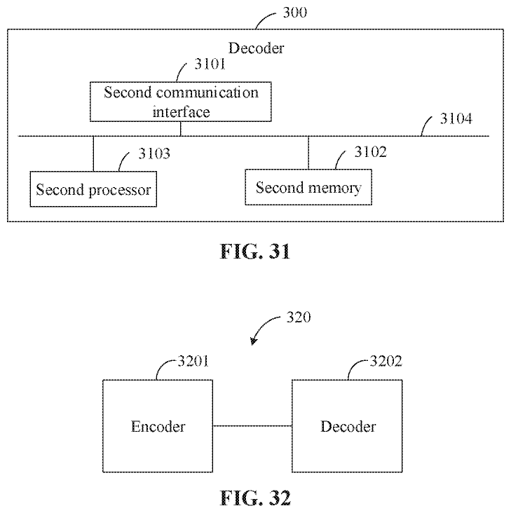

Based on the composition of the decoder 300 and the computer-readable storage medium, FIG. 31 is a schematic diagram of a specific hardware structure of a decoder provided by an embodiment of the present disclosure. As shown in FIG. 31, the decoder 300 may include: a second communication interface 3101, a second memory 3102 and a second processor 3103; the components are coupled together through a second bus system 3104. It may be understood that the second bus system 3104 is used to implement connection and communication among these components. The second bus system 3104 includes a power bus, a control bus and a status signal bus in addition to a data bus. However, for clarity of description, various buses are marked as the second bus system 3104 in FIG. 31. Wherein,
The second communication interface 3101 is used to receive and transmit signals during transceiving of information with other external network elements;
The second memory 3102 is used to store a computer program capable of running on the second processor 3103;
The second processor 3103 is used to, when running the computer program, perform: decoding a bitstream to determine a value of first syntax flag information; constructing a transformation model candidate list of a current block when the first syntax flag information indicates that the current block uses an inter prediction mode; determining a transformation model of the current block based on the transformation model candidate list, and determining a reference block of the current block; transforming the reference block based on the transformation model to determine a prediction block of the current block.

Optionally, as another embodiment, the second processor 3103 is further configured to, when running the computer program, perform the method according to any one of the preceding embodiments.

It may be understood that the hardware functions of the second memory 3102 are similar to those of the first memory 2902, and the hardware functions of the second processor 3103 are similar to those of the first processor 2903. The detailed descriptions thereof are omitted here.

An embodiment of the present disclosure provides a decoder. When a current block uses an inter prediction mode, a transformation model candidate list of the current block is first constructed, then a transformation model and a reference block of the current block are determined accordingly, and the reference block is transformed by the transformation model, thereby not only improving diversity of inter prediction, but also improving prediction accuracy, and further improving coding and decoding efficiency.

In yet another embodiment of the present disclosure, FIG. 32 is a schematic diagram of a composition structure of a coding and decoding system provided by an embodiment of the present disclosure. As shown in FIG. 32, the coding and decoding system 320 may include an encoder 3201 and a decoder 3202.

In an embodiment of the present disclosure, the encoder 3201 may be the encoder according to any one of the preceding embodiments, and the decoder 3202 may be the decoder according to any one of the preceding embodiments.

It should be noted that, in the present disclosure, the terms “include”, “comprise” or any other variation thereof are intended to cover a non-exclusive inclusion, such that a process, method, article or apparatus that includes a list of elements not only includes those elements, but also includes other elements not expressly listed, or further includes elements inherent to such process, method, article or apparatus. Without further limitation, an element defined by the statement “including a . . . ” does not exclude the presence of other identical elements in the process, method, article or apparatus including the element.

The serial numbers of the above embodiments of the present disclosure are for description only, and do not represent the advantages or disadvantages of the embodiments. The methods disclosed in the several method embodiments provided in the present disclosure may be combined arbitrarily without conflict to obtain new method embodiments.

The features disclosed in the several product embodiments provided in the present disclosure may be combined arbitrarily without conflict to obtain new product embodiments.

The features disclosed in the several method or apparatus embodiments provided in the present disclosure may be combined arbitrarily without conflict to obtain new method embodiments or apparatus embodiments.

The above are merely specific embodiments of the present disclosure, but the scope of protection of the present disclosure is not limited thereto. Changes or substitutions that may be easily conceived by any person skilled in the art within the technical scope disclosed by the present disclosure shall be covered within the scope of protection of the present disclosure. Therefore, the scope of protection of the present disclosure shall be subject to the scope of protection of the claims.

### INDUSTRIAL APPLICABILITY

In the embodiments of the present disclosure, at an encoding end, when a current block uses an inter prediction mode, a transformation model candidate list of the current block is constructed; a transformation model of the current block is determined based on the transformation model candidate list, and a reference block of the current block is determined; the reference block is transformed based on the transformation model to determine a prediction block of the current block. At a decoding end, a bitstream is decoded to determine a value of first syntax flag information; when the first syntax flag information indicates that the current block uses an inter prediction mode, a transformation model candidate list of the current block is constructed; a transformation model of the current block is determined based on the transformation model candidate list, and a reference block of the current block is determined; the reference block is transformed based on the transformation model to determine a prediction block of the current block. In this way, whether at the encoding end or the decoding end, when the current block uses an inter prediction mode, a transformation model candidate list of the current block is first constructed, then a transformation model and a reference block of the current block are determined accordingly, and the reference block is transformed by the transformation model, thereby not only improving diversity of inter prediction, but also improving prediction accuracy, and further improving coding and decoding efficiency.

1. A decoding method, implemented by a decoder, comprising:
decoding a bitstream to determine a value of first syntax flag information;
constructing a transformation model candidate list of a current block when the first syntax flag information indicates that the current block uses an inter prediction mode;
determining a transformation model of the current block based on the transformation model candidate list, and determining a reference block of the current block; and
transforming the reference block based on the transformation model to determine a prediction block of the current block.

2. The decoding method of claim 1, wherein the determining a transformation model of the current block based on the transformation model candidate list and determining a reference block of the current block comprises:
determining the transformation model of the current block based on the transformation model candidate list; and
determining the reference block of the current block based on the transformation model and a first merge candidate list.

3. The decoding method of claim 2, wherein the determining the transformation model of the current block based on the transformation model candidate list comprises:
decoding the bitstream to determine a transformation model index of the current block; and
determining the transformation model of the current block based on the transformation model index and the transformation model candidate list.

4. The decoding method of claim 2, further comprising:
determining at least one piece of candidate motion information of the current block; and
constructing the first merge candidate list according to the at least one piece of candidate motion information of the current block,
wherein the candidate motion information is used to indicate at least one of a candidate reference block of the current block or a template of the candidate reference block.

5. The decoding method of claim 2, wherein the determining the reference block of the current block based on the transformation model and the first merge candidate list comprises:
calculating template errors for at least one candidate reference block indicated in the first merge candidate list based on the transformation model to determine errors of the at least one candidate reference block; and
determining a minimum error from the errors of the at least one candidate reference block, and determining a candidate reference block corresponding to the minimum error as the reference block of the current block.

6. The decoding method of claim 2, wherein the determining the reference block of the current block based on the transformation model and the first merge candidate list comprises:
when the current block uses a decoder-side motion vector refinement (DMVR) mode, determining at least one group of candidate reference blocks of the current block based on the first merge candidate list, each group of candidate reference blocks comprising two candidate reference blocks;
transforming the two candidate reference blocks in each group of candidate reference blocks based on the transformation model to determine two transformed reference blocks in each group of candidate reference blocks;
calculating a matching error between the two transformed reference blocks in each group of candidate reference blocks to determine an error corresponding to each group of candidate reference blocks; and
determining, according to the error corresponding to each group of candidate reference blocks, a group of candidate reference blocks with a minimum error as the reference block of the current block.

7. The decoding method of claim 1, wherein the determining a transformation model of the current block based on the transformation model candidate list and determining a reference block of the current block comprises:
decoding the bitstream to determine the reference block of the current block; and
determining the transformation model of the current block based on the reference block and the transformation model candidate list.

8. The decoding method of claim 7, wherein the determining the transformation model of the current block based on the reference block and the transformation model candidate list comprises:
performing sorting on the transformation model candidate list based on the reference block to determine a sorted transformation model candidate list;
decoding the bitstream to determine a transformation model index of the current block; and
determining the transformation model of the current block based on the transformation model index and the sorted transformation model candidate list.

9. The decoding method of claim 8, further comprising:
determining a candidate transformation model at a preset list position based on the sorted transformation model candidate list; and
determining the candidate transformation model at the preset list position as the transformation model of the current block.

10. The decoding method of claim 1, wherein the constructing a transformation model candidate list of the current block comprises:
determining at least one candidate transformation model of the current block; and
determining the transformation model candidate list of the current block based on the at least one candidate transformation model.

11. The decoding method of claim 10, wherein the determining at least one candidate transformation model of the current block comprises at least one of:
determining available transformation models for adjacent positions of the current block;
determining available transformation models for a temporal domain of the current block;
determining available transformation models for non-adjacent positions of the current block;
determining available shifted temporal transformation models of the current block;
determining available historical transformation models; or
determining a preset transformation model.

12. The decoding method of claim 1, further comprising:
decoding the bitstream to determine a value of second syntax flag information; and
performing the operation of constructing the transformation model candidate list of the current block when the second syntax flag information indicates that the current block uses a transformation model candidate list-based manner.

13. The decoding method of claim 1, further comprising:
decoding the bitstream to determine a value of third syntax flag information;
decoding the bitstream to determine a value of second syntax flag information when the third syntax flag information indicates that the current block uses a reference block transformation-based prediction mode;
constructing a second merge candidate list of the current block when the second syntax flag information indicates that the current block uses a transformation model candidate list-based manner;
determining the transformation model and the reference block of the current block based on the second merge candidate list; and
transforming the reference block based on the transformation model to determine the prediction block of the current block.

14. The decoding method of claim 13, further comprising:
decoding the bitstream to determine a value of fourth syntax flag information; and
performing the operation of decoding the bitstream to determine a value of third syntax flag information when the fourth syntax flag information indicates that the current block uses an inter merge prediction mode.

15. The decoding method of claim 13, wherein the constructing a second merge candidate list of the current block comprises:
determining candidate merge information corresponding to a predefined position of the current block, wherein the candidate merge information comprises motion information and a transformation model; and
adding the candidate merge information corresponding to the predefined position to the second merge candidate list when the candidate merge information corresponding to the predefined position satisfies a preset candidate condition.

16. The decoding method of claim 1, further comprising:
when the current block has a first color component, a second color component and a third color component to be processed, storing a transformation model used by one of the first color component, the second color component and the third color component;
determining a type of the transformation model used by the one color component; and
deriving transformation models used by remaining two color components among the first color component, the second color component and the third color component based on adjacent reconstructed pixels of the current block and adjacent reconstructed pixels of the reference block, wherein types of the transformation models used by the remaining two color components are the same as a type of the transformation model used by the one color component.

17. The decoding method of claim 1, further comprising:
determining first motion information of the current block;
determining a first reference block of the current block according to the first motion information;
adjusting a model parameter of the transformation model based on a template of the current block and a template of the first reference block to obtain an adjusted transformation model; and
transforming the reference block based on the adjusted transformation model to determine the prediction block of the current block.

18. The decoding method of claim 1, further comprising:
determining a derived model of the current block by performing model derivation based on adjacent reconstructed pixels of the current block and adjacent reconstructed pixels of the reference block, or based on the reference block and a reconstructed block of the current block; and
storing the transformation model of the current block and the derived model of the current block.

19. An encoding method, implemented by an encoder, comprising:
constructing a transformation model candidate list of a current block when the current block uses an inter prediction mode;
determining a transformation model of the current block based on the transformation model candidate list, and determining a reference block of the current block; and
transforming the reference block based on the transformation model to determine a prediction block of the current block.

20. A non-transitory computer-readable storage medium, having a computer program and a bitstream stored thereon, wherein the computer program, when executed by at least one processor, enables the at least one processor to perform an encoding method to generate the bitstream, wherein the encoding method comprises:
constructing a transformation model candidate list of a current block when the current block uses an inter prediction mode;
determining a transformation model of the current block based on the transformation model candidate list, and determining a reference block of the current block; and
transforming the reference block based on the transformation model to determine a prediction block of the current block.
